(19) United States
(12) Patent Application Publication
(10) Pub. No.: US 2010/0138204 A1
(43) Pub. Date: Jun. 3, 2010

(54) CELL-BASED MODELS AND METHODS FOR SIMULATING LYMPHOCYTE DIFFERENTIATION AND OTHER BIOLOGICAL EVENTS

(76) Inventors: Ullysses A. Eoff, Nampa, ID (US); Michael A. Farrar, Minneapolis, MN (US); Timothy Otter, Caldwell, ID (US); David Zuercher, Boise, ID (US)

Correspondence Address: PERKINS COIE LLP, POST OFFICE BOX 1208, SEATTLE, WA, 98111-1208, US

(21) Appl. No.: 12/571,409

(22) Filed: Sep. 30, 2009

Related U.S. Application Data
(60) Provisional application No. 61/118,983, filed on Dec. 1, 2008.

(51) Int. Cl. G06G 7/58

(52) U.S. Cl. 703/11

(57) ABSTRACT

Systems and methods are disclosed herein that enable computer-implemented modeling of lymphocyte differentiation and developmental processes. Cell-based models and methods for simulating natural and transgenic lymphocyte differentiation are also disclosed. In some embodiments, systems and methods are provided for cell-centric simulation of lymphocyte differentiation with accommodating virtual thymic and/or bone marrow environment feedback. In one embodiment, a computer-implemented method of modeling lymphocyte differentiation can include receiving configurable simulation information and initializing an ontogeny engine to an initial step boundary in accordance with the configurable simulation information. The method can also include advancing the ontogeny engine, until a halting condition is encountered, from a current step boundary to a next step boundary in accordance with the configurable simulation information and the current step boundary. The initial step boundary can define at least one virtual early lymphoid progenitor cell. The advancing can include performing a stepCells function.

### CROSS-REFERENCE TO APPLICATION(S) INCORPORATED BY REFERENCE

The present application claims the benefit of U.S. Provisional Application No. 61/118,983, filed Dec. 1, 2008, which is incorporated herein in its entirety by reference. The present application also incorporates the subject matter of U.S. patent application Ser. No. 11/899,927 filed Sep. 7, 2007, entitled “VIRTUAL TISSUE WITH EMERGENT BEHAVIOR AND MODELING METHOD FOR PRODUCING THE TISSUE,” and International Application No. PCT/US2008/075514, entitled “SYSTEMS AND METHODS FOR CELL-CENTRIC SIMULATION AND CELL-BASED MODELS PRODUCED THEREFROM,” filed Sep. 5, 2008; in their entireties by reference. The present application also incorporates the subject matter of U.S. patent application Ser. No. 11/234,413, entitled “METHOD, SYSTEM, AND APPARATUS FOR VIRTUAL MODELING OF BIOLOGICAL TISSUE WITH ADAPTIVE EMERGENT FUNCTIONALITY,” filed Sep. 23, 2005, in its entirety by reference.

### STATEMENT REGARDING FEDERALLY SPONSORED RESEARCH

The U.S. Government has a paid-up license in this invention and the right in limited circumstances to require the patent owner to license others on reasonable terms as provided for by the terms of Contracts DAMD17-02-2-0049 and W81XWH-08-2-0003 as awarded by the US Army Medical Research Acquisition Activity (USAMRAA).

### TECHNICAL FIELD

The present disclosure is generally directed to simulation systems and computer-implemented methods for modeling lymphocyte differentiation and other related biological events. More specifically, the disclosure provides cell-based models and associated methods for simulating cell differentiation of “wild-type” and/or transgenic early lymphoid progenitor cells into B-cell lymphocytes and T-cell lymphocytes.

### BACKGROUND

In vivo and in vitro biological research methods are useful for understanding the response of biological systems to various experimental conditions or challenges, such as cell growth conditions, stress, or exposure to drugs. The complexity of biological systems can obstruct interpretation of in vivo experimental results from studies of particular biological pathways or mechanisms. In vitro studies may help in resolving experimental results from these in vivo studies, but only by isolating the experimental system from physiological context.

In silico simulation of biological systems has the potential to keep subject processes and structures within a reasonably complete and detailed context, but still allow a researcher to target data of specific interest and origin. That is, in silico simulation allows virtual dissection without physical separation. When used as a complementary and adjunct tool, in silico simulation can immediately make in vitro and in vivo research far more effective and, in some instances, reduce ethical issues.

However, current state of the art for in silico simulations suffer from limited applicability, rigid top-down designs, and static forms that provide only superficial mimicry of biological form and function, prevent open investigation of perturbations, mutations, and dynamic processes, and require complete knowledge of input pathways, states, or structures.

### BRIEF DESCRIPTION OF THE DRAWINGS

In the drawings, the sizes and relative positions of elements are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1A is a block diagram illustrating elements of a simulation system in accordance with an embodiment of the disclosure.

FIG. 1B is a schematic diagram illustrating aspects of a simulation environment for modeling a biological event relating to lymphocyte differentiation in accordance with an embodiment of the disclosure.

FIG. 2 is a block diagram of a suitable computer that may employ aspects of the disclosure.

FIG. 3 is a block diagram illustrating a suitable system in which aspects of the disclosure may operate in a networked computer environment.

FIG. 4 is a schematic block diagram illustrating subcomponents of the computing device of FIG. 3 in accordance with an embodiment of the disclosure.

FIG. 5 is a schematic flow diagram of an ontogeny model illustrating the relationship between gene expression, metabolism, cell signaling, sensory processes and gene regulation in accordance with an embodiment of the disclosure.

FIG. 6A is a flow diagram illustrating a routine for modeling lymphocyte differentiation invoked by the simulation system of FIG. 1A in accordance with an embodiment of the disclosure.

FIG. 6B is a flow diagram illustrating another routine for modeling lymphocyte differentiation supported by the simulation system of FIG. 1A in accordance with an embodiment of the disclosure.

FIGS. 7A-7C are isometric views illustrating a simulation of a cell division event including an initial cell division event and a differentiation event resulting in two cell types (7A), a second cell division event resulting in two cells representing each cell type (7B), and a reversion event (7C) in accordance with embodiments of the disclosure.

FIGS. 8A and 8B are isometric views illustrating two simulated cells using a subsphere free-space model with (8A) and without (8B) visible internal subspheres and in accordance with an embodiment of the disclosure.

FIGS. 9A and 9B are schematic flow diagrams illustrating legends for interpreting flow diagrams describing molecules and actions in a modeled signaling and gene regulatory network (SGRN) in accordance with an embodiment of the disclosure.

FIG. 10 is a schematic flow diagram illustrating T cell and B cell lineage-restricted differentiation pathways in accordance with embodiments of the disclosure.

FIGS. 11A-11B are schematic illustrations of a simulated thymic environment.

FIGS. 12A-12T are schematic flow diagrams illustrating molecules and actions, gene units and gene unit products, and chemical-interaction rules for modeling lineage-restricted lymphocyte differentiation pathways in accordance with the simulation of biological events described in Example 1 of section C1 and in accordance with an embodiment of the disclosure.

FIG. 13 is a schematic flow diagram illustrating T cell and B cell differentiation patterns when modeling development of transgenic lymphocytes having a constitutively active form of the STAT5 transcription factor in accordance with embodiments of the disclosure.

FIGS. 14A-14M are schematic flow diagrams illustrating molecules and actions, gene units and gene unit products, and chemical-interaction rules for modeling lineage-restricted transgenic lymphocyte differentiation pathways in accordance with the simulation of biological events described in Example 2 of section C2 and in accordance with an embodiment of the disclosure.

FIG. 15 is an isometric view of a graphical image displaying developing transgenic lymphocytes in a thymic environment at a current step boundary in accordance with an embodiment of the disclosure.

FIG. 16 is a graphical representation of B cell versus T cell lineage-restricted development with increased levels of constitutively active STAT5 in accordance with an embodiment of the disclosure.

FIGS. 17A-17H are schematic flow diagrams illustrating molecules and actions, gene units and gene unit products, and chemical-interaction rules for modeling lineage-restricted transgenic lymphocyte differentiation pathways in accordance with the simulation of biological events described in Example 3 of section C3 and in accordance with an embodiment of the disclosure.

FIGS. 18A-18D illustrates lymphocyte distribution in wild type (FIGS. 18A-18B) and STAT5B-CA (FIGS. 18C-18D) mice by flow cytometry analysis in accordance with an embodiment of the disclosure.

FIGS. 19A-19B are graphs of representative simulations illustrating the percentage of T cells and B cells at different STAT5P effect levels in accordance with an embodiment of the disclosure.

FIGS. 20A-20B illustrates lymphocyte distribution in STAT5B-CA-ebf^{+/+} mice (FIGS. 20A(i) and 20B(i)) and in STAT5B-CA-ebf^{+/-} mice (FIGS. 20A(ii)-(iii) and 20B(ii)-(iii)) by flow cytometry analysis in accordance with an embodiment of the disclosure.

FIG. 21 is a graphical representation of B cell versus T cell lineage-restricted development with increased levels of constitutively active STAT5 in heterozygous and homozygous EBF virtual environments in accordance with an embodiment of the disclosure.

FIG. 22 illustrates the concept that initial concentrations of Notch versus STAT5P predict lineage commitment of ELP progeny.

FIGS. 23A-23D illustrate lineage commitment potential of virtual ELPs. ELPs that are near Notch become T cells (FIG. 23A), ELPs that are near IL-7 become B cells (FIG. 23B), and displaced cells that have already committed to the B cell or T cell lineage retain that commitment (FIGS. 23C-23D, arrows).

### DETAILED DESCRIPTION

### A1. Overview

Systems and methods are provided herein that enable computer-implemented modeling of biological events, such as lymphocyte differentiation. In some embodiments, systems and methods are provided for cell-centric simulation of cellular differentiation of wild-type and/or transgenic lymphocytes. In one embodiment, cell-centric simulation can be defined as computer-implemented simulation of biological events wherein the cell is the starting basic unit, and wherein the cell unit can be defined with varying levels of abstractness to model the biological events with sufficient accuracy, but without having to define unnecessary levels of molecular detail. In other embodiments, cell-centric simulation can accommodate environment feedback. In one embodiment, cell-centric simulation of natural and/or transgenic lymphocyte differentiation and development can be implemented in accordance with configurable simulation information provided to a suitable simulation system. In another embodiment, simulation of biological events relating to lymphocyte differentiation and development, as described herein, can automatically implement additional simulation events in accordance with information captured during a previous simulation event and stored in a configuration file. Simulation of lymphocyte cell differentiation and development can include simulation of a plurality of biological events that typically occur concurrently and/or in sequential order in living organisms during lymphocyte differentiation. In some embodiments, simulation of biological events associated with lymphocyte differentiation can include modeling biological processes (e.g., cellular growth, differentiation of pluripotent cell, etc.), wherein the modeling generates one or more virtual T-cell or B-cell lymphocyte having emergent properties.

One aspect of the disclosure is directed toward a computer-implemented method of modeling lymphocyte differentiation. The method can include receiving configurable simulation information. The configurable simulation information can include configured physical and chemical parameters, configured environmental information and configured metabolic information. The method can also include initializing an ontogeny engine to an initial step boundary in accordance with the configurable simulation information. In one embodiment, the initial step boundary defines at least one virtual early lymphoid progenitor (ELP) cell in a virtual environment. The method can further include advancing the ontogeny engine from a current step boundary to a next step boundary in accordance with the configurable simulation information and the current step boundary. The advancing includes performing a “stepCells” function. In some embodiments, the advancing can include a “stepPhysics” function and/or other functions. The method can also include continuing the advancing until a halting condition is encountered.

In another embodiment, a system for modeling lymphocyte differentiation includes a processor and a plurality of modules configured to execute on the processor. For example, the system can include a receive module configured to receive configurable simulation information. The configurable simulation information can include configured physical and chemical parameters, configured environmental information and configured metabolic information. The configured metabolic information can include information for defining a lymphocyte virtual genome and a set of chemical-interaction rules. The system can also include an initialize module configured to initialize an ontogeny engine to an initial step boundary in accordance with the configurable simulation information. The initial step boundary can define at least one virtual ELP cell in a virtual environment. The lymphocyte virtual genome can be assigned to the at least one ELP cell. The system can further include an advance module configured to advance the ontogeny engine from a current step boundary to a next step boundary in accordance with the configurable simulation information and the current step boundary, the advancing comprising performing a stepCells function. The system can further include a halt detection module configured to continue the execution of the advance module until a halting condition is encountered. In additional embodiments, the advancing step may also include performing a stepPhysics function.

Other aspects of the disclosure are directed toward a cell-based model for simulating cellular differentiation, such as lymphocyte differentiation. In one embodiment, the differentiating virtual cells have an emergent property (e.g., self-repair, adaptive response to an altered environment, etc.). In one embodiment, the multi-cellular virtual tissue can contain at least one pluripotent cell capable of division and differentiation toward non-pluripotent cell types, and at least one or more non-pluripotent cell types. Further, the virtual tissue can include a plurality of virtual cell layers, wherein virtual cells in each of the plurality of virtual layers are differentially specialized with respect to each of the other virtual cell layers.

The following description provides specific details for a thorough understanding and enabling description of these embodiments of the disclosure. One skilled in the art will understand, however, that the disclosure can be practiced without many of these details. Additionally, some well-known structures or functions may not be shown or described in detail, so as to avoid unnecessarily obscuring the relevant description of the various embodiments.

### A2. Terminology

The terms below have the following definitions herein, unless indicated otherwise:

In biology, a “cell” is the basic unit of living matter in all organisms. A cell is a self-maintaining system employing chemical and physical mechanisms for obtaining energy and/or materials to satisfy nutritional and energy requirements. A cell represents the simplest level of biological organization that manifests all the features of the phenomenon of life with the capacity for autonomous reproduction, for example by cellular division. A “virtual cell”, as used herein, is a computer-simulated analogue of a biological cell (e.g., a modeled cell, a simulated cell, etc.). For example, the virtual cell is separated from its environment (e.g., modeled extracellular matrix, modeled substrate, other virtual cells, etc.) via a cell barrier, e.g., virtual cell “membrane” such that the cell can be considered a discrete unit having an intracellular space separate from the extracellular surroundings.

A virtual cell can also be provided with a virtual genome having a plurality of virtual genes or gene units that can confer on the cell a number of modeled cellular functions. For example, virtual genes can provide a means from which basic cellular functions can be simulated, wherein basic cellular functions can include, but not limited to, (1) gene expression, (2) cell metabolism, (3) cell division, and/or (4) cell growth. In some embodiments, the virtual cells (“cells”) can be provided with one or more gene units (e.g., virtual genes, virtual gene product, molecules, etc.) that can be influenced during simulation to invoke a cell “death” or elimination during simulation. In further embodiments, the cells can be provided with one or more gene units that can be influenced during simulation to invoke biological events, such as lymphocyte differentiation from one cell state or cell type to a second cell state or cell type (e.g., different states of lymphocyte cell differentiation).

The “virtual genome” can provide a template for enabling simulation of one or more biological events including simulation of cell growth, cell division, cell homeostasis, cell death, cell differentiation, tissue formation, etc. In one embodiment, the virtual genome can be the collection of gene units assigned to or applied to a virtual lymphocyte cell. In another embodiment, the virtual genome can be a sub-collection of gene units assigned to or applied to a virtual lymphocyte cell. For example, in some embodiments, a cell can be provided with more than one virtual genome, wherein each virtual genome includes a set of gene units that can be applied to a particular class of functions (e.g., metabolism genome, cell primitive genome [discussed below], lymphocyte development genome, stem cell genome, etc.).

“Virtual genes” (e.g., gene units, gene assemblies) are computer simulation analogues, possibly abstracted, of biological genes. Each gene unit can have a gene control “region” that regulates an activity status or activity level (e.g., low, high, attenuated, etc.) of the gene unit (e.g., in response to absence or presence of molecules in the environment and/or cell). For example, in one embodiment, molecules can positively and/or negatively regulate gene control regions based on their presence, absence, location within the environment, movement within the environment, and other effects of molecules in cellular environments as would occur in vivo. In further embodiments, a quantity of a molecule within the macro- and/or micro-environment can strengthen or attenuate the simulated response (e.g., high activity, low activity, etc.). For example, the quantity of a molecule can be controlled within the lymphocyte differentiation model and such the effect of the molecule on the modeled cell can be tested at different levels. For example, if the quantity of a molecule is doubled, it can be determined whether and to what extent the targeted response is increased, decreased, or is unaffected. In additional embodiments, more than one molecule can interact with a gene control region, thereby further regulating a gene unit activity response to the environment during simulation. In addition to control regions, gene units can have a structural “region” (e.g., information configured to specify the type of molecule or molecules produced by the gene unit). For example, a growth gene unit may be denoted as [DiffuseNutrient 0.18, NeighborPresent −3] [Growth], specifying that a growth molecule is promoted moderately (0.18) by DiffuseNutrient, and strongly inhibited (−3.00) by NeighborPresent. In some embodiments, the structural region can specify more than one type of molecule generated by the gene unit.

A “virtual environment” can include a computer simulation analogue, possibly abstracted, of a biological cellular environment. The term “environment”, as used herein, can reference both extracellular and intracellular environments, and thereby encompasses the entirety of the space or volume occupied by one or more virtual cells in the simulation system as well as the virtual space in which the cells are placed. In one embodiment, the environment can be uniform (e.g., molecules present are uniformly distributed and can invoke simulated biological events in one or more cells present in the environment regardless of location (e.g., coordinates). In another embodiment, the environment can be non-uniform or consist of a plurality of micro-environments. For example, a first micro-environment can include a first set of molecules, and a second micro-environment can include a second set of molecules. Virtual cells residing in the respective first and second micro-environments can be differentially affected (and thereby show differential modeled behavior).

Intracellular environments can also be uniformly- and/or variably-configured in accordance with an embodiment of the disclosure. For example, a virtual cell can be discreetly or non-discretely subdivided with respect to distribution of molecules. As such, increasingly complex levels of detail that mimic the intricacies of natural biological systems can be applied using the simulation system as described herein.

“Molecules”, as used herein, are computer simulation analogues, possibly abstracted, of molecules found in biological systems. For example, a molecule refers to a virtual compound or resource that can be produced by a virtual gene, or alternatively, is introduced into the environment or converted by a chemical-interaction rule. In some embodiments, molecules can be categorized as a type of resource, wherein a resource may further refer to a state of an object, an electrical membrane potential, an action capacity, polarizing factors, cytoskeletal properties, localized pools of resources, an influence on physical properties, energy and other conceptual resources. The term “molecule” is encompassed by the term “resource,” and may be used interchangeably in appropriate situations. A function or set of functions can be applied to a molecule, such that, when present, the molecule can affect the state of one or more virtual cells, e.g., through its interaction with other molecules and/or gene units in a virtual cell, etc. A molecule, whether referred to in a singular or plural form, refers to a collection of a molecule type. A molecule can be provided a strength value indicating the molecule's relative amount or presence in a virtual environment or cell. The strength value (e.g., relative concentration) can be altered during simulation.

“Chemistry equations” or “chemical-interaction rules” refer to a set of equations that, when invoked, can simulate the extra-genetic (e.g., non-gene) behavior and interactions between or among intracellular and/or extracellular molecules, such as products generated by gene unit activity, simulated cell receptors, simulated cell transporters, etc.

“Action rules” can be provided and invoked in silico to simulate cellular adhesion events, growth events, division events and/or stages of the cell cycle, etc. For example, action rules can be a set of operational directives that are invoked when one or more pre-configured conditions are met. For example, action rules can be used, at least in part, to simulate a cell's influence from and/or on adjacent cells. Action rules can also be used, at least in part, to simulate a cell's growth to a larger cell size or to divide a cell into two cells. In some embodiments, action rules can be invoked in response to one or more molecules present in the environment, such as those molecules produced by a gene unit relating to intercellular adhesion, cell growth, cell division, and/or other effects of molecules in cellular environments as would occur in vivo.

“Physical-interaction rules” can be provided and invoked in silico to simulate how a cell will move in response to its own simulated growth, simulated division, simulated growth and/or division of neighboring cells, and/or how a cell will move in response to physical constraints or perturbations imposed by the environment.

A “molecule profile” can be used to define the types of molecules, distribution of each molecule, concentration of each molecule, etc., for a particular environment (e.g., macro-environment, micro-environment, etc.) or virtual cell (e.g., intracellular environment). Change in a molecule's concentration and/or gradient within an environment or virtual cell can be defined as molecule flux. During simulation, a molecule profile can change via simulation-induced molecule flux.

A gene unit can serve as a template for generating molecules that provide cellular function or activity (within the simulation scheme), such as intercellular adhesion, cell division, cell growth, intercellular signaling, etc. As such, molecule flux within the simulation scheme can alter the state or states of a virtual cell and/or adjacent cells. As representative of molecular mechanisms recognized in biological systems, a molecule and/or other resource can effect a specified role or function within the context of the biological system, such as, by directly or indirectly invoking action and/or physical-interaction rules, interacting with other molecules through chemical-interaction rules, etc. One of ordinary skill in the art will recognize that the molecule(s) derived from a gene unit can provide more than one function within the simulation scheme.

“Cell primitives” refer to the simplest operations or behaviors that a virtual cell can perform (e.g., ability to divide, ability to grow larger, ability to move, etc.). All other operations of a cell can be combinations of such cell primitives and/or combinations of cell primitives and other operations or behaviors that a virtual cell can perform.

A “virtual tissue” is a collection of virtual cells collectively having a shape and functional characteristics within the simulation scheme. In biology, a tissue is a mass of cells that are derived from the same origin, but are not necessarily identical, and which work together to perform a particular function or set of functions. For example, tissues (e.g., epithelial, muscle, neural, connective, vascular, etc.) can be recognized as an intermediate form of cellular organization between the individual cell and an organism (e.g., animal, plant). In other embodiment, the virtual tissue can be a simulated representation of artificially grown or genetically engineered tissue.

“Cell signaling” can refer to an event in which molecules assigned a signaling function and which are available in the virtual environment (e.g., generated during a simulation step and/or session from a gene unit) can affect the behavior of one or more cells in that environment. For example, simulative generation of a “signaling” molecule in one virtual cell can, in a next step, interact with “receptor” molecules in or on a second virtual cell. When simulating cell signaling processes, chemical-interaction rules can further effect a behavior change in the second virtual cell (e.g., activation of one or more gene units within the second cell, etc.).

A “signal” molecule can refer to a nutrient or other molecule located external to a virtual cell and/or exported from a virtual cell that can, directly or indirectly, affect the behavior of virtual cells within the context of the simulation scheme. For example, the presence of a signal molecule can spawn simulative responses such as transport of the signal molecule into a virtual cell, interaction with a control region of a gene unit, interaction with a cell surface receptor molecule, etc.

When present, a “receptor” molecule can be localized on a virtual cell's surface (e.g., cell barrier, cell membrane, etc.). Interaction, via an invoked chemical-interaction rule, between an extracellular molecule with a signal function and a receptor molecule localized on a virtual cell surface, can directly or indirectly affect the behavior of the cell by invoking one or more additional chemical-interaction rules, action rules, or other rules.

An “adjacent cell,” as applied to a specified virtual cell, refers to other cells that are in contact with and/or are an immediate neighbor of that cell with respect to the simulated environment. In one embodiment, the simplest neighborhood of a cell consists of those cells that are spatially adjacent to (touching) the cell of interest. However, in other embodiments, a cell's neighborhood may be configured as any arbitrary group of cells. For example, a neighborhood (the cells to/from which it will send/receive signals) could include cells that are not adjacent, as occurs in vivo with cells that are able to signal non-local cells via hormones.

The “phenotype” of an organism or tissue refers to the observable traits, appearance, properties, function, and behavior of the subject organism or tissue.

“Physical constraints” refer to constraints imposed upon the position and/or growth of a cell due to the presence of adjacent cells or size limits of the tissue.

A “totipotent cell” refers to a cell having the capability to form, by one or more rounds of simulated cell division, other totipotent cells, pluripotent cells, or differentiated cell types. In biology, totipotent cells can give rise to any of the various cell types in an organism.

A “pluripotent cell” refers to a cell that can give rise to daughter cells capable of differentiating into a limited number of different cell types. For instance, dermal stem cells (e.g., a pluripotent cell) can give rise to cells of a variety of dermal cell types, but do not give rise to cells of non-dermal cell types.

A “stem cell” can refer to a totipotent or pluripotent cell. For example, a stem cell can be an undifferentiated or partially undifferentiated cell that can divide indefinitely, the process of which can give rise to a first daughter cell that can undergo a terminal differentiation event resulting in a cell having a specific cell type and/or function. The second daughter cell resulting from each successive division event can be a stem cell that retains its proliferative capacity and an undifferentiated state or partially undifferentiated state.

A “virtual stem cell”, “virtual totipotent cell”, or “virtual pluripotent cell” refer to virtual cells having analogous characteristics to their biological cell counterparts described above.

“Homeostasis” refers to the ability or tendency of an organism or cell to maintain a relatively constant shape, temperature, fluid content, etc., by the regulation of its physiological processes in response to its environment.

“Emergent properties” or “emergent behavior” refers to a process or capability that exists at one level of organization, but not at any lower level and that depends on a specific arrangement, organization, or interaction of the lower level components. Two emergent behaviors of a virtual tissue in accordance with embodiments of the disclosure are (i) self-repair, induced response whereby cells are replaced when they have been killed, damaged, or removed, and (ii) adaptation, meaning a change in structure, function, or habits as appropriate for different conditions, enabling an organism to survive and reproduce in a certain environment or situation.

An “interval” refers to a time period, typically but not necessarily a discrete time period, at which the state or status of the cells making up a virtual tissue are updated, e.g., while simulating or modeling a biological event.

“Cell differentiation” is the process by which cells acquire a more specialized form or function during development. Cell differentiation can be, in part, described in terms of incremental and/or various stages transitioning the cell toward a terminal stage (e.g., of specialized form or function). For example, stages of differentiation can include a committed and/or specified stage that indicates the cell's strong propensity to differentiate, a determined stage that indicates an inexorable commitment to differentiation, etc. In one example, during early embryonic animal development, a plurality of identical cells eventually become committed to alternative differentiation pathways resulting in development of specialized tissues (e.g., lymphocyte cells, bone, heart, muscle, skin, etc.) in the developing animal.

### B. EMBODIMENTS OF SUITABLE SYSTEMS AND METHODS FOR SIMULATING LYMPHOCYTE DIFFERENTIATION AND DEVELOPMENT

Methods, systems, and apparatuses for implementing computer simulation models of lymphocyte differentiation and development, as disclosed herein, relate to a computational approach and platform that incorporates principles of biology, utilizing and building upon primitive features of living systems that are fundamental to their construction and operation and that distinguish them from non-living systems. The goal of biological incorporation is to identify, extract, and capture in algorithmic form the essential logic by which a living system self-organizes, self-constructs, regulates itself and other cells, and eliminates itself at the end of its cellular lifespan. Such algorithmic form(s) include a perspective based on the properties of the natural lymphocyte cells and embeds those properties within the simulation system for modeling their differentiation and development. Accordingly, the cell-based (e.g., cell-centric) approach to modeling lymphocyte differentiation and developmental processes produces advantageous modeling features, such as accommodating dynamic environment feedback and hierarchical organization of the cells and tissues, thereby effectuating emergent properties.

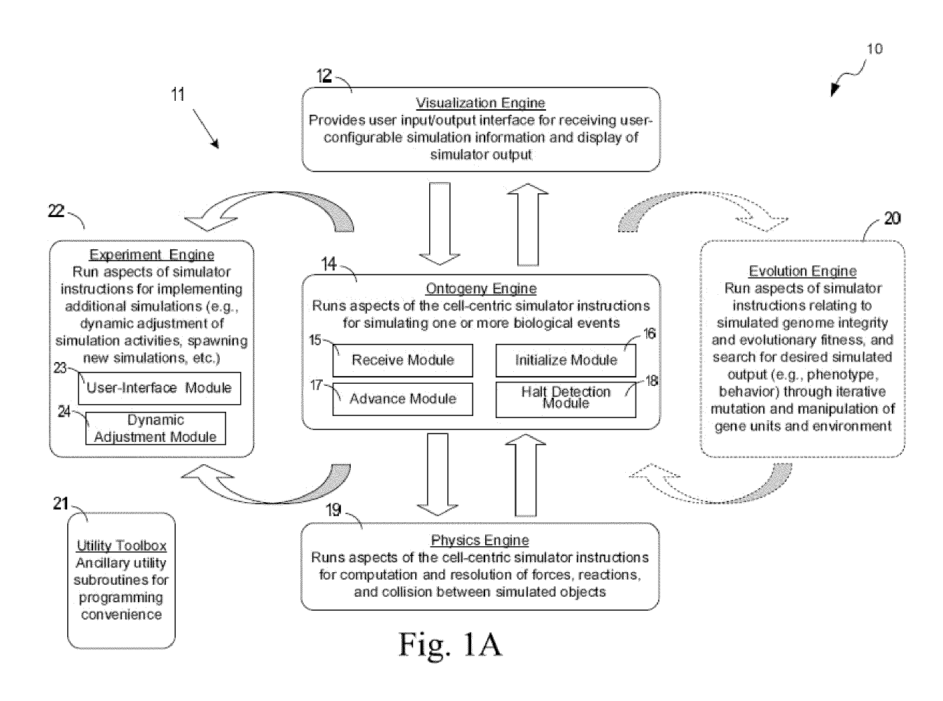

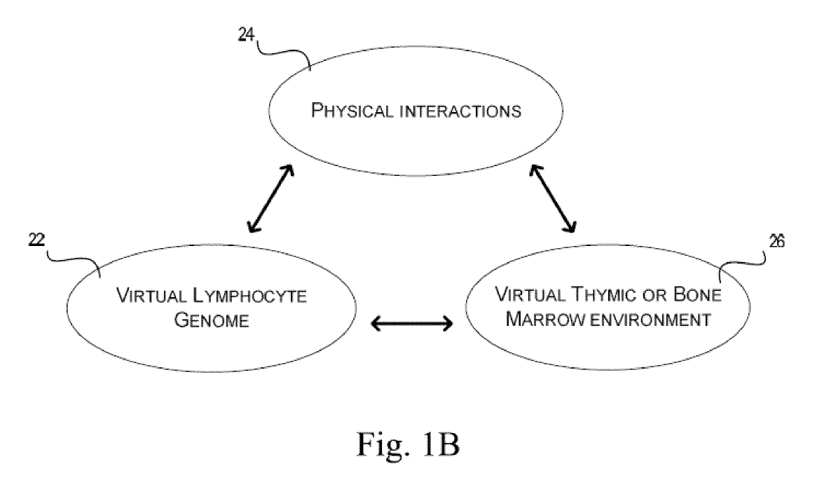

In one embodiment, simulation systems and methods as disclosed in International Application No. PCT/US2008/075514, entitled “SYSTEMS AND METHODS FOR CELL-CENTRIC SIMULATION AND CELL-BASED MODELS PRODUCED THEREFROM,” filed Sep. 5, 2008; incorporated by reference in its entirety, can be used to simulate lymphocyte differentiation and developmental process starting from a single cell or initial grouping of cells, each with a configured genome (e.g., genotype), to model resultant tissue and/or mature lymphocyte cellular phenotypes. Phenotypic properties, such as tissue shape and/or cellular spatial orientation, self-repair, specialized cellular differentiation of the lymphocytes, etc., arise from the interaction of gene-like elements as the virtual cells develop. FIG. 1A is a block diagram illustrating elements of a suitable simulation system for implementing aspects of the present disclosure. The simulation system can include an ontogeny engine (described in further detail below) for defining and controlling the parameters of the virtual environment necessary for modeling biological events, such as, tissue development, placement of nutrients, allocation of space for cells to grow, sequencing of simulated events and/or actions, rules that invoke simulation of natural physical laws in the virtual environment, etc. To make the simulation and modeling flexible, the environmental parameters are configurable, and may include rules governing the calculation of molecular affinity, and the placement and concentration of nutrients or other molecules.

A suitable simulation platform can provide means for receiving and updating configurable simulation information relating to the simplest operations or behaviors that a virtual lymphocyte cell can perform (e.g., the cellular primitives). For example, configurable simulation information can capture, in algorithmic form, the primitive features of living systems by which the system can self-organize, self-construct, and self repair. The logic behind cell primitive features that can be captured in algorithmic form can include a cell's genome, cellular membrane, extracellular matrix (ECM), ability to divide, ability to grow larger, ability to move or migrate through an environment, ability to maintain and/or change cell shape, ability to polarize, ability to differentiate (functionally specialize), ability to communicate with neighboring cells and the surrounding environment (e.g., send and receive signals), ability to age and/or die, ability to retain or recall or readapt to recent cellular states, ability to connect to adjacent cells and/or the ECM via cellular adhesion, etc. As such, configurable information relating to cell primitives provides the simulation platform with the means to model biological processes such as lymphocyte differentiation of pluripotent and/or early lymphoid progenitor cells, communication and feedback between specialized lymphocytes, and metabolism.

### B1. Suitable Computing Environments

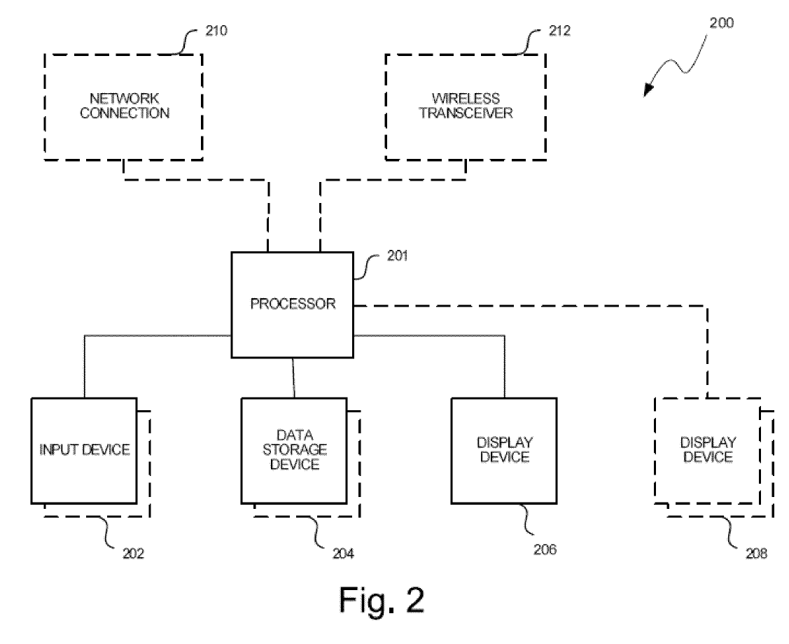

FIG. 2 and the following discussion provide a general description of a suitable computing environment in which aspects of the disclosure can be implemented. Although not required, aspects and embodiments of the disclosure will be described in the general context of computer-executable instructions, such as routines executed by a general-purpose computer, e.g., a server or personal computer. Those skilled in the relevant art will appreciate that the disclosure can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The disclosure can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The disclosure can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the disclosure described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the disclosure may reside on a server computer, while corresponding portions reside on a client computer. Data structures and transmission of data particular to aspects of the disclosure are also encompassed within the scope of the disclosure.

Referring to FIG. 2, one embodiment of the disclosure employs a computer 2800, such as a personal computer or workstation, having one or more processors 201 coupled to one or more user input devices 202 and data storage devices 204. The computer is also coupled to at least one output device such as a display device 206 and one or more optional additional output devices 208 (e.g., printer, plotter, speakers, tactile or olfactory output devices, etc.). The computer may be coupled to external computers, such as via an optional network connection 210, a wireless transceiver 212, or both.

The input devices 202 may include a keyboard and/or a pointing device such as a mouse or haptic device. Other input devices are possible such as a microphone, joystick, pen, touch screen, scanner, digital camera, video camera, and the like. The data storage devices 204 may include any type of computer-readable media that can store data accessible by the computer 200, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 2).

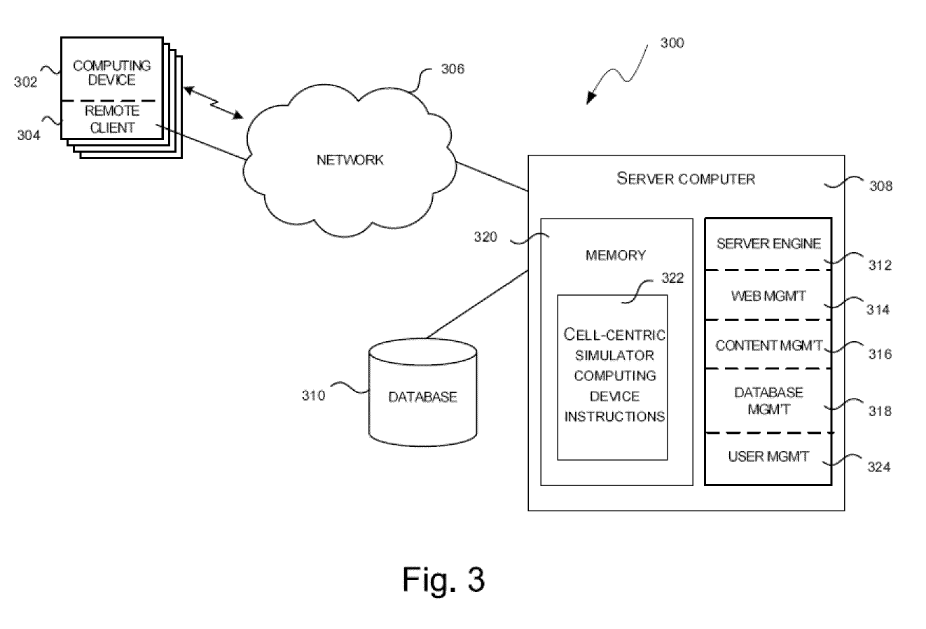

Aspects of the disclosure may be practiced in a variety of other computing environments. For example, referring to FIG. 3, a distributed computing environment with a network interface includes one or more computing devices 302 (e.g., a client computer) in a system 300 are shown, each of which includes a remote client module 304 that permits the computing device to access and exchange data with the network 306 (e.g., Internet, intranet, etc.), including web sites within the World Wide Web portion of the Internet. The computing devices 302 may be substantially similar to the computer described above with respect to FIG. 2. Computing devices 302 may include other program modules such as an operating system, one or more application programs (e.g., word processing or spread sheet applications), and the like. The computing devices 302 may be general-purpose devices that can be programmed to run various types of applications, or they may be single-purpose devices optimized or limited to a particular function or class of functions. While shown with remote client applications using internet protocols or proprietary communication protocols for communication via network 306, any application program for providing a graphical user interface to users may be employed (e.g., network browsers), as described in detail below.

At least one server computer 308, coupled to the network 306 (e.g., Internet or intranet) 306, performs much or all of the functions for receiving, routing and storing of electronic messages, such as web pages, data streams, audio signals, and electronic images. While the Internet is discussed, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. In some embodiments, a database 310 or databases, coupled to the server computer(s), can store much of the content exchanged between the computing devices 302 and the server 308. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 308 can also contain an internal memory component 320. The memory 320 can be standard memory, secure memory, or a combination of both memory types. The memory 320 and/or other data storage device 310 can contain computer readable medium having computing device instructions 322, such as cell-centric simulator computing device instructions. The encoded computing device instructions 322 are electronically accessible to at least one of the computing devices 308 and 302 for execution. In further embodiments, computing device instructions 322 can include basic operating instructions, cell-centric simulator instructions (e.g., source code, configurable simulation information), etc.

The server computer 308 may include a server engine 312, a web page management component 314, a content management component 316, a database management component 318 and a user management component 324. The server engine performs basic processing and operating system level tasks. The web page management component 314 handles creation and display or routing of web pages. Users may access the server computer by means of a URL associated therewith. The content management component 316 handles most of the functions in the embodiments described herein. The database management component 318 includes storage and retrieval tasks with respect to the database 310, queries to the database, read and write functions to the database and storage of data such as video, graphics and audio signals. The user management component 324 can support authentication of a computing device to the server 308.

Many of the functional units described herein have been labeled as modules, in order to more particularly emphasize their implementation independence. For example, modules may be implemented in software for execution by various types of processors, such as processor 201. An identified module of executable code may, for instance, comprise one or more physical or logical blocks of computer instructions which may, for instance, be organized as an object, procedure, function, or algorithm. The identified blocks of computer instructions need not be physically located together, but may comprise disparate instructions stored in different locations which, when joined logically together, comprise the module and achieve the stated purpose for the module.

A module may also be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

### D2. Embodiments of User Systems and Interfaces

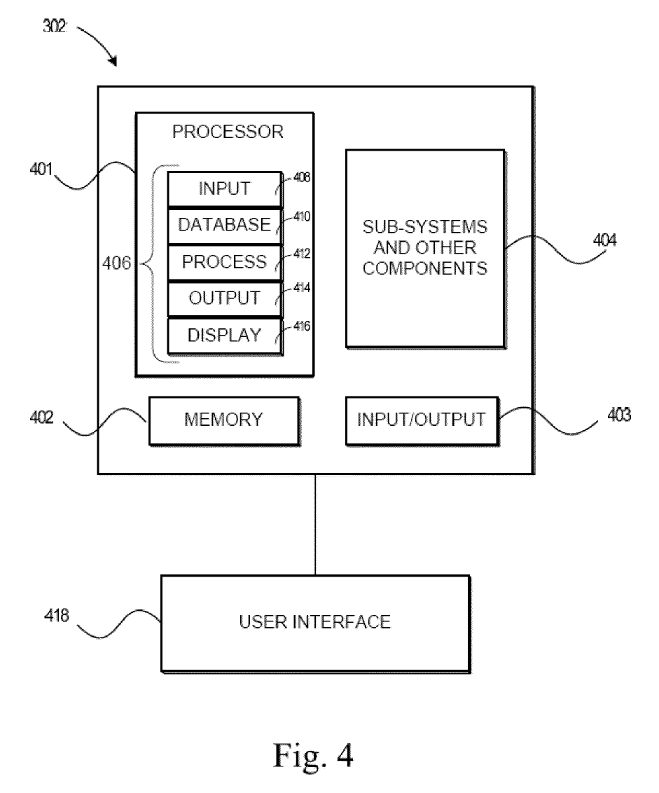

FIG. 4 is a schematic block diagram illustrating subcomponents of the computing device 302 of FIG. 3 in accordance with an embodiment of the disclosure. The computing device 302 can include a processor 401, a memory 402 (e.g., SRAM, DRAM, flash, or other memory devices), input/output devices 403, and/or subsystems and other components 404. The computing device 302 can perform any of a wide variety of computing processing, storage, sensing, imaging, and/or other functions. Components of the computing device may be housed in a single unit or distributed over multiple, interconnected units (e.g., through a communications network). The components of the computing device 302 can accordingly include local and/or remote memory storage devices and any of a wide variety of computer-readable media.

As illustrated in FIG. 4, the processor 401 can include a plurality of functional modules 406, such as software modules, for execution by the processor 401. The various implementations of source code (e.g., in a conventional programming language) can be stored on a computer-readable storage medium or can be embodied on a transmission medium in a carrier wave. The modules 406 of the processor can include an input module 408, a database module 410, a process module 412, an output module 414, and, optionally, a display module 416.

In operation, the input module 408 accepts an operator input via the one or more input devices described above with respect to FIG. 2, and communicates the accepted information or selections to other components for further processing. The database module 410 organizes records, including simulation records, configurable simulation information, generated models, and other operator activities, and facilitates storing and retrieving of these records to and from a data storage device (e.g., internal memory 402, external database 310, etc.). Any type of database organization can be utilized, including a flat file system, hierarchical database, relational database, distributed database, etc.

In the computing environment illustrated in FIG. 4, the process module 412 can generate simulation control variables based on operator input accepted by the input module 408, simulation operational parameters, etc., and the output module 414 can communicate operator input to external computing devices such as server computer 408. In other embodiments, the input module 408 can accept data transmitted by a server, such as server 308 (e.g., over a network 306). The display module 416 can be configured to convert and transmit simulation parameters, biological event modeling, input data, etc. through one or more connected display devices, such as a display screen, printer, speaker system, etc.

In various embodiments, the processor 401 can be a standard central processing unit or a secure processor. Secure processors can be special-purpose processors (e.g., reduced instruction set processor) that can withstand sophisticated attacks that attempt to extract data or programming logic. The secure processors may not have debugging pins that enable an external debugger to monitor the secure processor's execution or registers. In other embodiments, the system may employ a secure field programmable gate array, a smartcard, or other secure devices.

The memory 402 can be standard memory, secure memory, or a combination of both memory types. By employing a secure processor and/or secure memory, the system can ensure that data and instructions are both highly secure and sensitive operations such as decryption are shielded from observation.

The computing environment 300 can receive user input in a plurality of formats. In one embodiment, data is received from a user-operated computer interface 418 (i.e., “user interface”). In various embodiments, the user interface 418 is associated with the computing device 302 and can include various input and output devices, such as a keyboard, a mouse, a haptic device, buttons, knobs, styluses, trackballs, microphones, touch screens, liquid crystal displays, light emitting diode displays, lights, speakers, earphones, headsets, and the like. In other embodiments not shown, the user interface 418 can be directly associated with the server computer 308.

Referring back to FIG. 3, the computing device 302 may connect to network resources, such as other computers 302 and 308 and one or more data storage devices 310. As examples, the computing device 302 may connect to a server 308 to upload data logs, configurable simulation information, simulation commands, and so forth. The computing device 302 may also connect to a server 308 to download updates to software, cell-centric simulator computing device instructions, and so forth. The computing device 302 can also connect to the data storage device 310. As described above, the computing device 302 may connect to network resources via network 306, such as the Internet or an intranet.

### B3. Suitable Simulation Systems

FIG. 1A and the following discussion provide a brief, general description of a suitable simulation system 10 in which aspects of the disclosure can be implemented. Those skilled in the relevant art will appreciate that the disclosure can be practiced with other simulation systems and methods for implementing computer simulation models of biological events, such as lymphocyte differentiation events and processes. These can include simulation systems for receiving configurable information of varying levels of abstraction, accommodating dynamic environment feedback, hierarchical organization of cells and tissues and/or combinations of one or more of the above for modeling lymphocyte differentiation and developmental processes.

As shown in FIG. 1A, the system 10 includes a cell-centric simulator 11 configured to model one or more biological events. In one example, the cell-centric simulator 11 can simulate a developmental process (e.g., tissue and cellular growth and generation, cell differentiation, etc.). In one embodiment, the cell-centric simulator 11 can model tissue phenotype (e.g., appearance, physical traits, properties, etc.). Properties such as tissue shape and self-repair arise from the interaction of modeled gene-like elements (e.g., gene units) as the multicellular virtual tissue and/or cells develop. In some embodiments, the simulator 11 can define and control a plurality of parameters of the virtual environment necessary for modeling cellular and/or tissue development, including placement of nutrients, defining space for cells to grow, sequencing of simulated events and/or actions, rules that invoke simulation of natural physical laws in the virtual environment, etc. In additional embodiments, environmental parameters (e.g., rules governing the calculation of molecular affinity and the placement and concentration of nutrients or other molecules) are configurable at run-time.

In one embodiment, the cell-centric simulator 11 can include a visualization engine 12 for supporting client visualization and manipulation of simulation data generated during a simulation session. In one embodiment, the visualization engine can be supported on a client computing device, such as computing device 302 (FIGS. 3 and 4) as, for example, a client application. In another embodiment, the visualization engine 12 can be supported by another computing device, such as the server 308 and/or another computing device. The visualization engine 12 can include a user input and output interface and be configured to interact with the simulator 11 and system 10 (e.g., imputing/receiving user-configurable simulation information, requesting simulation of lymphocyte differentiation, interacting with a simulation in real-time, displaying results and/or data of a completed simulation, etc.). In some embodiments, the visualization engine 12 can be configured to display at least one of (alone or in combination) a graphical, a numerical and an alphanumeric representation of data generated during or following a simulation session. For example, the visualization engine 12 can be configured to generate and display a graphical image representing the current status of the simulation at a user interface, such as user interface 418 (FIG. 4).

The cell-centric simulator 11 can also include the ontogeny engine 14 for running aspects of the cell-centric simulator instructions (e.g., relating to simulation of biological events, developmental processes, metabolic processes, etc.). For example, the ontogeny engine 14 can include a receive module 15, an initialize module 16, an advance module 17 and a halt detection module 18. In another embodiment, not shown, the ontogeny engine can also include an output module. In general, modules 15, 16, 17 and 18 comprise listings of executable instructions for implementing logical functions which can be embodied in any computer readable medium for use by or in connection with an instruction execution system or device (e.g., computer-based system, processor-containing system, etc.).

In one embodiment, the ontogeny engine 14 can provide the following functions:
from one cell, many cells can develop by cell growth, division, and death;
cells can descend from parent cells and so develop with lineage and sequential order;
cells can be semi-autonomous units, each with its own set of genes;
context-dependent, cell-by-cell control of gene expression via signaling;
construction and monitoring of an extracellular environment; and
higher order, emergent properties (e.g., self-repair).

The cell-centric simulator 11 can further include a physics engine 19 for running additional aspects of the cell-centric simulator instructions (e.g., physical interaction simulation, resolution of spatial and/or size constraints, etc.). In another embodiment, the cell-centric simulator can include an experiment engine 22 for running additional aspects of the cell-centric simulator instructions (e.g., dynamic adjustment of simulation activities, spawning new simulations, etc.) For clarity, the ontogeny engine 14 is shown separate from the physics engine 19 and the experiment engine 22; however, one of ordinary skill in the art will recognize that the ontogeny engine 14 could include the function of the physics engine 19, the experiment engine 22 and/or other functional features relating to the cell-centric simulator 11.

In another embodiment, the simulation system 10 can also include an evolution engine 20 for running further simulation instructions relating to simulated genome integrity, evolutionary fitness, etc. In a further embodiment, the simulation system 10 can include and/or be in communication with adjunct utilities 21 for providing additional programming and/or operation options and support.

The selection and evaluation process provided by the evolution engine 20 can be useful when simulations of the modeled cells and tissue can be specified with precise coordinates, such as an “egg carton” model wherein each cell is assigned to a specified bin. Alternatively, when using a model where the cells are allowed to adopt positions in free space, and assume a variety of sizes or shapes, it may be more practical to employ the visualization model 12 to visually compare the modeled tissue with the target tissue, and make empirical adjustments to the genome or environmental conditions, to achieve a closer match between the modeled and target tissues.

FIG. 1B is a schematic block diagram illustrating aspects of the simulation environment for modeling a biological event relating to lymphocyte differentiation in accordance with an embodiment of the disclosure. In one embodiment, the ontogeny engine 14 runs aspects of the cell-centric simulator instructions for defining and characterizing the following elements: (i) a virtual lymphocyte genome 22 which specifies the gene units (e.g., control region and structure region) present in a lymphocyte cell; (ii) physical interactions 24, which specifies how the lymphocyte cells move and occupy space during cell growth, division, death, within a tissue, etc.; and (iii) a virtual thymic or bone marrow environment 26 in which the lymphocytes cells will differentiate, develop and grow.

The simulated and/or configured elements relating to the virtual lymphocyte genome 22, physical interactions 24 and the environment 26 interact within the simulated environment, as illustrated by the arrows in FIG. 1B. For example, status and/or activation of gene units present in a lymphocyte cell depend on both signal molecules in both the micro- and macro-environments, and accordingly, gene products simulated by activation of a gene unit contribute to the changing of both the micro- and macro-environments. Biological events, such as cell division and cell growth can occur as a result of the changing molecules (e.g., invoked action rules), and such events can alter the physical interactions modeled between lymphocyte cells and their environment (e.g., neighboring cells, substrate, spatial constraints, etc. In principle, any of these elements 22, 24 and 26 can be adjusted to devise the generation of a given tissue's or cell's response to a perturbation.

In biology, genes provide a resource for cells by providing a template from which proteins and other molecular molecules (e.g., non-translated ribonucleic acids) can be synthesized. As such, the cell-centric simulator 11 provides each virtual cell with a virtual genome, e.g., a set of gene unit templates for simulating protein production and molecule synthesis for generating and coordinating a multicellular aggregate during a simulation session. For gene units to simulate natural genes for modeling a biological event, e.g., a lymphocyte differentiation process, there can be a means to control how, where and when particular gene units are activated (e.g., generate a molecule increase). To represent these features in a computational model, each gene unit within a virtual genome contains both a control (e.g., regulatory) region and a structural (e.g., designating a functional gene product) region. Gene unit activation is controlled by the interaction of molecules (e.g., representing transcription factors) in the internal micro-environment of the virtual cell with the control region (e.g., configured simulation parameters specific to that gene unit), in a manner analogous with gene regulatory networks in vivo.

In biology, genes contribute to the biological potential of scale whereby complexity arises from a relatively simple set of genetic encodings. Yet for this potential to be realized, genetic information must be rendered by a process of self-construction, e.g., by development. Self-construction by living systems is driven in a manner that harnesses the power of genetic encodings to ensure heritability of traits, while packaging them in an encoded form that is compact enough to place into a single cell, the smallest living unit.

Integration of gene units into biological simulations (e.g., in the context of development) can rely on understanding characteristics of the gene product encoded by the natural correlate gene sequence, (e.g., in the manner that it contributes to cellular function or its coordination in the growing multicellular tissue). For instance, some genes encode sensor molecules that allow cells to propagate signals to the ECM and to neighboring cells, while other genes encode receptor molecules that allow cells to detect signals from neighboring cells. However, while genes determine the types of sensors a cell can make, genes do not specify the patterns of information that the cell can receive.

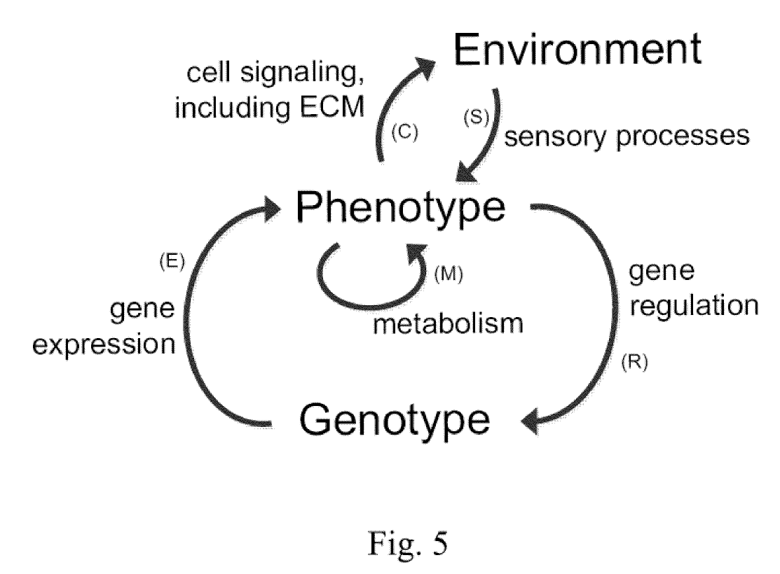

FIG. 5 is a schematic flow diagram of an ontogeny model illustrating the relationship between gene expression, metabolism, cell signaling, sensory processes and gene regulation in accordance with an embodiment of the disclosure. The ontogeny engine 14, which runs aspects of the cell-centric simulator instructions, can be configured to simulate biological processes configured in accordance with the ontogeny model depicted in FIG. 2. For example, the cell-centric simulator instructions can include simulation information related to genetic encoding, a process of self-construction analogous to biological development, as well as environmental influences of the processes by which the organism and/or cell is so constructed. Although FIG. 5 illustrates genotype, phenotype, and environment as separate domains of influence on the process of development (e.g., ontogeny), the arrows indicate that these influences can be interdependent and overlapping.

As seen in the ontology model illustrated in FIG. 5, genotype can influence phenotype through gene expression (E) and internal cellular metabolism (M), while phenotype acts on the genome by regulating overall gene activity (R). The phenotype influences the local environment of adjacent cells by cell signaling (C), for example, by release of cellular products into the environment. In turn, the phenotype is acted upon by the local environment through sensory processing (S), for example, extracellular molecules acting on cell receptors, extracellular molecule transport into cells, etc. Accordingly, phenotype represents a higher ontological category than genotype, since the phenotype has access to genetically encoded information and information in its environment that is not so encoded.

Patterns of gene expression in cells, or across an entire tissue or organism are derived from functional controls each cell applies according to and/or in response to both the internal and external signals it receives. In contrast, signal molecule concentration(s) are locally defined by the position a cell occupies in the developmental field. For example, localized concentration(s) of signal molecules can depend on the type and level of molecules produced by the cell's neighbors, as well as by signal molecules retained in the virtual external environment and/or in the extracellular matrix (ECM). In biology, microenvironments and mechanisms for control of gene expression provide the basis for differentiation.

In addition to their role in development, genes serve a passive role as units of inheritance, the units for transfer of information across generations. For genes to serve as units of inheritance they must have a stable, but not completely unchangeable, structure. For example, changes that occur in the structure (e.g., the coding sequence) of genes are passed on to progeny.

Each virtual lymphocyte cell in the system is assigned a virtual genome containing a plurality of gene units, each of which has a control region that determines what combination of signals (e.g., molecules or conditions) will signal gene activity and at what level. Each gene unit also comprises a gene product region that specifies the gene product or action produced by the gene unit. Table 1 includes an exemplary group of gene units that represent a “basic” set of virtual genes that can be used during in a variety of simulation session, e.g., for lymphocyte differentiation applications. One of ordinary skill in the art will recognize additional and/or alternative gene units that can be included in a virtual genome. Moreover, a virtual lymphocyte cell can be provided with a wild-type or natural virtual genome, or in another embodiment, the cell can be provided with a non-wild-type or transgenic virtual genome in which one or more of the gene units are modified. Furthermore, the listings in Table 1 are not meant to be limiting to the structure or context of code shown, and as such, other means and methods of coding and/or conveying gene unit information is considered within the scope of this present disclosure.

TABLE 1
Examples of Gene Units having Control and Gene Product Regions

| Gene Unit | Gene specification |
|---|---|
| 1 | [DiffuseNutrients .3] [Plasticity, Elasticity, Rigidity], |
| 2 | [DiffuseNutrients 5] [ExistanceSignal, |
| | ExistanceSignalReceiver], |
| 3 | [DiffuseNutrients .18, NeighborPresent −3] [Growth], |
| 4 | [DiffuseNutrients .18, NeighborPresent −3] [Division], |
| 5 | [DiffuseNutrients 5, Dominator −10, Dominated 5] |
| | [DominationSignalReceiver], |
| 6 | [NeighborPresent 3, Dominated −10, Dominator 3] |
| | [Dominator, DominationSignal] |

In addition, the cell-centric simulator instructions can contain chemistry equations that can be invoked to simulate the extra-genetic activity of molecules, including gene products and molecules from the environment. The chemistry equations can be configured to model the molecular interactions that occur normally within lymphocyte cells (e.g., how the molecules behave independent of the cell's genome). For example, chemistry equations can be used to simulate the rate of turnover of the molecules, molecular binding and/or reaction effects, etc.

Molecules present in the environment or generated within virtual cells are governed by extragenetic rules, referred to herein as chemical-interaction rules or chemistry equations, which can determine how molecules will be transformed or transported as they interact with other molecules in the system. In one embodiment, chemical-interaction rules can direct conversion of substrate molecules to molecules independent of gene unit molecule production. Table 2 includes a listing of nine exemplary chemistry equations or chemistry-interaction rules that can be invoked when modeling a biological event. One of ordinary skill in the art will recognize additional and/or alternative chemistry equations that can be included in the cell-centric simulation instructions and the system allows for the addition of such equations either in the beginning or during a given simulation session. Furthermore, the listings in Table 2 are not meant to be limiting to the structure or context of code shown, and as such, other means and methods of coding and/or conveying chemistry equation information is considered within the scope of this present disclosure.

TABLE 2
Example Chemical-Interaction Rules

| EQ # | CHEMISTRY EQUATION |
|---|---|
| 1 | {DiffuseNutrients} + (NutrientTransport) = |
| | 0.1 DiffuseNutrients + (1.11111111111111 NutrientTransport); |
| 2 | (NutrientTransport) = (1.111111111111111111 NutrientTransport); |
| 3 | (GenericExporter) = (1.111111111111111111 GenericExporter); |
| 4 | ExistanceSignal + (GenericExporter) = |
| | (1.1111111111111 GenericExporter) + {ExistanceSignal}; |
| 5 | ExistanceSignalReceiver = (ExistanceSignalReceiver); |
| 6 | {ExistanceSignal} + (ExistanceSignalReceiver) = |
| | 20 NeighborPresent; |
| 7 | DominationSignal + (GenericExporter) = |
| | (1.1111111111111 GenericExporter) + {DominationSignal}; |
| 8 | DominationSignalReceiver = (DominationSignalReceiver); |
| 9 | {DominationSignal} + (DominationSignalReceiver) = |
| | 20 Dominated + 20 GrowABit; |

The left side of the equal sign in each chemistry equation denotes the reactants and/or substrates, while the right side of the equation denotes the products and/or result of the reactant/substrate interaction.

Chemistry equations can designate how internal or surface substrate molecules are converted to other internal or surface molecules, how molecules are transported across the cell membrane by surface molecules, and how molecules are relocated between a cell's interior and surface. Chemistry equations can also be used to consume molecules, thereby inhibiting their involvement in other and/or additional interactions.

Emergence is a term that conveys many meanings, and accordingly, a broad range of phenomena have been classified as emergent (Steels, L. [1994] The artificial life roots of artificial intelligence. Artificial Life I, [no. 1, 2]:75-110; Morowitz, H [2002]. The Emergence of Everything. Oxford Univ. Press, Oxford UK. 209 pp.). As used herein, emergence refers to a relationship among cell primitives in a multi-cellular system. In one embodiment, a specific arrangement or interaction among cell primitives produces the emergent behavior, such that the behavior is not a property of any single cell primitive. Typically, emergence refers to behaviors or dynamic states rather than static shapes or structures. In living systems, emergence can convey one or more additional meanings: 1) that the property of interest appears only at some higher level of hierarchical organization than the elements that give rise to it; and 2) that the emergent behavior is adaptive, that it carries survival value, or increases fitness. For instance, homeostasis among vertebrates (e.g., maintenance of blood composition within narrow limits) can satisfy both of these conditions.

As described in more detail below, the cell-centric simulator 11 provides means for simulating lymphocyte differentiation and developmental processes such as those that model the naturally occurring events and interrelationships described above. For example, the cell-centric simulator 11 can model differentiation of early lymphoid progenitor cells to mature T-cell and B-cell lymphocytes and related immune system responses. In operation, the cell-centric simulator 11 provides means for receiving configurable simulation information. Such configurable simulation information can include both macro- and micro-environmental parameters, as well as cell-specific parameters. Cell-specific parameters can include, for example, features characterizing the plurality of gene units that make up the cell's virtual genome, the defined state and/or maturity level of the cell at an initial step boundary (e.g., at the beginning of a simulation session), etc. Further, configurable simulation information can include a plurality of rules and equations that model the interrelationships between the object oriented molecules (e.g., gene unit products, nutrients, receiver molecules, signaling molecules, etc.). Additional configurable simulation information can include physical rules that are invoked to model the physical laws of nature (e.g., contact inhibition, size constraints, gravity, affinity/adhesion parameters between molecules and/or cells, etc.). In one embodiment, configurable simulation information can be interpreted by the cell-centric simulator source code for running a simulation.

Additionally, embodiments of the present disclosure have demonstrated utility for simulating emergent properties, such as those described above (e.g., self-repair, cell communication that leads to a desired phenotype, dynamic adaptability to a changed environment, feedback networks that respond to a dynamic environment and model oscillations of cell state that can propagate through a modeled multicellular tissue, etc.). In particular, emergent properties simulated by the cell-centric simulation system 10 can include the following:

differentiation and/or cell specialization from an initial state to a terminal state;

communication by sensory functions and exchange of signals;

homeostasis by regulatory processes and metabolic feedback;

metabolism of fuels, energy, and molecular synthesis;

self-repair through cell turnover, regeneration, and replication; and

adaptation by phenotypic plasticity.

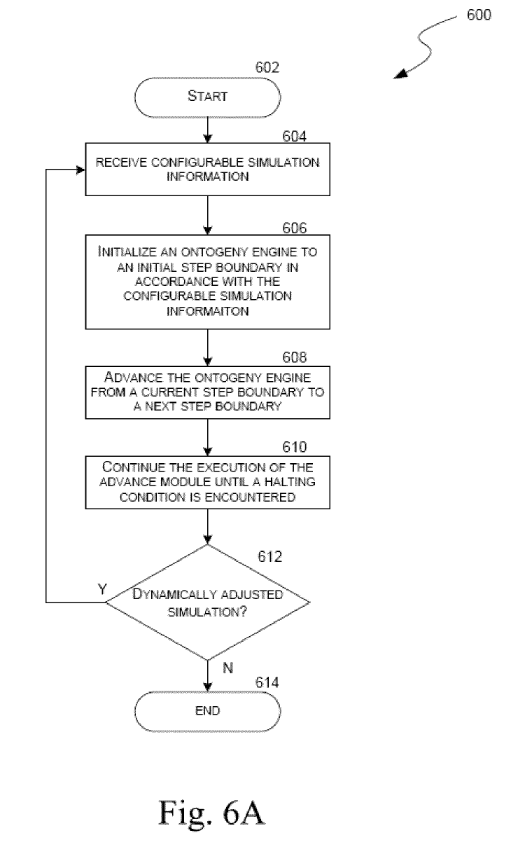

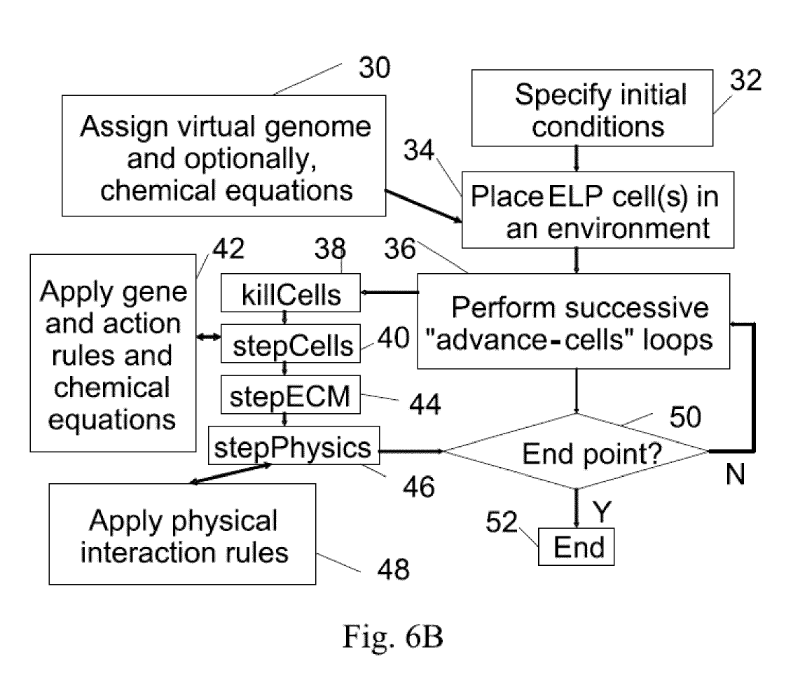

FIG. 6A is a flow diagram illustrating a routine 600 for modeling lymphocyte differentiation invoked by the simulation system 10 in some embodiments. The routine 600 can be invoked by a computing device, such as a client computer or a server computer coupled to a computer network. In one embodiment, the computing device includes the cell-centric simulator 11 having the ontogeny engine 14. As an example, the computing device may invoke the routine 600 after an operator engages a user interface in communication with the computing device.

The routine 600 begins at block 602 and the receive module receives configurable simulation information (block 604). In some embodiments, the configurable simulation information can include user-configurable simulation information received from a user interface. In additional embodiments, the configurable simulation information can include information in a configurable file generated from a previous modeling session. The initialize module initializes the ontogeny engine to an initial step boundary in accordance with the configurable simulation information (block 606). In one embodiment, the initial step boundary can define a reference point from which a simulation can commence or continue. For example, the initial step boundary can define the static starting “state” from which subsequent steps may be taken. In the present implementation, the ontogeny engine can be driven one step at a time from the initial step boundary to subsequent step boundaries.

The advance module advances the ontogeny engine from a current step boundary to a next step boundary in accordance with the configurable simulation information and the current step boundary (block 608). In one embodiment, the advancing includes performing a stepCells function (described in detail below). In another embodiment, the advancing can include performing one or more of a killCells function, a stepECM function and stepPhysics function. One of ordinary skill in the art will recognize that the killCells, stepCells, stepECM and stepPhysics functions can be implemented in any combination, in sequential order, in non-sequential order, and/or simultaneously (e.g., to model lymphocyte differentiation in a continuous manner).

A halt detection module continues the execution of the advance module until a halting condition is encountered (block 610). The routine 600 may then continue at block 612, where it ends.

In one embodiment, a halting condition can be a halt command received from an operator (e.g., user) of the system at a user interface, for example. In another embodiment, the halting condition can be a configured halting condition and the halt detection module continues the execution of the advance module until the configured halting condition is detected during simulation. For example, the configured halting condition can be a preset number of advancements by the ontogeny engine from a current step boundary to a next step boundary and the halt detection module can halt the advancement module when the preset number of advancements has been exhausted. In another embodiment, the configured halting condition can be a condition in which a degree of change (of one or more parameters) between a current step boundary and a next step boundary is less than a threshold degree of change. For example, a simulated biological process can be configured to continue through step advancements until a virtual tissue reaches a state of homeostasis.

In another embodiment, the cell-centric simulator 11 can be configured to model lymphocyte differentiation and developmental processes in a continuous and/or asynchronous manner. For example, the initialization module can be configured to initialize the ontogeny engine to an initial step boundary such that the initial step boundary includes one or more virtual early lymphoid progenitor (ELP) cells initialized in a virtual environment. The advance module can be configured to advance the ontogeny engine from a current step boundary to a next step boundary, wherein the advancing includes advancing each of the one or more virtual ELP cells in the virtual environment independent of each of the other virtual ELP cells. For example, the advancing can include the killCells function, the stepCells function, the stepECM function, the step Physics function, and/or other functions (e.g., “the functions”) operating on each virtual ELP cell independently from the other virtual ELP cells. In operation, the functions can be invoked in a first virtual ELP cell or, in another embodiment, in a first subpopulation of cells at a different time and/or rate than in a second virtual ELP cell or second subpopulation of cells. Accordingly, a step boundary for one cell can occur independent of a step boundary in an adjacent cell. In this manner, the cell-centric simulator can operate in a continuous manner and/or in a manner in which virtual lymphocyte cells can exhibit differential behavior.

In some embodiments, the visualization engine can generate and display a graphical image representing the current step boundary at a user interface. In one example, the graphical image can be a first graphical image, and the visualization engine can display a second graphical image representing the next step boundary in sequential order following the display of the first graphical image. In another embodiment, the visualization engine can provide progressive display of a plurality of graphical images either in real-time mode (e.g., during simulation), or off-line at one or more times following simulation. For example, the visualization engine can retrieve and render simulation data stored in files for replaying the simulation session (e.g., on a client computer, on a server, etc.). In a further embodiment, the visualization engine can provide a user interactive interface such that an operator can, in real-time, make a change to the simulation (e.g., perturb the environment, change a gene unit in one cell so that cell division and/or growth are not inhibited by neighbor cells, etc.). For example, the routine 600 (at decision block 612) can accommodate adjustment information received (at block 604) from the visualization engine user interactive interface, for initializing the ontogeny engine to an initial step boundary in accordance with the adjustment information.

In some embodiments, not shown, the output module can transmit simulation data to one or more data storage devices. In one embodiment, the output module can generate and transmit a recording file following the end 612 of the routine 600, wherein the recording file can be accessed at a subsequent time to “replay” the simulation, e.g., by the visualization engine. In another embodiment, the visualization engine can retrieve and render the recording data in the recording file such that a visual output of the recording can be manipulated (e.g., cells can be colored, cell connections displayed, visualize subspheres, rotate a point of reference, etc.). The visualization engine can also be configured to replay an entire simulation recording form the recording data, or in another embodiment, replay a sub-portion. Further, the visualization engine can capture “snap shot” images from the recording data in the recording file, e.g., from selected step boundaries.

In one embodiment, configuration files can be generated at any point (e.g., at any step boundary) during a simulation session, including a stop boundary (e.g., when a halting condition is encountered), transmitted (e.g., by the output module) and can be stored for later retrieval. For example, configuration files corresponding to any of the initial step boundary, 1^{st} step boundary, 2^{nd} step boundary, . . . n^{th} step boundary, n^{th}+1 step boundary, . . . stop boundary, etc., can be generated and stored for subsequent retrieval. In one embodiment, configuration files can include simulation information, including all configurable information used during the initiation of the ontogeny engine, as well as simulation information regarding the current step boundary from which the file was generated. In one embodiment, the experiment engine can be configured to access and retrieve a stored configuration file generated during a previous simulation session such that the configuration file can be used to run additional simulations. For example, a selected configuration file can be received by the receive module at block 604 (e.g., from the experiment engine) and the initialize module, at block 606, can initialize the ontogeny engine to an initial step boundary in accordance with the configurable simulation information provided in the selected configuration file. Accordingly, configurable simulation information derived from any step boundary and/or stop boundary can be used to initialize the ontogeny engine and, e.g., define an initial step boundary for initiating further simulation sessions.

In some embodiments, the experiment engine 22 can include a user-interface module 23 (FIG. 1A) for supporting user-selection of the configuration file. For example, the configuration file can be a user-selected file, and be selected from a plurality of stored configuration files. In such embodiments, the operator may be queried by and/or instruct the experiment engine to further alter the configurable simulation information stored in the configuration file. For example, the operator can perturb selected parameters (e.g., gene units, environmental parameters, chemical equations, action rules, etc.) and/or alter a simulation protocol prior to the initialization of the ontogeny engine at block 606. Accordingly, the simulation system can be used for iterative experiments and queries by an operator by running subsequent simulation sessions having selected parameters altered. An operator can compare results from a plurality of modeled sessions.

In a particular and non-limiting example, an operator may want to determine if and how development of lymphocytes can be altered when the cells are starved for nutrients at an intermediate point during development. In this example, an operator can choose to run a first simulation session wherein the configurable simulation information codes for a high level of modeled nutrient molecules. In a second simulation session, the operator can select a configuration file generated during an intermediate step boundary (e.g., 1^{st} step boundary, 2^{nd} step boundary, . . . n^{th} step boundary, n^{th}+1 step boundary, . . . etc.). Following selection of the desired configuration file, the receive module can receive, at block 604, the configuration file and additional configurable simulation information, wherein the additional information instructs a low level of modeled nutrient molecules. The initialize module can initialize the ontogeny engine (block 606) as described above and modeling of lymphocyte development can “continue” from the selected intermediate step boundary while in a virtual environment depleted of nutrient molecules. The operator can compare results of the first simulation session to the second simulation using, for example, the visualization engine, or some other data output device.

In other embodiments, the experiment engine 22 can be configured with additional programming logic for automatically selecting configuration files from which additional and/or different simulations can be generated. For example, a simulation session can be automatically implemented using the simulation system without requiring an operator to manually input or otherwise specify the configurable simulation information.

In one embodiment, experiment engine 22 can include a dynamic adjustment module 24 for capturing configuration files and automatically initiating additional simulation sessions for modeling biological events. One of ordinary skill in the art will recognize that the dynamic adjustment module 24 includes configurable hyper-directives (e.g., programmed rules for generating rules). Such hyper-directives allow the spontaneous generation of rules so that the dynamic adjustment module can automatically, and in real-time, run a plurality of directives in accordance with a plurality of simulations.

In one aspect, the dynamic adjustment module can be configured to recognize instances (e.g., at step boundaries, at a stop boundary, etc.) wherein criteria are met for generating a second or multiple simulation sessions. For example, the dynamic adjustment module can be configured to automatically spawn a second simulation following or to run concurrently with a first simulation (decision block 612). In such embodiments, the routine 600 may then continue at block 604, wherein the receive module receives configurable simulation information.

In further embodiments, the dynamic adjustment module 24 can be configured to alter a captured configuration file and/or user-configurable simulation information over multiple simulation sessions, such that the equivalent of multiple experiments can be simulated automatically. For instance, the dynamic adjustment module 24 can systematically and/or randomly alter the control region parameters (e.g., simulating constitutively active expression of a gene, simulating a gene “knock-out” or “knock-down”, etc.) of each of a targeted group of gene units in sequential simulation sessions. An operator can compare the results and/or final modeled output data from any simulation session (e.g., a first simulation session using a “wild-type” or normal gene unit configuration) to any other simulation session results (e.g., a second simulation session using a “knock-out” or absent gene-unit).

FIG. 6B is a flow diagram illustrating another routine for modeling lymphocyte differentiation supported by the simulation system 10 and in accordance with an embodiment of the disclosure. In block 30, a virtual ELP cell (or cells) is assigned a virtual genome, e.g., a set of gene units, each with specified gene control and gene product characteristics (described in more detail below). In some embodiments, one or more chemistry equations that govern the extra-genetic behavior of the molecules present in an environment or generated as a result of gene unit activity can be specified (described in more detail below). In block 32, a simulated environment is generated through specification of initial conditions (e.g., spatial parameters, virtual substrate characteristics, molecule types [external signals] present, molecule density, molecule gradient(s) within the environment, available nutrient(s), quantity and distribution of nutrients, etc.). In block 34, one or more virtual ELP cells can be placed in the virtual environment. For example, following blocks 30, 32 and 34, the ontogeny engine can be initialized to an initial step boundary (e.g., an initial static state in accordance with the configuration simulation information received in steps 30, 32 and 34).

Following initialization of the ontogeny engine, simulation of the one or more biological events includes advancing the ontogeny engine from a current step boundary to a next step boundary in accordance with the configurable simulation information and the current step boundary. Accordingly, at block 36, the state of each virtual ELP cell can be advanced in steps. Advancing can include applying at each step, one or more of the functions indicated at blocks 38, 40, 44 and 46. One of ordinary skill in the art will recognize that the ontogeny engine can perform one or more of these functions in any combination and/or order. It will also be recognized that each function employed during the advancing of the ontogeny engine can be performed in a sequential and/or simultaneous manner. In a further embodiment, one or more functions can be performed in an asynchronous manner.

The “killCells” function is configured to eliminate virtual lymphocyte cells from the virtual environment. The cells that are removed are the cells for which a cell death criterion was met (e.g., death gene unit activated, loss of activation of an essential gene unit, etc.) in the previous cell advancement step.

The “stepCells” function (block 40) is configured to update and/or refresh cell activity functions that are poised to be affected at that step, including gene activity, gene response, intracellular and intercellular signaling, etc. (described in more detail below). The stepCells function invokes the gene unit control region rules and chemistry equations (block 42) to determine the adjustment in the on/off and/or level of activity of each gene unit, change state of molecules acting within or on each cell, etc. For example, the chemistry equations and correlating changes in activity level of gene units can be applied to produce a “new cell state” for each cell. In response to new and/or step-wise refreshed interactions between molecules within a cell and each gene unit, each gene unit within the cell can contribute to the generation of molecules (e.g., increasing or decreasing the value of molecule strength in the cell, etc.). In biology, when a gene is transcribed, the transcriptional machinery of the cell synthesizes corresponding ribonucleic molecules (RNA) that are defined by the gene's structural region (e.g., open reading frame). Many of these RNAs are, in turn, translated by the cell's translation machinery into proteins having specific functions. Likewise, when gene units are acted upon, the simulation system is updated as though the gene units give rise to the correlative levels of the specific gene product for which the gene units represent. These newly generated molecules may in turn interact with the cell's other gene units in the virtual genome, affecting rates and/or levels of transcription during the next round of applied stepCells function. In some embodiments, the stepCells function can include rules that independently determine rates and/or levels of transcription and translation operations of gene unit templates.

Simulation of lymphocyte differentiation and developmental processes is thus governed, at each step advancement, through changes in the virtual external environment, as well as changes to the virtual internal cell environment. Using further complexity, a virtual lymphocyte cell can also be affected through chemical equations representing interaction with molecules generated by neighboring virtual lymphocyte cells. During simulation, the simplest neighborhood of a cell (the cells to/from which a virtual cell will send/receive signals) consists of those cells that are spatially adjacent to (touching) the cell of interest. However, a cell's neighborhood may be configured as any arbitrary group of cells. For example, a neighborhood could include cells that are not adjacent, as occurs in vivo with cells that are able to signal non-local cells via hormones.

In one embodiment, the “stepECM” function (block 44) can be invoked at each advancing step to update and/or refresh simulated adhesion properties between virtual lymphocyte cells and a virtual ECM, for example. For instance, the stepECM function can be configured to execute rule-based directives for breaking overextended cell adhesions, forming cell adhesions between adjacent cells, weakening cell adhesions over time, etc. (discussed in more detail below).

In addition to operations that increase or decrease a molecule strength value (e.g., analogous to concentration) during simulation, additional actions, such as cell growth, cell division and optionally, cell death, are applicable to each cell and each of these action affect the environment's spatial parameters. The virtual genome of a cell can include gene units that serve as a template for growth molecules, division molecules, death molecules, etc., and as these gene units are activated during the simulation session, the concentration of encoded molecules in the cell's virtual cytoplasm increases. In some embodiments, growth and/or death can be a function of the concentration of these two types of molecules. When a cell accumulates a threshold level of a death molecule, it can be removed from the environment in a subsequent advancing step. In another example, if a cell grows, its overall size (e.g., spherical diameter, volume, etc.) is increased. In a further example, if a cell divides, a new cell is placed in a location adjacent to the parent cell. If all adjacent positions are already occupied, operation rules can prevent a cell from dividing. Such operation rules can supersede other factors, such as division and/or growth potential exceeding a predetermined threshold for meeting a division and/or growth action rule requirement.

In one embodiment, the “stepPhysics” function (block 44) can be invoked at each advancing step to update and/or refresh simulation of physical forces on the virtual lymphocyte cells and/or molecules in the environment. For example, the stepPhysics function can move cells according to calculated forces in their environment (e.g., dividing cells, cell growth of neighboring cells, adhesion or attraction forces, etc.) In one embodiment, the stepPhysics function is configured to resolve overlaps between cells that arise from cell growth, division, and/or motion, including motion from prior calculations for resolution of cell overlap. The stepPhysics function invokes physical interaction rules (block 48) for specifying cell adhesion forces, rules for applying natural physical laws and rules for simulating the mechanics of moving cells (e.g., apart from one another during resolution of cell overlap, toward one another to resolve excessive cell motion, etc.) The stepPhysics function, can in one embodiment, be provided by or reside in source code for running by the physics engine.

In one embodiment, the stepPhysics function operates using spatially defined models described further herein. For example, the stepPhysics function can operate using (1) a fixed-coordinate, discrete-coordinate, or egg-carton model in which cells are assigned to predetermined two- or three-dimensional coordinates in space, similar to the bins of an egg carton; (2) a free-space or continuous-coordinate model in which each cell is represented by a solid sphere which is free to assume arbitrary coordinates in two- or three-dimensional space; and (3) a free-space model in which the cells are identified by a plurality of subspheres (e.g., a “bag of marbles”), and therefore, are free to assume arbitrary non-spherical shapes, e.g., flattened shapes. In general, a free-space model gives a much closer approximation to real-cell behavior, and may be required for modeling certain tissue behavior. In one embodiment, during each “advance-cells” loop (block 36), the stepPhysics function (block 46) runs several cycles, e.g., 20 cycles or greater, to iteratively resolve cell movement and overlap.

As indicated in FIG. 6B, the “advance-cells” loop is repeated until a halting condition is encountered end point is reached, at 50, terminating the run at 52. This end point may be defined by a pre-selected number of loops, or when the tissue reaches a stable or steady state.

Models for simulating lymphocyte differentiation (with or without a mechanism for maintaining a virtual ELP cell following one or more cell division events can be achieved using the above described simulation platform. In some embodiments, mechanisms and/or interaction pathways for abstracted (e.g., not detailed, etc.) virtual molecular interactions can be advantageous for investigative attempts to better appreciate the dynamics of such models.

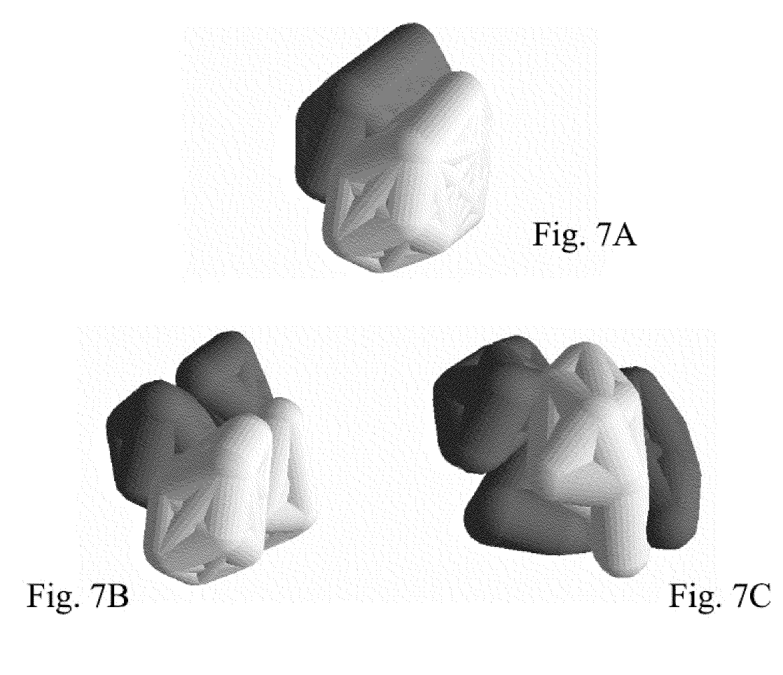

FIGS. 7A-7C are isometric views illustrating a simulation of a cell division event including an initial cell division event and a differentiation event resulting in two cell types (7A), a second cell division event resulting in two cells representing each cell type (7B), and a reversion event (7C) in accordance with embodiments of the disclosure. In one embodiment, an initial virtual cell having a configured virtual genome can be placed into a virtual environment having a specific molecular profile.

In FIG. 7A, the initial cell has divided to yield two virtual cells in the virtual environment. Following the division event depicted in FIG. 7A, signaling (e.g., as operated by a plurality of gene units, chemical-interaction rules, action rules, physical-interaction rules, etc.) between the two progeny cells can result in each of the virtual cells establishing a cell state (e.g., state of differentiation, etc.) different from the other virtual cell. For instance, a first cell can be configured to have a light-colored surface, and a second cell can be configured to have a dark-colored surface. Each of the light and dark colored cells can have properties that 1) allow the cell to retain its light or dark color, respectively, and/or 2) prevent the other cell from attaining its light or dark color, respectively. As such, this example illustrates one process used to simulate maintenance of cell identity and/or differentiation, as well as demonstrating how intercellular influences can influence a cell's identity.

FIG. 7B illustrates a second graphical image of the simulation output following a second division event. As shown in FIG. 7B the cell identity can be configured to be heritable and/or otherwise influenced by the parent cell. For example, the light-colored cell gave rise to two light-colored daughter cells, and the dark-colored cell gave rise to two dark-colored daughter cells. In further embodiments, virtual cells can be configured to revert to previous and change to a different cell state. For example simulated intercellular signaling pathways (e.g., as operated by a plurality of gene units, chemical-interaction rules, action rules, physical-interaction rules, etc.) can influence cells to alter a cell state. FIG. 7C illustrates this embodiment and shows that one of the light-colored cells has altered its cell state to become a black-colored cell, leaving only one remaining light-colored cell in the virtual cell cluster.

Daughter cells arising as a result of a cell division event from a parent cell having high DominationSignal levels can be initiated with some accumulated level of Dominator and DominatorSignal molecules, and accordingly, remain predisposed to generating high levels of DominationSignal molecules Likewise, daughter cells arising as a result of a cell division event from a parent cell having high Dominated molecule levels can be predisposed to generate high levels of Dominated molecules. Additionally, following a cell division event, each daughter cell can be subjected to DominatorSignal versus Dominated molecule competition until only once cell remains having a high level of Dominated molecules. The resulting cell with high levels of Dominated molecules can be configured to resist differentiation and/or further differentiation to other cell states or cell types. In this example, the neighboring cells in the virtual environment can proceed to differentiate if so stimulated.

The cell-centric simulator can be configured to create and initiate virtual ELP cells having a variety of and/or different virtual genomes. However, GENE UNITS 1 through 6 listed above in Table 1 are representative of gene units that can be included in virtual genomes regardless of the model being queried. Similarly, chemistry equations 1 through 9 listed above in Table 2 can be representative of a “standard set” of chemistry interactions associated with cellular transport, decay or renewal of molecules, and molecular interactions. Examples 1 through 3 described below illustrate different virtual tissue systems involving different and configurable virtual genomes and chemistry equations.

Essentially, three steps can be followed to develop a particular simulation model:
1) Describe the model: identify the criteria that indicates how the model will be recognized;
2) Define cell states: identify the various cell states expected to be seen in the model;
3) Write configuration file: encode the cell state transitions into a configuration with virtual genes and chemical-interaction rules.

To illustrate how the virtual genes, chemistry equations, environmental parameters, and other settings are specified to the ontogeny engine, it can be useful to consider a configuration hierarchy. One of ordinary skill in the art will recognize additional embodiments for specifying parameters and settings to the ontogeny engine, and the configuration files described below are considered to be exemplary. A detailed description and examples of configuration files and narrative pseudocode (a high level description of a computer programming algorithm for human reading) for developing a simulation model can be found in detail in U.S. patent application Ser. No. 11/899,927 and International Application No. PCT/US2008/075514, both of which are incorporated by reference in their entireties. For purposes of understanding the simulation models highlighted in Examples 1-3, elements of exemplary configuration files are described below. Moreover, pseudocode described and presented herein is understood to be exemplary only. Accordingly, one of ordinary skill in the art will recognize that other code and program instructions, order of steps, etc. can be used to implement the features and functions described herein.

In one embodiment, the MoleculeCatalog provides translations between named aliases and molecular signatures and properties. Each molecule has a name, a two-part signature, a decay rate, and an indivisible flag. The name is for ease of user reference during simulation or configuration; the signature is described in more detail below; and the decay rate describes a how quickly a molecule is reduced and removed from the simulation as a percentage (0.1=10% of the molecule per simulation step). If a molecule is indivisible, it cannot be divided between daughter cells during division, but must instead be allocated to only one of the two.

A molecular signature consists of an Indicant and a Sensitivity value. These values are used to calculate the Affinity between molecules and gene units. The Indicant is the molecule's interactive identity and the Sensitivity affects how much Affinity the molecule has for other molecules or gene units with different Indicants. An exact Indicant match between a molecule and gene unit yields a maximum Affinity of 1.0. As the difference between Indicants increases, Affinity decreases at a rate determined by the Sensitivity values of the molecule and gene unit. In one embodiment, Sensitivity values can be applied on an infinite scale. A molecule with a Sensitivity of 0.0 matches any gene unit; likewise, a gene unit with a Sensitivity of 0.0 matches any molecule. As Sensitivity increases, Indicants must match more closely for there to be significant interaction between molecules and gene units. Molecules A, B, and C below have very high Sensitivities (10) and call for a nearly exact Indicant match with a gene unit to have any effect. MoleculeD, however, with a low sensitivity of 0.5, could interact significantly with gene units having Indicants differing by as much as 5 from MoleculeD's Indicant.

<MoleculeCatalog>

MoleculeA [10, 10];
MoleculeB [20, 10] 0.2;
MoleculeC [30, 10] 0.0 I;
MoleculeD [40, 0.5];

</MoleculeCatalog>

The choice of Signal method and Signal settings determines how all signals originating in cells will be distributed between non-contacting cells. <FallOff> signaling allows signals to decrease in concentration in a smooth curve as distance increases. The meanings of settings for <FallOff> signaling are discussed under <Shade> below. <Local> signaling presents a fully concentrated signal across the specified separation distance, but none beyond. <Droplet> signaling diffuses signals through fluid droplets when fluid droplets are present in the simulation. <Linear> signaling decreases signal concentration linearly with distance.

Adhesions between two cells break if they exceed the specified separation distance. The example below specifies a separation distance of 0.25. This parameter primarily accounts for small separations that potentially result from incomplete physics resolution rather than breaking of an adhesion. In general, cell flexibility via Rigidity determines when cell adhesions are broken.

<MaxInterAdhesionLength>0.25</MaxInterAdhesionLength>

As discussed above, the Genome consists of a bracketed, comma-separated set of gene units. A gene unit consists of a bracketed Regulatory Region and a bracketed Structural Region. A Regulatory Region consists of a comma-separated set of Regulatory gene units. Each Regulatory gene unit has a molecule alias or an Indicant-Sensitivity pair, called a signature, and an Effect multiplier value. A Structural Region consists of a comma-separated set of Structural gene units, each of which is a molecule alias or signature.

Regulatory gene units either promote, with positive Effect values, or inhibit, with negative Effect values, transcription of the structural region of the gene unit. In each metabolic step, all internal molecules in a cell are compared to all Regulatory gene units and the promotion of the gene unit, based on the Affinity and concentration of each molecule, is multiplied by the gene unit's Effect value. If the net promotion of a Regulatory Region is positive, the molecules listed in the Structural Region are produced in the cell at a quantity matching the net positive promotion. If the net promotion of the Regulatory Region is zero or negative, no molecules are produced.

Shade is a bracketed collection of comma-separated molecular point sources, sometimes called gradient builders. In one embodiment, <UseRadius/> and <UseModifier/> are specified to designate a more complete description of the point sources.

Each point source description begins with an “S”, followed by a molecular alias or signature, an “@” (commercial-at) symbol, and completed with a sequence of floating-point values. The first three values of the numerical sequence are the X, Y, and Z coordinates of the point source. The fourth number is the concentration at the source location. To describe the shape of the gradient away from the source, the last three numbers are exponent, modifier, and radius values.

Setting the exponent value to 0 causes the gradient to be uniform at the full source concentration throughout the environment space. An exponent specified at greater than 1 describes a decrease in concentration at distance increases from the source.

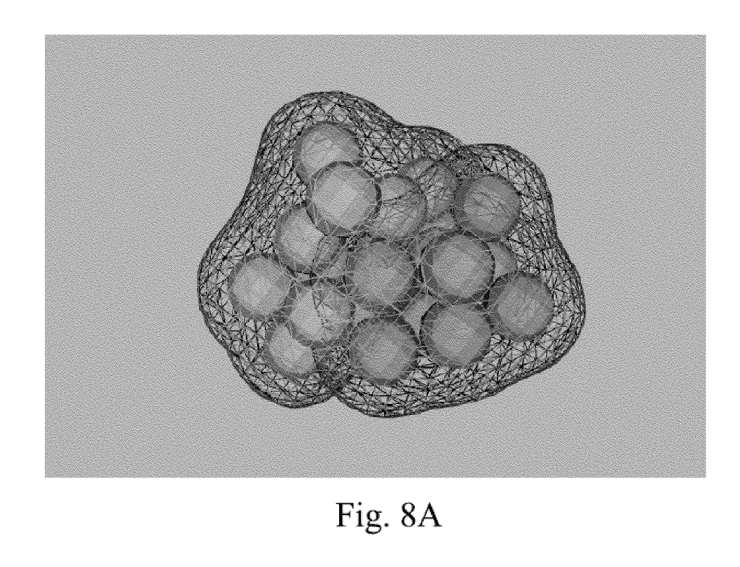

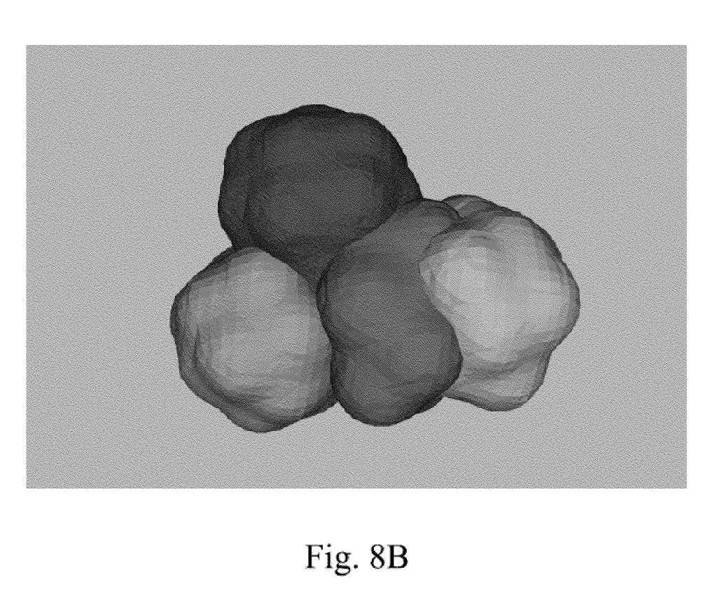

The following examples illustrate tissue and cellular differentiation modeling for lymphocyte development in thymic and/or bone marrow environments. The examples are configured as a free space environment where cells can be shaped with the marbles-in-a-bag approach (e.g., having one or more subspheres) and have cell movement and adhesion properties as those described in detail in U.S. patent application Ser. No. 11/899,927 and International Application No. PCT/US2008/075514, both of which are incorporated by reference in their entireties. FIGS. 8A and 8B are isometric views illustrating two simulated cells using a subsphere free-space model with (17A) and without (17B) visible internal subspheres. One or ordinary skill in the art will recognize that the simulation models described below can be configured to operate in other environments, such as a grid-space environment, and with other cell shapes (e.g., uniform spheres), as also described in detail in U.S. patent application Ser. No. 11/899,927 and International Application No. PCT/US2008/075514. The examples are intended to illustrate how the virtual genome and chemistry equations may be selected to achieve specific tissue and cellular behavior and morphology, but are in no way intended to limit the scope of the invention.

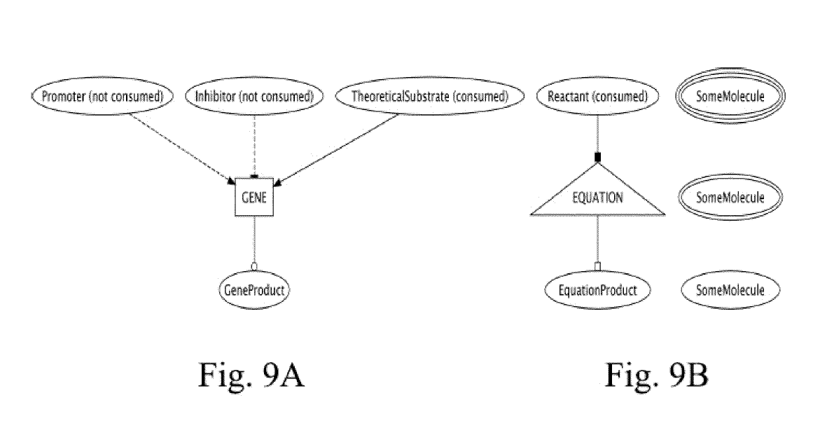

FIGS. 9A and 9B are schematic flow diagrams illustrating legends for interpreting flow diagrams describing molecules and actions in a modeled signaling and gene regulatory network (SGRN) in accordance with an embodiment of the disclosure. As seen in FIG. 9A, a gene unit, represented by a square box in the SGRN diagram, can be acted upon by a variety of molecules, indicated by single-line ovals. A dashed line with an arrow indicates a promoter that is not consumed, a dashed line with a tee indicates an inhibitor that is not consumed, and a solid line with an arrow indicates a substrate that is consumed when an action is invoked (e.g., via a chemical-interaction rule, etc.). Also in FIG. 9A, the gene unit product is indicated by a solid line terminating at an open circle.

In a further example, the legend in FIG. 9B represents a chemistry equation. Reactants consumed by the chemistry equation are indicated by solid lines terminating in solid boxes. Products of the chemistry equation are indicated by solid lines ending in an unfilled box. FIG. 9B also shows three ovals representing molecules: those with a three-line perimeter represent extracellular molecules, those with a two-line perimeter represent molecules on a cell surface, and those with a single-line perimeter represent molecules internal to a cell.

When a simulation is started, the developed configuration file is parsed and transmitted by the user interface to the ontogeny engine whereby the ontogeny engine is initialized to an initial step boundary from which subsequent steps may be taken. In one embodiment, the initial step boundary can define a reference point from which a simulation can commence or continue. In the present implementation, the ontogeny engine is driven one step at a time from the initial step boundary to subsequent step boundaries. The ontogeny engine may be implemented on any of a variety of computing systems known in the art. In one embodiment, the ontogeny engine supports user control of the number of steps performed in the simulation without additional instruction.

For each step in the ontogeny engine, one or more of the following functions, detailed below, can be performed until the user halts the simulation or a configured halting condition is reached:

killCells

stepCells

stepECM

stepPhysics

One of ordinary skill in the art will recognize that the ontogeny engine can be configured to perform one or more of these functions in any combination and/or order. For example, in some embodiments, the ontogeny engine can be advanced from an initial step boundary to subsequent step boundary by performing a stepCells function. In another embodiment, the advancing can include performing a stepCells function and a stepPhysics function. It will also be recognized that each function employed during the advancing of the ontogeny engine can be performed in a sequential and/or simultaneous manner. In a further embodiment, one or more functions can be performed in an asynchronous manner. For example, advancing from a first current step boundary to a next step boundary may include a stepCells function and advancing from a second current step boundary to a next step boundary may include a killCells function and a stepPhysics function.

As described above and with respect to FIG. 6B (at 37), killCells removes virtual cells marked for death in a previous step. When first marked by a flag set in the source code controlling the cell, cell death is treated as no longer performing any metabolic or transcription algorithms.

Upon being marked for death, the cell can begin a countdown to be removed from the simulation and so will no longer be involved in any physical interactions. In one embodiment, this countdown is satisfied immediately and so the cell will be removed immediately upon being marked for death.

The stepCells function (FIG. 6B; reference number 38) can be performed in each simulation step. In some embodiments each virtual cell can be independently subjected to internal step logic. In summary, signals from source cells are copied to target regions for detection by potential target cells, cells gather signals so placed, and the cells then perform a metabolism step.

The metabolizeCell function provides additional operation directives for the stepCells function described above. In one embodiment, if a cell has not been marked for death, the stepCells function will invoke a metabolic processing step. In one embodiment, a metabolic processing step can be configured to apply rules directed to metabolic interactions and genetic transcription calculations. Each metabolic interaction is computed to assess molecule flux (e.g., the molecule value consumed and produced according to the configured chemistry equations and gene units). The molecules produced from these virtual metabolism and genetic transcription calculations are then accumulated in the context of molecule strength and/or relative concentration. Over subsequent steps, the molecule strength values can be reduced so as to simulate molecular decay. If the cell has not reached its death threshold (that is, has not accumulated enough death action molecules), growth, adhesion, and division actions are performed if the cell has reached those respective thresholds.

Furthermore, the metabolizeCell function can include sub-functions such as a transcribeGenome function. Each gene unit, or a subset of gene units, of the genome can be compared for affinity and a corresponding promotion is calculated. If the promotion is sufficient to result in a concentration (e.g., strength value applied), the gene unit products specified in its structural region are produced and added to the cell's internal molecules, either as transfactors to be considered in future transcriptions or chemistry reactions or as action potentials accumulated for growth, division, etc.

As described above with respect to FIG. 6B (at reference number 41), the stepPhysics function can invoke physical interaction rules following metabolism to update a cell's location in response to cell death, division, growth, adhesion changes, or perturbation. In other embodiments, the stepPhysics function can be performed at any time or in any order with respect to other functions and operations during simulation. For stepPhysics operations, the unit spheres that represent the physical presence of cells (or ECM) can be treated with only limited regard to their cell (or ECM) membership. Accordingly, in one embodiment, each sphere location and velocity is updated iteratively based on forces calculated to be acting upon it.

### C. LYMPHOCYTE DIFFERENTIATION MODELS AND APPLICATIONS OF THE CELL-CENTRIC SIMULATION SYSTEM TO LYMPHOCYTE DIFFERENTIATION

Aspects of the present disclosure are directed to systems, methods and models for simulating differentiation pathways for lymphocytes, such as T cell and B cells, having selected behavioral and morphological properties, and for designing and implementing in silico experiments for perturbing such pathways.

T cell and B cell lymphocytes are components of the adaptive immune response. T cells are involved in cell-mediated immunity whereas B cells are primarily responsible for antibody production secretion (e.g., humoral immunity response). Both T cells and B cells originate from a common lymphoid progenitor before differentiating into their distinct lymphocyte types. The differentiation process of lymphocytes follow pathways in a hierarchical fashion, as well as somewhat plastic fashion that include into respective migration to the spleen (B cells) and to the thymus (T cells) for further development and maturation. T cell and B cell lymphocytes function to eliminate invading (e.g., non-self) pathogens or pathogen-infected cells through recognition of specific antigens.

### C1. Example 1

### Lineage Specific Differentiation Pathways

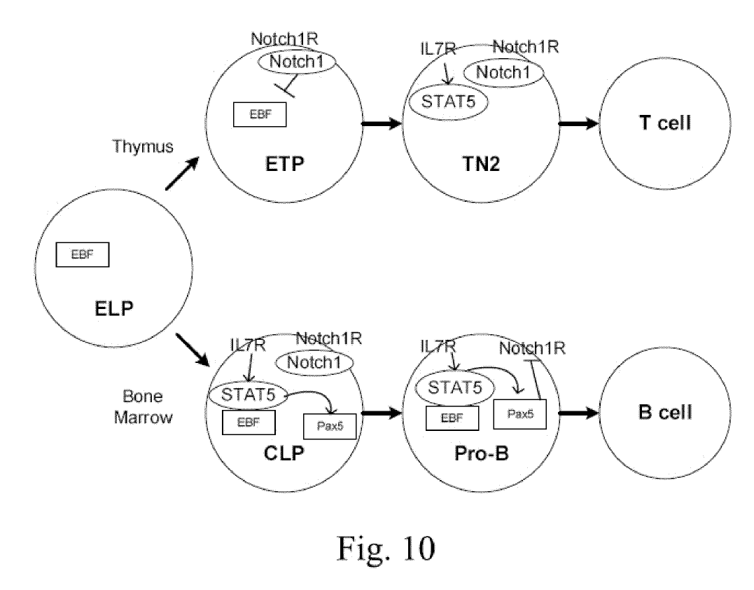

FIG. 10 is a schematic flow diagram illustrating T cell and B cell lineage-restricted differentiation pathways as adapted from Goetz et al. (2005. J. Immun., 174, 7753-7763; incorporated herein by reference in its entirety). As illustrated in FIG. 10, early lymphoid progenitor cells (ELPs) can differentiate into T cell and B cell type lymphocytes. In biology, ELPs give rise to early T cell progenitors (ETP) in the thymus, and common lymphoid progenitors (CLP) in the bone marrow. Some recent studies have suggested that the Notch1 receptor and the Pax5 transcription factor regulate, at least in part, B and T cell lineage commitment. For example, Notch1 signaling is required for T cell differentiation (and inhibits B cell differentiation), and the transcription factors Pax5 and early B cell factor (EBF) promote B cell development. Goetz et al. describe lineage specific differentiation pathways of early lymphoid progenitors (ELPs) into B and T cells. Goetz et al.'s in vitro experiments demonstrate that binary ELP differentiation can be promoted and/or determined by specific signaling ligands found in the cell's environment. Specifically, CLP cells express the cytokine receptor IL7R and the Notch 1 receptor, which respond to IL7R and Notch 1 signaling ligands respectively. IL7R activation results in activation of the STAT5 transcription factor, which in turn upregulates the Pax5 transcription factor.

In contrast, ETP cells express the Notch 1 receptor (prior to expression of IL7R). The Notch 1 receptor responds to Notch 1 signaling ligands in the thymic environment, which initiates a signaling cascade resulting in EBF inhibition and, thereby inhibition of Pax5 transcription factor production. According to the model proposed by Goetz et al., IL7R-induced STAT5 signaling ensures that B and T cell development are restricted to the bone marrow and thymic environments, respectively. Goetz et al. also propose a model wherein T versus B cell lineage commitment is dictated by a competition between Notch1 and STAT5 activation.

C1.1. Describing the Model

The objective of Example 1 is to develop an in silico model of ELP differentiation based on the gene regulatory network (GRN) model proposed by Goetz et al. and illustrated in FIG. 10. Cell clones developed with this model will reveal their lineage-specific behavior (wild-type lymphocytes) when subjected to a virtual thymic environment and a bone marrow environment.

C1.1.1. Defining Cell States

Lymphocyte: T cell and B cell type lymphocytes are white blood cells in the vertebrate immune system. These cells maintain a potential to grow but do not divide. They produce Notch1 receptors (Notch1R) and IL-7 receptors (IL7R) on their surface when not in the ELP state.

ELP: Early lymphoid progenitor cells are B and T cell progenitors. ELPs maintain a potential to divide, inhibit production of Notch1 and IL-7 receptors on their surface, and maintain a level of internal E2A molecules which promote the EBF gene.

ETP: Early T progenitor cells are cells that promote Notch 1 signaling prior to activation of the IL-7 signaling pathway to reinforce the transition into a TN2 cell state. Notch1 signaling is up-regulated and represses E2A and EBF expression, thereby indirectly inhibiting Pax5. At this stage of differentiation, Notch1 signaling has “won” the competition with IL-7 signaling, thereby preventing STAT5 activation.

CLP: Common lymphoid progenitor cells (e.g., early B cell progenitors) are characterized by having the IL-7 signaling pathway up-regulated, thereby activating STAT5 which, in turn, synergizes with EBF to reinforce the transition into the ProB cell state. At this stage of differentiation, IL-7 signaling has won the competition with Notch1 signaling, thereby allowing for STAT5 activation.

TN2: TN2 cells are cells that have committed to the T cell lineage pathway. IL-7 signaling is restored in this state which allows for STAT5 activation. E2A and EBF expression are non-detectable.

ProB: ProB cells are cells that have committed to the B cell lineage pathway. Pax5 and EBF genes have established a positive feedback loop and Notch1 signaling pathways are inhibited.

C1.1.2. Defining the Environments

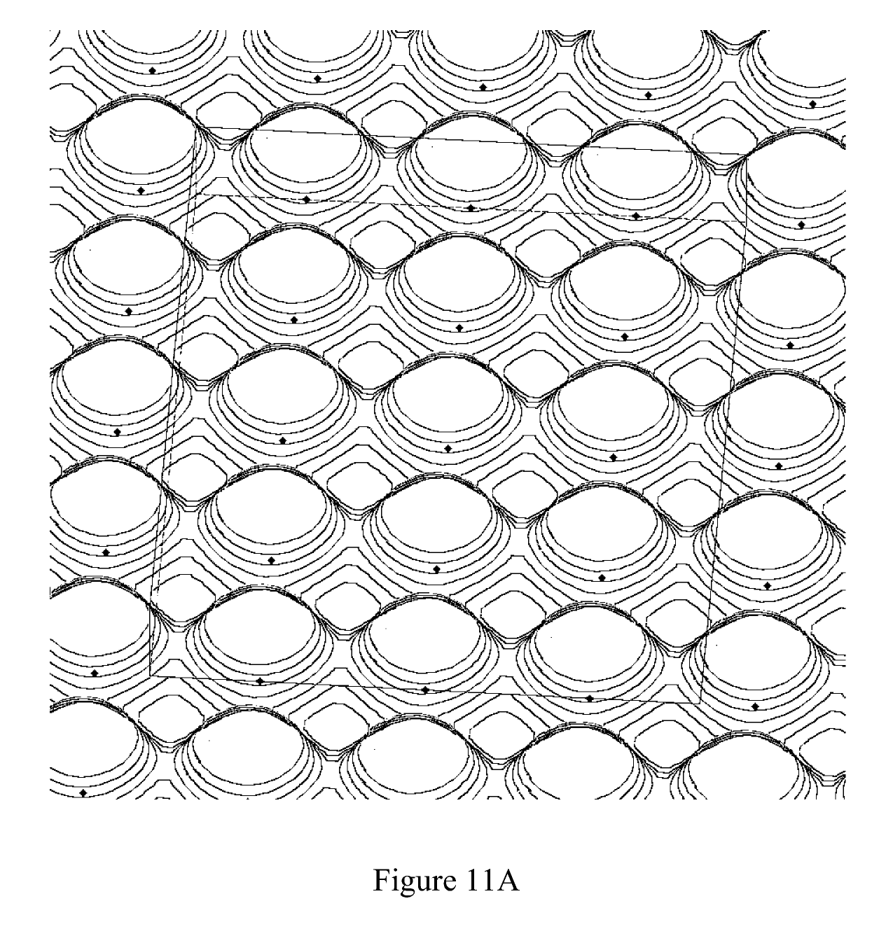

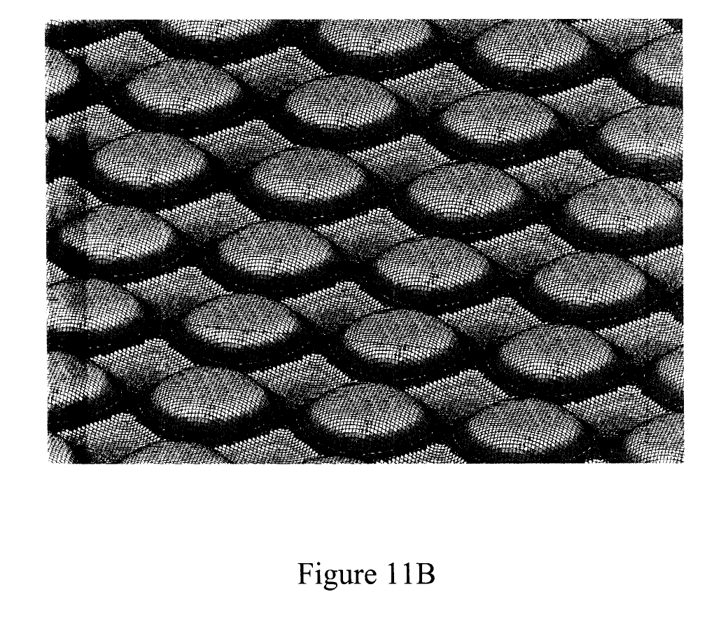

Thymic: The thymic environment consists of IL-7 signaling ligands and Notch1 signaling ligands. The IL-7 ligands are modeled using a uniform point source (IL7Ligand) to form a homogeneous landscape. The Notch1 ligands are modeled using an array of localized point sources (Notch1Ligand) to form a heterogeneous landscape. FIGS. 11A-11B are schematic illustrations of a simulated thymic environment showing a three-dimensional (3D) contour view (FIG. 11A), and a 3D shaded contour relief view (FIG. 11B) of the heterogeneous Notch1 ligand landscape. Referring to FIGS. 11A and 11B together, the raised portions of the contour relief landscape represent the array of point sources of the Notch1 ligand. For example, the source points represent the highest level of Notch1 ligand concentration. The intervening “valleys” between the raised portions represent the low levels of Notch1 ligands. Accordingly, the contours visualized in FIGS. 11A and 11B represent differing concentrations the Notch1 ligand in the landscape.

Bone Marrow: This environment consists of IL-7 signaling ligands modeled as a uniform point source (IL7Ligand). Small traces of Notch1 ligands exist in this environment; however, these ligands are presented at a level insufficient to induce effective Notch1 signaling.

C1.2. Writing the Configuration File

In the present embodiment, the configuration is designed starting from a simulation configuration template, with details interpreted in previous examples and in section E. One of ordinary skill in the art will recognize additional and/or alternative simulation configuration templates and/or configuration files.

C1.2.1. Basic Components

In this example, the configuration file was designed with basic components that may not need to change from one modeling effort to the next. For example, this type of configuration can serve as a template for various future models. Most of the configured parameters in this template stem from prior analysis of the modeling system and tend to work well with a plurality of models. However, one of ordinary skill in the relevant art will recognize other configuration files suitable for use with one or more models. Following is an example template to begin designing the model.

### Configuration Example:

<CsIndividual>

<Simulation>

<Physics>

<MaxVelocityChange>0.1</MaxVelocityChange>
<TimePerStep>0.1</TimePerStep>
<DampingMultiplier>3.0</DampingMultiplier>
<NudgeMagnitude>3.0</NudgeMagnitude>
<RepulsionMultiplier>1.0</RepulsionMultiplier>

</Physics>
<Cell>

<Promoter>

<Smoother>

<PromotionMidpoint>5.0</PromotionMidpoint>
<Slope>3.0</Slope>
<ActiveConcentration>1.0</ActiveConcentration>

</Smoother>

</Promoter>
<Chemistry><Default/></Chemistry>

</Cell>

</Simulation>

</CsIndividual>

To constrain an area where cells can move and grow during simulation, a virtual dish is added under <Physics>. In this example, the dish has a radius of 10.0, the center of which is centered at coordinates [0.0, −1.0, 0.0]. In some embodiments, the virtual dish can be configured with infinitely high walls so that the virtual environment and virtual cells remain constrained within the dish. Conceptually, this dish can be thought of as a Petri dish; however, one of ordinary skill in the art will recognize that a plurality of container sizes and/or shapes may be designated in the configuration file. Also, adding a gravity rule under <Physics> will allow cells to maintain contact with the surface of the dish.

### Configuration Example:

<Gravity>0.85</Gravity>
<Container>

<Dish>[0.0, −1.0, 0.0] 10</Dish>

</Container>

To grow a maximal number of cells in the area defined by the dish and to limit the cell size, the minimum, maximum, and initial cell sizes are set to 1, 2, and 1, respectively. This is configured under <Cell>.

### Configuration Example:

<MinimumSize>1</MinimumSize>
<MaximumSize>2</MaximumSize>
<InitialSize>1</InitialSize>

C1.2.2. Configure the Environment

Both the bone marrow and thymic environments contain IL-7 ligands. These ligands can be simulated with a single uniform IL7Ligand point source. Also, both environments contain Notch1 ligands. However, the bone marrow contains a negligible amount of Notch1 ligands (i.e. very low levels that do not affect B cell development). Therefore, the only difference between defining the Notch1Ligand point sources in one environment vs. the other is the strength parameter. A single uniform Notch1Ligand point source can be defined to simulate the Notch1 ligands. Since activation of Notch1 curbs T versus B cell fate decisions, the configuration file is created using a heterogeneous landscape of Notch1 ligands.

A) Bone Marrow Environment

An IL7Ligand entry of <Shade> under <CsIndividual> is added with a strength value of 100.0 and an exponent of 0.0. With an exponent of 0.0, the concentration of IL7Ligand will be 100.0 at every point in the environment; the location, modifier, and radius values are irrelevant in this specific example. Since Notch1Ligand exists in both environments (at varying strengths) they can be defined by the strength of the Notch1Ligand point sources. In the bone marrow environment, they are defined at low levels to simulate the natural bone marrow environment.

### Configuration Example:

<Shade>

<UseModifier/><UseRadius/>
[
S IL7Ligand @ 1000 1000 1000 100 0 2 1
,S Notch1Ligand @ 0 0 0 0.1 0 1 1
,S Notch1Ligand @ 0 0 0 0.1 1 5 2
,S Notch1Ligand @ −5 0 0 0.1 1 5 2
]

</Shade>

B) Thymic Environment

An IL7Ligand entry of <Shade> under <CsIndividual> is added with a strength value of 100.0 and an exponent of 0.0. With an exponent of 0.0, the concentration of IL7Ligand will be 100.0 at every point in the environment; the location, modifier, and radius values are irrelevant in this specific example. Since Notch1Ligand exist in both environments (at varying strengths) they can be defined by the strength of the Notch1Ligand point sources. In the thymic environment, they are defined at higher levels to simulate the natural thymic environment.

### Configuration Example:

<Shade>

<UseModifier/><UseRadius/>
[
S IL7Ligand @ 1000 1000 1000 100 0 2 1
,S Notch1Ligand @ 0 0 0 3 0 1 1
,S Notch1Ligand @ 0 0 0 100 1 5 2
,S Notch1Ligand @ −5 0 0 100 1 5 2
]

</Shade>

C1.2.3. Configure Metabolic Components

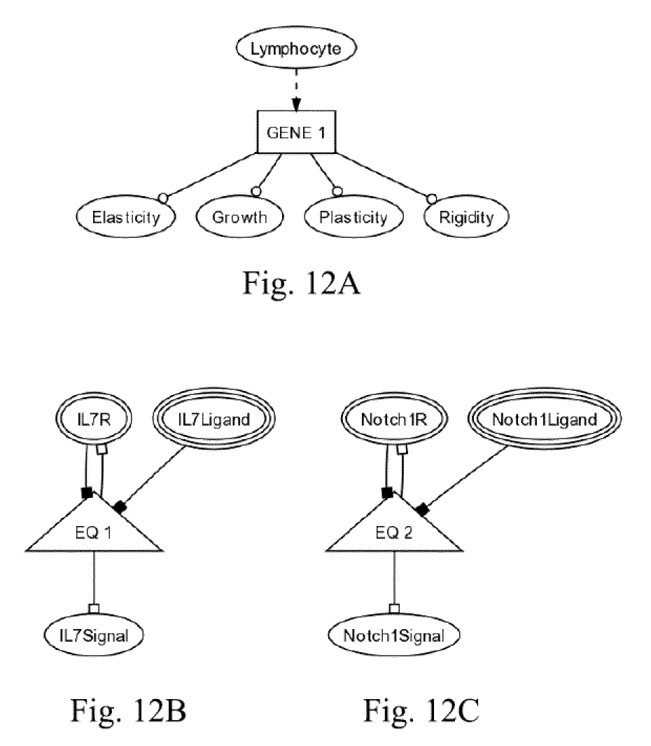

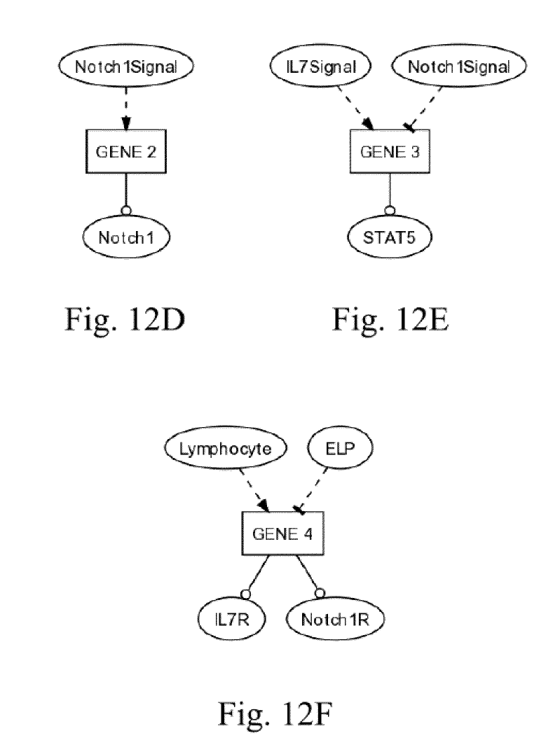

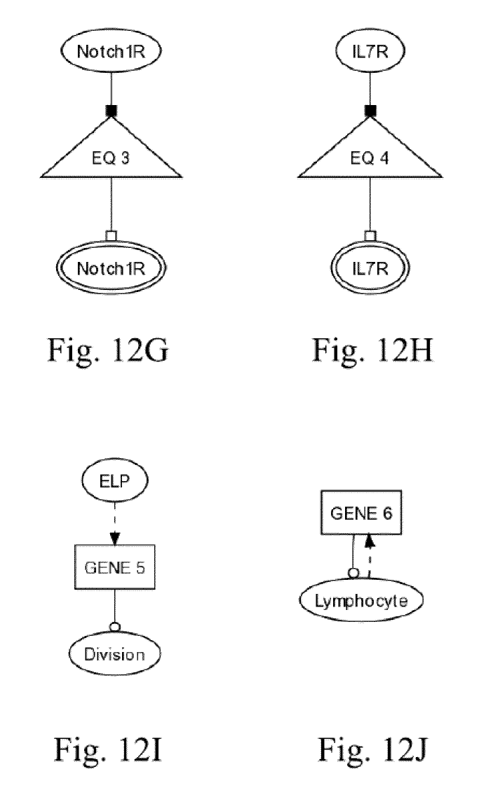

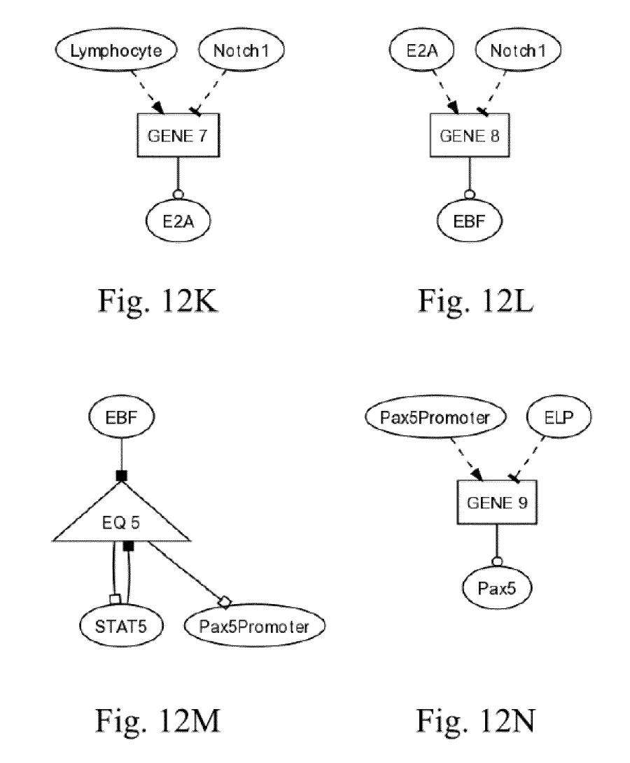

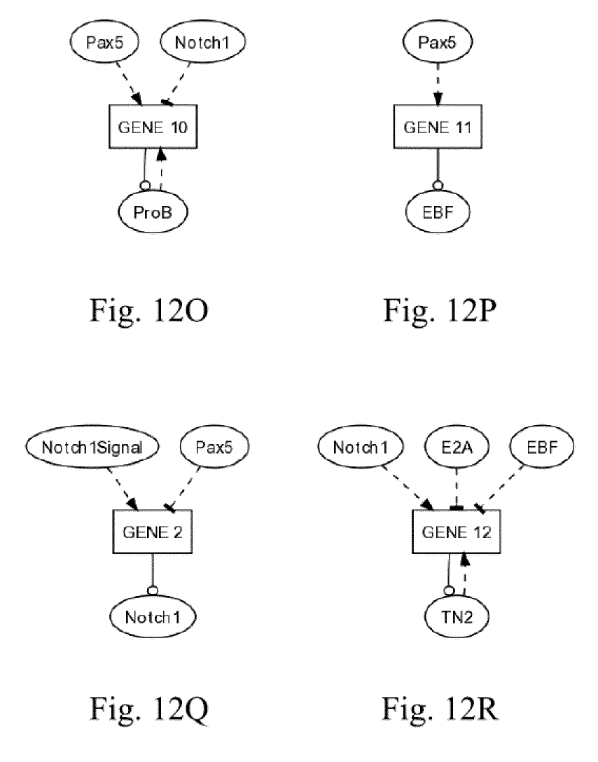

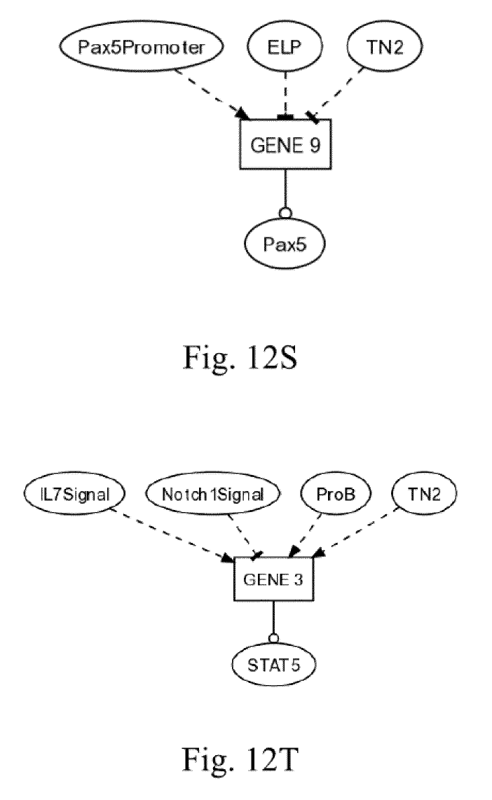

FIGS. 12A-12T are schematic flow diagrams illustrating molecules and actions, virtual genes and gene products, and chemical-interaction rules for modeling lineage-restricted lymphocyte differentiation pathways in accordance with the simulation of biological events described in Example 1 of section C1 and in accordance with an embodiment of the disclosure.

By default, the initial cell in a simulation contains no molecules. <InitialChemistry> specifies the contents with which to initialize the cell(s). The initially-defined cells in this model are ELPs. For purposes of modeling, each cell is also defined as a “lymphocyte.” Therefore, an initial starting concentration of these molecules is added to <InitialChemistry> under <Cell>.

### Configuration Example:

<InitialChemistry>

Lymphocyte 10
ELP 10

</InitialChemistry>

To simulate natural ELP and mature lymphocyte cell growth, the configuration file is configured to maintain the cells with physical properties. As shown in FIG. 12A, a gene unit is added to <Genome> under <CsIndividual> to produce these molecules.

### Configuration Example:

<Genome>
[

[ Lymphocyte 1.0 ] [ Growth, Rigidity, Plasticity, Elasticity ]

]
</Genome>

To initiate IL-7 and Notch1 signaling pathways, two chemistry equations are added as an entry of <ChemistryEquations> under <Cell> (FIG. 12B; FIG. 12C). Two signal molecules, IL7Signal and Notch1Signal, are created so that they can be used to trigger the appropriate gene unit response pathways.

### Configuration Example:

<ChemistryEquations>

{ IL7Ligand } + ( IL7R ) = ( IL7R ) + IL7Signal;
{ Notch1Ligand } + ( Notch1R ) = ( Notch1R ) + Notch1Signal;

</ChemistryEquations>

The initial gene unit responses to signal production are achieved with two gene unit assemblies defined under <Genome> (FIG. 12D; FIG. 12E). Since Notch1 signaling blocks IL-7 signaling, the Notch1Signal is used to inhibit the IL-7 signal response gene unit. Production of two molecules, Notch1 and STAT5, are the initial result of the chemical-interaction rules. Conceptually, if Notch1 signals are weaker than IL-7 signals, then IL-7 signaling will win the competition. In contrast, if Notch1 signals are stronger than IL-7 signals, the Notch1 signaling pathway will determine the lineage-restricted outcome.

### Configuration Example:

[ Notch1Signal 1.2 ] [ Notch1 ]
[ IL7Signal 1, Notch1Signal −1 ] [ STAT5 ]

To achieve a “one step only” external signal (i.e. a signal pulse), molecules can be defined as 100% decaying. For example, a 100% decaying molecule will be fully consumed or eliminated from the environment once the molecule triggers a chemistry equation. In this model, the IL7Signal and the Notch1Signal are pulse signals. The following are defined in <MoleculeCatalog> under <CsIndividual>.

### Configuration Example:

<MoleculeCatalog>

Notch1 Signal [ 700, 10 ] 1.0;
IL7Signal [ 1000, 10 ] 1.0;

</MoleculeCatalog>

Lymphocyte cells produce Notch1R and IL7R molecules to support their respective signaling pathways. However, if the Lymphocyte is also classified as an ELP cell then these receptor molecules are inhibited from production. This inhibition blocks these receptors from being created until ELP progeny are generated through division. Therefore, a gene unit assembly is created to model this inhibitory behavior (FIG. 12F).

### Configuration Example:

[Lymphocyte 1, ELP −2] [Notch1R, 1L7R]

Since gene unit transcription produces molecules internal to the cell, the Notch1R and IL7R molecules can be moved to the surface of the cell to support the Notch1 and IL-7 signaling pathways. This is done by creating the following equations under <ChemistryEquations> (FIG. 12G; FIG. 12H).

### Configuration Example:

Notch1R=(Notch1R);

IL7R=(IL7R);

ELP cells can divide so that progeny can begin specific lineage pathway commitment. A gene unit assembly under <Genome> is defined to produce Division molecules (FIG. 12I). A promotion effect of 0.15 allows for slower build-up of Division molecules within the cell. In this embodiment, the promotion effect of 0.15 ensures that division does not occur at every step of the simulation.

### Configuration Example:

[ELP 0.15][Division]

In the present example, when an ELP divides into two cells, one of the cells remains an ELP and the other is subject to a differentiation mechanism. The modeling platform supports a method for allowing this division protocol to occur without having to define a complete differentiation pathway via gene units and equations. This division protocol is achieved by defining certain molecules as “indivisible”. For example, only one cell from each cell division event will get indivisible molecules. In the present model, the “ELP” molecule serves as a marker and regulator for the ELP cell type. Therefore the ELP molecule can be defined as indivisible, and in further embodiments, can be decay resistant. ELP is defined under <MoleculeCatalog> to be indivisible and non-decaying.

### Configuration Example:

ELP [300, 10] 0.0 I;

To maintain and regulate the “Lymphocyte” molecule levels within a cell, a gene-based feedback loop can be created under <Genome> (FIG. 12J).

### Configuration Example:

[Lymphocyte 10] [Lymphocyte]

Also, to keep the “Lymphocyte” molecule levels fairly constant, the corresponding molecule decay rate of the Lymphocyte molecule can be defined as 0.5 (i.e. 50% per step) under <MoleculeCatalog>.

### Configuration Example:

Lymphocyte [200, 10] 0.5

In this example, all cell types can either express or inhibit the E2A gene unit products. In the ELP, CLP, and ProB states, cells can express E2A. In contrast, in the ETP state, up-regulation of Notch1 represses E2A production. This relationship can be captured with a single gene unit assembly (FIG. 12K).

### Configuration Example:

[Lymphocyte 1, Notch1 −1] [E2A]

In this example, E2A molecules promote the EBF gene unit. Also in this example, Notch1 represses EBF production (FIG. 12L).

### Configuration Example:

[E2A 1, Notch1 −2] [EBF]

STAT5 and EBF synergize to reinforce the B cell lineage pathway by activating Pax5 production. In order to enforce this example's requirement that both molecules must be present to activate Pax5, a chemistry equation is appropriate and defined under <ChemistryEquations> (FIG. 12M).

### Configuration Example:

3 STAT5+EBF=STAT5+1.5 Pax5Promoter;

To allow for additional control factors to be implemented on Pax5 promotion, the “activated” Pax5 Promoter is the result of the STAT5 and EBF synergy equation, in this example. This relationship enables gene unit-based Pax5 production to be regulated by various molecules as needed. Also, ELP cells can be configured to repress the Pax5 gene unit (FIG. 12N).

### Configuration Example:

[Pax5 Promoter 1.2, ELP −1.5][Pax5]

In the present model, the presence of Pax5 enables cells to transition into a ProB cell. To reinforce the commitment to the ProB cell state, the ProB gene unit has been configured to reinforce its own activation (FIG. 12O). Also, during commitment to a ProB cell, Pax5 and EBF establish a positive feedback loop (FIG. 12P). Pax5 can further be configured to inhibit Notch1 signaling. For example, Pax5 can be added as an inhibitor to the Notch1 signal response gene unit (FIG. 12Q).

### Configuration Example:

[ Pax5 1, ProB 3 ] [ ProB ]
[ Pax5 3 ] [ EBF ]
[ Notch1 Signal 1.2, Pax5 −1.2 ] [ Notch1 ]

As discussed above, Notch1 molecules (in the intracellular environment) are the result of the chemical interaction between Notch1 signals and the Notch1 receptor. This relationship reinforces the T cell lineage pathway. To model this relationship, the Notch1 molecules activate the TN2 gene unit. The TN2 gene unit reinforces itself through a feedback loop. In one embodiment, the TN2 cell state is not recognized until EBF and E2A molecules are no longer present in the intracellular environment. In one embodiment, the E2A and EBF can be configured to repress the TN2 gene unit (FIG. 12R). Since Notch1 has been previously configured to repress the E2A and EBF gene units, the transition to the TN2 cell state can be achieved. Additionally, the Pax5 gene can be inhibited under this regime since it reinforces the B cell lineage pathway (FIG. 12S).

### Configuration Example:

[ Notch1 1, TN2 1, EBF −10, E2A −10 ] [ TN2 ]
[ Pax5Promoter 1.2, ELP −1.5, TN2 −1.5 ] [ Pax5 ]

The ProB and TN2 committed cell types ensure that the IL-7 signaling pathway is restored and active (FIG. 12T).

### Configuration Example:

[IL7Signal 1, Notch1Signal −1, TN2 1, ProB 1] [STAT5]

C1.2.4 Initializing Simulation

To begin a simulation session, one or more cells can be initiated into the virtual area previously defined (e.g., virtual Petri dish, thymic environment, bone marrow environment, etc.). This operation can be defined in the <InitialCellLocations> under <Simulation>.

### Configuration Example:

<InitialCellLocations>

[ 0.0, 0.0, 0.0 ];
[ 5.0, 0.0, 0.0 ];
[ −5.0, 0.0, 0.0 ];
[ 0.0, 0.0, 5.0 ];
[ 0.0, 0.0, −5.0 ];

</InitialCellLocations>

C1.2.5. Configuration File Results

A) Wild-Type Lymphocyte in Bone Marrow

In the example discussed above, a resulting configuration is shown below:

<CsIndividual>

<Simulation>

<InitialCellLocation>

[ 0.0, 0.0, 0.0 ];
[ 5.0, 0.0, 0.0 ];
[ −5.0, 0.0, 0.0 ];
[ 0.0, 0.0, 5.0 ];
[ 0.0, 0.0, −5.0 ];

</InitialCellLocation>
<Physics>

<Container><Dish>[0.0, −1.0, 0.0] 10.0</Dish></Container>
<Gravity>0.85</Gravity>
<MaxVelocityChange>0.1</MaxVelocityChange>
<TimePerStep>0.1</TimePerStep>
<DampingMultiplier>3.0</DampingMultiplier>
<NudgeMagnitude>3.0</NudgeMagnitude>
<RepulsionMultiplier>1.0</RepulsionMultiplier>

</Physics>
<Signal><No/></Signal>
<Cell>

<Promoter>

<Smoother>

<PromotionMidpoint>5.0</PromotionMidpoint>
<Slope>3.0</Slope>
<ActiveConcentration>1.0</ActiveConcentration>

</Smoother>

</Promoter>
<Chemistry><Default/></Chemistry>
<MaximumSize>2</MaximumSize>
<InitialSize>1</InitialSize>
<MinimumSize>1</MinimumSize>
<ChemistryEquations>

Notch1R = (Notch1R);
IL7R = ( IL7R );
3 STAT5 + EBF = STAT5 + 1.5 Pax5Promoter;
{ IL7Ligand } + ( IL7R ) = ( IL7R ) + IL7Signal;
{ Notch1Ligand } + ( Notch1R ) = ( Notch1R ) + Notch1Signal;

</ChemistryEquations>
<InitialChemistry>

Lymphocyte 10.0
ELP 10.0

</InitialChemistry>

</Cell>

</Simulation>
<MoleculeCatalog>

Lymphocyte [ 200, 10 ] 0.5;
ELP [ 300, 10 ] 0.0 I;
E2A [ 400, 10 ];
EBF [ 500, 10 ];
Notch1R [ 600, 10 ];
Notch1Signal [ 700, 10 ] 1.0;
Notch1 [800, 10 ];
IL7R [ 900, 10 ];
IL7Signal [ 1000, 10 ] 1.0;
STAT5 [ 1100, 10 ];
Pax5Promoter [ 1200, 10 ];
Pax5 [ 1300, 10 ];
ProB [ 1400, 10 ];
TN2 [ 1500, 10 ];

</MoleculeCatalog>
<Genome>
[

[ Lymphocyte 10 ] [ Lymphocyte ],
[ Lymphocyte 1, ELP −2 ] [ Notch1R, IL7R ],
[ Lymphocyte 1, Notch1 −1 ] [ E2A ],
[ E2A 1, Notch1 −2 ] [ EBF ],
[ Notch1Signal 1.2, Pax5 −1.2 ][ Notch1 ],
[ IL7Signal 1, Notch1Signal −1, TN2 1, ProB 1 ] [ STAT5 ],
[ Notch1 1, TN2 1, EBF −10, E2A −10 ] [ TN2 ],
[ Pax5Promoter 1.2, TN2 −1.5, ELP − 1.5 ] [ Pax5 ],
[ Pax5 3] [ EBF ],
[ Pax5 1, ProB 3, Notch1 −10] [ ProB ],
[ ELP 0.15 ] [ Division ],
[ Lymphocyte 1 ] [ Rigidity, Elasticity, Plasticity, Growth ]

]
</Genome>
<Shade>

<UseModifier/><UseRadius/>
[

S IL7Ligand @ 1000 1000 1000 100 0 2 1
,S Notch1Ligand @ 0 0 0 0.1 0 1 1
,S Notch1Ligand @ 0 0 0 0.1 1 5 2
,S Notch1Ligand @ −5 0 0 0.1 1 5 2

]

</Shade>

</CsIndividual>

B) Wild-Type Lymphocyte in Thymus

In the example discussed above, a resulting configuration is shown below:

<CsIndividual>

<Simulation>

<InitialCellLocation>

[ 0.0, 0.0, 0.0 ];
[ 5.0, 0.0, 0.0 ];
[ −5.0, 0.0, 0.0 ];
[ 0.0, 0.0, 5.0 ];
[ 0.0, 0.0, −5.0 ];

</InitialCellLocation>
<Physics>

<Container><Dish>[0.0, −1.0, 0.0] 10.0</Dish></Container>
<Gravity>0.85</Gravity>
<MaxVelocityChange>0.1</MaxVelocityChange>
<TimePerStep>0.1</TimePerStep>
<DampingMultiplier>3.0</DampingMultiplier>
<NudgeMagnitude>3.0</NudgeMagnitude>
<RepulsionMultiplier>1.0</RepulsionMultiplier>

</Physics>
<Signal><No/></Signal>
<Cell>

<Promoter>

<Smoother>

<PromotionMidpoint>5.0</PromotionMidpoint>
<Slope>3.0</Slope>
<ActiveConcentration>1.0</ActiveConcentration>

</Smoother>

</Promoter>
<Chemistry><Default/></Chemistry>
<MaximumSize>2</MaximumSize>
<InitialSize>1</InitialSize>
<MinimumSize>1</MinimumSize>
<ChemistryEquations>

Notch1R = (Notch1R);
IL7R = ( IL7R );
3 STAT5 + EBF = STAT5 + 1.5 Pax5Promoter;
{ IL7Ligand } + ( IL7R ) = ( IL7R ) + IL7Signal;
{ Notch1Ligand } + ( Notch1R ) = ( Notch1R ) + Notch1Signal;

</ChemistryEquations>
<InitialChemistry>

Lymphocyte 10.0
ELP 10.0

</InitialChemistry>

</Cell>

</Simulation>
<MoleculeCatalog>

Lymphocyte [ 200, 10 ] 0.5;
ELP [ 300, 10 ] 0.0 I;
E2A [ 400, 10 ];
EBF [ 500, 10 ];
Notch1R [ 600, 10 ];
Notch1Signal [ 700, 10] 1.0;
Notch 1 [ 800, 10 ];
IL7R [ 900, 10 ];
IL7Signal [ 1000, 10 ] 1.0;
STAT5 [ 1100, 10 ];
Pax5Promoter [ 1200, 10 ];
Pax5 [ 1300, 10 ];
ProB [ 1400, 10 ];
TN2 [ 1500, 10 ];

</MoleculeCatalog>
<Genome>
[

[ Lymphocyte 10 ] [ Lymphocyte ],
[ Lymphocyte 1, ELP −2 ] [ Notch1R, IL7R ],
[ Lymphocyte 1, Notch1 −1 ] [ E2A ],
[ E2A 1, Notch1 −2] [ EBF ],
[ Notch1Signal 1.2, Pax5 −1.2 ][ Notch1 ],
[ IL7Signal 1, Notch1Signal −1, TN2 1, ProB 1 ] [ STAT5 ],
[ Notch1 1, TN2 1, EBF −10, E2A −10 ] [ TN2 ],
[ Pax5Promoter 1.2, TN2 −1.5, ELP −1.5 ] [ Pax5 ],
[ Pax5 3 ] [ EBF ],
[ Pax5 1, ProB 3, Notch1 −10] [ ProB ],
[ ELP 0.15 ] [Division],
[ Lymphocyte 1 ] [ Rigidity, Elasticity, Plasticity, Growth ]

]
</Genome>
<Shade>

<UseModifier/><UseRadius/>
[

S IL7Ligand @ 1000 1000 1000 100 0 2 1
,S Notch1Ligand @ 0 0 0 3 0 1 1
,S Notch1Ligand @ 0 0 0 100 1 5 2
,S Notch1Ligand @ −5 0 0 100 1 5 2

]

</Shade>

</CsIndividual>

C1.3. Modeling Results and Additional Experimental Embodiments

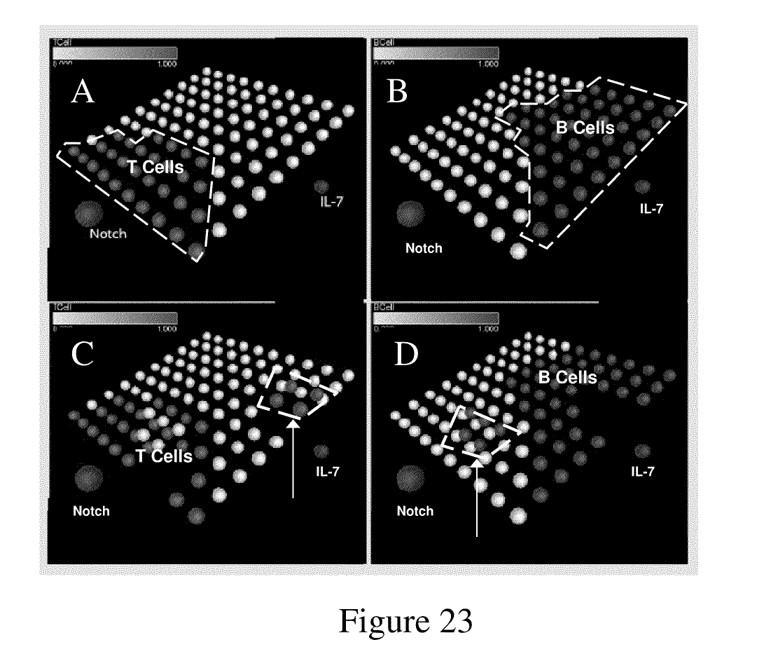

The cell-centric simulator was used to simulate lineage commitment in early lymphocyte progenitor (ELP) cells. To establish the lineage commitment potential of virtual ELPs according to one embodiment, 10×10 fixed grids of ELP cells were exposed to orthogonal gradients of Notch and IL7 ligands (FIG. 23). Cells near the Notch source became T cells (FIG. 23A) and cells near the IL7 source became B cells (FIG. 23B), but when the concentrations of both signaling molecules were low, ELPs remained uncommitted. Uncommitted cells that are pushed toward the Notch source or toward the IL7 source committed to the T cell or B cell lineage, respectively, and such commitment was irreversible. T cells displaced toward higher IL7 concentrations or B cells exposed to higher Notch levels retained their original commitment decision (FIGS. 23C and 23D, arrows).

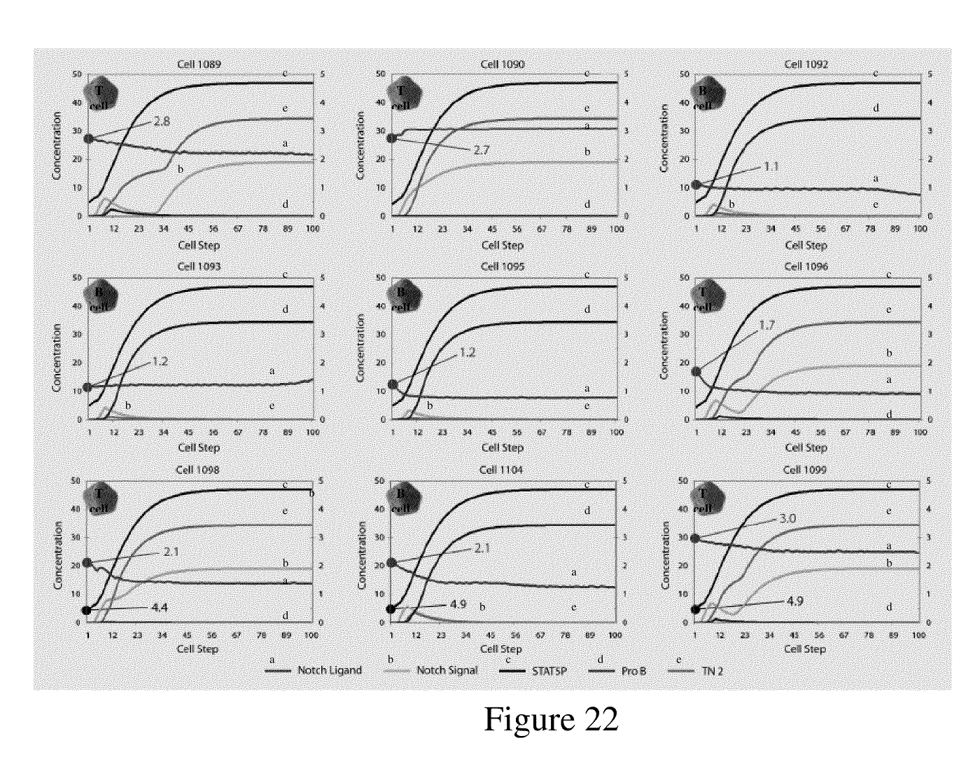

In another embodiment, the molecular contents of transgenic virtual ELP progeny (see description of a transgenic lymphocyte model in the following section) were studied to ascertain early patterns of gene expression and gene product abundance that determine whether a particular cell commits to T cell or B cell lineage. By simultaneously monitoring the intracellular concentrations of phosphorylated STAT5 (STAT5P), Notch (Notch Signal) and two lineage specific markers (ProB and TN 2) in 188 ELP progeny exposed to a heterogeneous landscape of Notch ligand, it was determined that initial intensity of Notch- versus STAT5-dependent signals control lineage commitment. When Notch is initially at higher levels and STAT5P is at initially higher levels, T cells are produced (FIG. 22).

### C2. Example 2

### Creating a Transgenic Lymphocyte

In some embodiments, one or more additional simulation sessions can be user-specified and/or automatically generated (e.g., by the dynamic adjustment module), to 1) perturb and test the model, and/or 2) perform in silico experiments. The following example highlights one exemplary method and modeling results from performing an in silico experiment using the simulation system as described above.

In their research, Goetz et al. showed that B cells could originate in the thymus of a transgenic mouse model that constitutively expresses an isoform of the STAT5 transcription factor (STAT5-CA mice). To model this phenomenon and demonstrate the potential for thymic B cell development in silico, a transgenic version of the gene regulatory network was developed to replace the “wild-type” version of the virtual genome in the modeled lymphocyte cells (referred to herein as transgenic lymphocytes). Differentiation of transgenic lymphocytes configured to constitutively express the STAT5 transcription factor was modeled in the thymic environment.

C2.1. Describing the Model

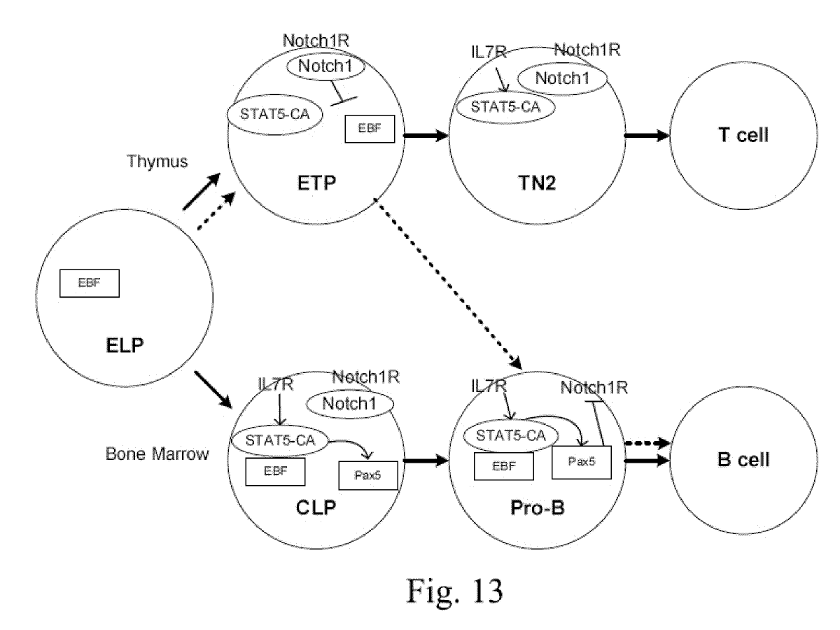

The objective of Example 2 is to develop an in silico transgenic gene regulatory network (GRN) of ELP differentiation based on a transgenic gene regulatory network (GRN) model proposed by Goetz et al. and illustrated in FIG. 13. FIG. 13 is a schematic flow diagram illustrating T cell and B cell differentiation patterns of transgenic lymphocytes having a constitutively active form of the STAT5 transcription factor.

In the absence of transgene activation, ELPs develop normally, as shown in FIG. 10. In this case, Notch1 signaling is both necessary and sufficient to commit ELPs to the T cell lineage. However, mice expressing constitutively active STAT5 (STAT5-CA) develop large numbers of B cells in the thymus as STAT5-CA overcomes the influence of Notch signals. This causes early T cell progenitors (ETPs) to shift developmental pathways and become B cells.

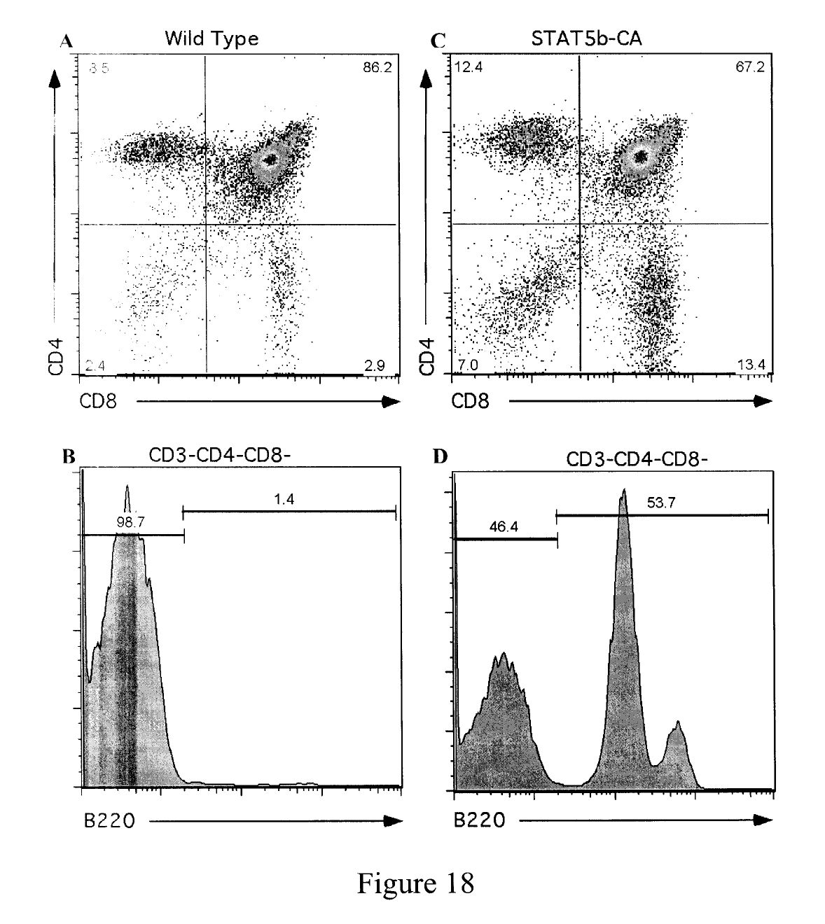

The in silico model was adapted to represent known B and T cell proportions in the thymus of STAT5-CA mice, as shown in FIG. 18. Early T cell progenitors were monitored to detect any shifts in development pathways. The earliest progenitors within the thymus are negative for the mature surface markers CD4, CD8 and CD3. These “triple negative” (TN) cells can be further categorized into four developmental stages, TN1, TN2, TN3 and TN4. Thymi from wild type and STAT5-CA mice were analyzed first by flow cytometry using markers against CD4 and CD8 (FIGS. 18A and 18C). The number of cells that were negative for both CD4 and CD8 was higher in STAT5B-CA thymi (FIG. 18B, 2.4%) as compared to wild type thymi (FIG. 18C, 7.0%). To more closely characterize the TN population, the TN cell population was gated using markers against CD3, CD4 and CD8, and then the gated population was stained for B cell (B220) expression. (FIGS. 18B and 18D). STAT5B-CA TN cells exhibit an increase in the percentage of B220-expressing cells relative to wild type mice (53.7% vs. 1.4%, respectively, FIGS. 18B and 18D). This increase in B220-expressing cells may be attributed to increased levels of STAT5P causing early T cell progenitors (ETPs) to shift developmental pathways to become B cells.

C2.1.1. Defining the Transgenic GRN

The transgenic gene regulatory network (tGRN) and virtual transgenic genome configured for the simulation session in accordance with Example 2 is substantially similar to the GRN and virtual genome described above with respect to Example 1 in section C1, with the following differences:

STAT5 activation: STAT5 is constitutively expressed. As simulated using the cell-centric simulator described above, IL-7 binding (IL7Ligand) to the IL-7 receptor (IL7R) causes the IL7R to alter to a phosphorylated IL-7 receptor analogue (IL7RP). When the molecular profile of the virtual lymphocyte includes both IL7RP molecules and STAT5 molecules, STAT5 molecules can be altered to a phosphorylated STAT5 analogue (STAT5P). Both an IL7RP and a STAT5 can be consumed in a chemical equation to yield an IL7RPSTAT5P molecule (e.g., an analogue of a protein dimer). When the molecular profile of the virtual lymphocyte includes both the IL7RPSTAT5P molecule and a second STAT5 molecule, a chemical-interaction rule can be invoked to consume the IL7RPSTAT5P molecule and yield a STAT5P molecule, and an IL7RP molecule. STAT5P can be considered the “activated” form of the STAT5 transcription factor for fulfilling one or more further chemical-interaction rule requirements. As implemented, the above description of analogue molecules and chemical-interaction rules can model in silico biological protein interaction pathways that occur in vivo.

E2A: In this example, the E2A gene unit and corresponding molecules and chemistry equations have been eliminated from the tGRN.

EBF regulation: STAT5P has been configured to initiate (through chemical-interaction rules) weak EBF expression (e.g., low levels of intracellular EBF molecules present). The tGRN can be configured such that stronger levels of EBF expression (e.g., high levels of intracellular EBF molecules present) result in Pax5 production (e.g., simulating PAX5 transcription, Pax5 translation, etc.). The tGRN can also be configured to include chemical-interaction rules that provide a feedback loop in which the presence of Pax5 molecules are used to increase EBF molecule production (e.g., expression).

C2.1.2. Defining Cell States

The cell types and cell states configured for the simulation session in accordance with Example 2 is substantially similar to the cell types and cell states described above with respect to Example 1 in section C1, with the following differences:

TLymphocyte: As with wild-type lymphocyte cells described above, transgenic lymphocytes maintain a potential to grow but do not divide. They produce Notch1 receptors (Notch1R) and IL-7 receptors (IL7R) on their surface when not in the ELP state. These cells are configured to constitutively express STAT5P, which induces EBF expression at levels insufficient to trigger B cell lineage commitment.

C2.1.3. Defining the Environment

Thymic: As described above with respect to Example 1 and illustrated in FIGS. 11A-11B, the thymic environment consists of IL-7 signaling ligands and Notch1 signaling ligands. The IL-7 ligands are modeled using a uniform point source (IL7Ligand) to form a homogeneous landscape. The Notch1 ligands are modeled using an array of localized point sources (Notch1Ligand) to form a heterogeneous landscape.

C2.2. Writing the Configuration File: Configure Initial Environment and Cells

As described above with respect to Example 1 in section C1, the configuration is designed starting from a simulation configuration template, with details interpreted in previous examples and in section B. One of ordinary skill in the art will recognize additional and/or alternative simulation configuration templates and/or configuration files.

In this example, the cell-centric simulator is configured to initiate a simulation session with the above-described thymic environment, and run as described above with respect to Example 1 and with the changes to the file noted above in section C2.1.1.-C2.1.2.

C2.2.1. Basic Components

In this example, the configuration file was designed with the basic components and gravity as described in Example 1 in section C1.2.1.

As discussed above, to constrain an area where cells can move and grow during simulation, a virtual dish is added under <Physics>. The dish is centered at coordinates [0.0, −1.0, 0.0] and has a radius of 10.0. Conceptually, this dish can be thought of as a Petri dish. Also, adding a gravity rule under <Physics> will allow cells to maintain contact with the surface of the dish.

### Configuration Example:

<Gravity>1.5</Gravity>
<Container>

<Dish>[0.0, −1.0, 0.0] 10</Dish>

</Container>

To grow a maximal number of cells in the area defined by the dish and to limit the cell size, the minimum, maximum, and initial cell size parameters are set to 1, 2, and 1, respectively. This is configured under <Cell>.

### Configuration Example:

<MinimumSize>1</MinimumSize>
<MaximumSize>2</MaximumSize>
<InitialSize>1</InitialSize>

C2.2.2. Configure the Thymic Environment

An IL7Ligand entry of <Shade> under <CsIndividual> is added with a strength of 100.0 and an exponent of 0.0. With an exponent of 0.0, the concentration of IL7Ligand will be 100.0 at every point in the environment; the location, modifier, and radius values are irrelevant in this specific example. Notch1Ligands are defined as an array of localized point sources. This array can be large enough to cover the virtual area defined by the “dish” that was configured as described above.

One example of a thymic environment configuration includes:

<Shade>

<UseModifier/><UseRadius/>
[

S IL7Ligand @ 1000 1000 1000 100 0 1 1
,S Notch1Ligand @ −12 0 −12 3 0.9 5 1.2
,S Notch1Ligand @ −12 0 −9 3 0.9 5 1.2
,S Notch1Ligand @ −12 0 −6 3 0.9 5 1.2
,S Notch1Ligand @ −12 0 −3 3 0.9 5 1.2
,S Notch1Ligand @ −12 0 0 3 0.9 5 1.2
,S Notch1Ligand @ −12 0 3 3 0.9 5 1.2
,S Notch1Ligand @ −12 0 6 3 0.9 5 1.2
,S Notch1Ligand @ −12 0 9 3 0.9 5 1.2
,S Notch1Ligand @ −12 0 12 3 0.9 5 1.2
,S Notch1Ligand @ −9 0 −12 3 0.9 5 1.2
,S Notch1Ligand @ −9 0 −9 3 0.9 5 1.2
,S Notch1Ligand @ −9 0 −6 3 0.9 5 1.2
,S Notch1Ligand @ −9 0 −3 3 0.9 5 1.2
,S Notch1Ligand @ −9 0 0 3 0.9 5 1.2
,S Notch1Ligand @ −9 0 3 3 0.9 5 1.2
,S Notch1Ligand @ −9 0 6 3 0.9 5 1.2
,S Notch1Ligand @ −9 0 9 3 0.9 5 1.2
,S Notch1Ligand @ −9 0 12 3 0.9 5 1.2
,S Notch1Ligand @ −6 0 −12 3 0.9 5 1.2
,S Notch1Ligand @ −6 0 −9 3 0.9 5 1.2
,S Notch1Ligand @ −6 0 −6 3 0.9 5 1.2
,S Notch1Ligand @ −6 0 −3 3 0.9 5 1.2
,S Notch1Ligand @ −6 0 0 3 0.9 5 1.2
,S Notch1Ligand @ −6 0 3 3 0.9 5 1.2
,S Notch1Ligand @ −6 0 6 3 0.9 5 1.2
,S Notch1Ligand @ −6 0 9 3 0.9 5 1.2
,S Notch1Ligand @ −6 0 12 3 0.9 5 1.2
,S Notch1Ligand @ −3 0 −12 3 0.9 5 1.2
,S Notch1Ligand @ −3 0 −9 3 0.9 5 1.2
,S Notch1Ligand @ −3 0 −6 3 0.9 5 1.2
,S Notch1Ligand @ −3 0 −3 3 0.9 5 1.2
,S Notch1Ligand @ −3 0 0 3 0.9 5 1.2
,S Notch1Ligand @ −3 0 3 3 0.9 5 1.2
,S Notch1Ligand @ −3 0 6 3 0.9 5 1.2
,S Notch1Ligand @ −3 0 9 3 0.9 5 1.2
,S Notch1Ligand @ −3 0 12 3 0.9 5 1.2
,S Notch1Ligand @ 0 0 −12 3 0.9 5 1.2
,S Notch1Ligand @ 0 0 −9 3 0.9 5 1.2
,S Notch1Ligand @ 0 0 −6 3 0.9 5 1.2
,S Notch1Ligand @ 0 0 −3 3 0.9 5 1.2
,S Notch1Ligand @ 0 0 0 3 0.9 5 1.2
,S Notch1Ligand @ 0 0 3 3 0.9 5 1.2
,S Notch1Ligand @ 0 0 6 3 0.9 5 1.2
,S Notch1Ligand @ 0 0 9 3 0.9 5 1.2
,S Notch1Ligand @ 0 0 12 3 0.9 5 1.2
,S Notch1Ligand @ 3 0 −12 3 0.9 5 1.2
,S Notch1Ligand @ 3 0 −9 3 0.9 5 1.2
,S Notch1Ligand @ 3 0 −6 3 0.9 5 1.2
,S Notch1Ligand @ 3 0 −3 3 0.9 5 1.2
,S Notch1Ligand @ 3 0 0 3 0.9 5 1.2
,S Notch1Ligand @ 3 0 3 3 0.9 5 1.2
,S Notch1Ligand @ 3 0 6 3 0.9 5 1.2
,S Notch1Ligand @ 3 0 9 3 0.9 5 1.2
,S Notch1Ligand @ 3 0 12 3 0.9 5 1.2
,S Notch1Ligand @ 6 0 −12 3 0.9 5 1.2
,S Notch1Ligand @ 6 0 −9 3 0.9 5 1.2
,S Notch1Ligand @ 6 0 −6 3 0.9 5 1.2
,S Notch1Ligand @ 6 0 −3 3 0.9 5 1.2
,S Notch1Ligand @ 6 0 0 3 0.9 5 1.2
,S Notch1Ligand @ 6 0 3 3 0.9 5 1.2
,S Notch1Ligand @ 6 0 6 3 0.9 5 1.2
,S Notch1Ligand @ 6 0 9 3 0.9 5 1.2
,S Notch1Ligand @ 6 0 12 3 0.9 5 1.2
,S Notch1Ligand @ 9 0 −12 3 0.9 5 1.2
,S Notch1Ligand @ 9 0 −9 3 0.9 5 1.2
,S Notch1Ligand @ 9 0 −6 3 0.9 5 1.2
,S Notch1Ligand @ 9 0 −3 3 0.9 5 1.2
,S Notch1Ligand @ 9 0 0 3 0.9 5 1.2
,S Notch1Ligand @ 9 0 3 3 0.9 5 1.2
,S Notch1Ligand @ 9 0 6 3 0.9 5 1.2
,S Notch1Ligand @ 9 0 9 3 0.9 5 1.2
,S Notch1Ligand @ 9 0 12 3 0.9 5 1.2
,S Notch1Ligand @ 12 0 −12 3 0.9 5 1.2
,S Notch1Ligand @ 12 0 −9 3 0.9 5 1.2
,S Notch1Ligand @ 12 0 −6 3 0.9 5 1.2
,S Notch1Ligand @ 12 0 −3 3 0.9 5 1.2
,S Notch1Ligand @ 12 0 0 3 0.9 5 1.2
,S Notch1Ligand @ 12 0 3 3 0.9 5 1.2
,S Notch1Ligand @ 12 0 6 3 0.9 5 1.2
,S Notch1Ligand @ 12 0 9 3 0.9 5 1.2
,S Notch1Ligand @ 12 0 12 3 0.9 5 1.2

]

</Shade>

C2.2.3. Configure Metabolic Components

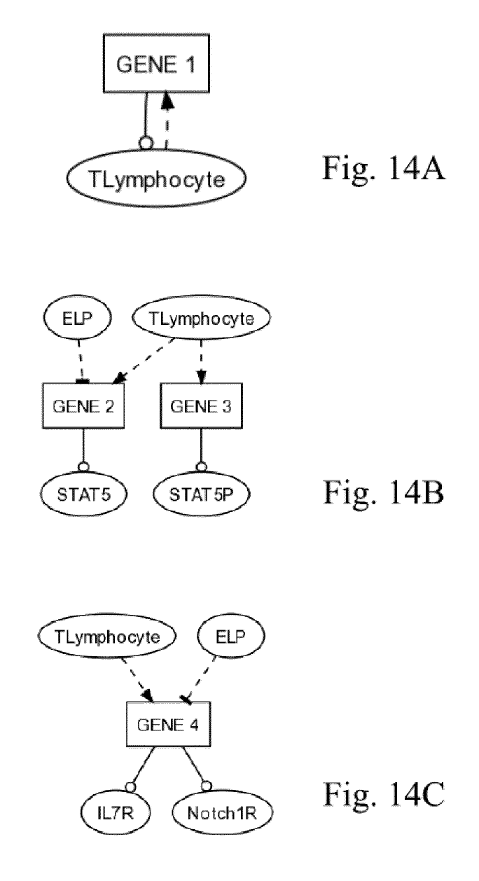

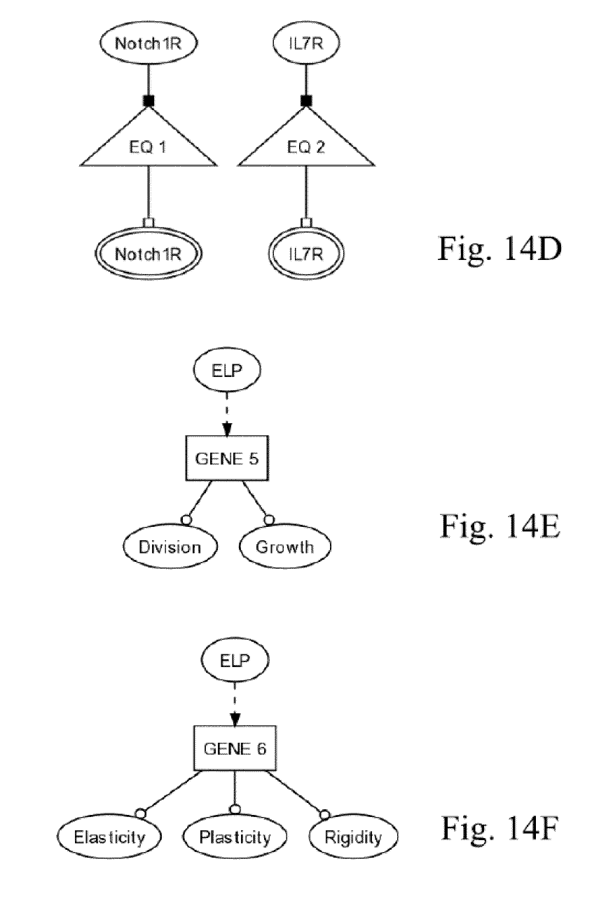

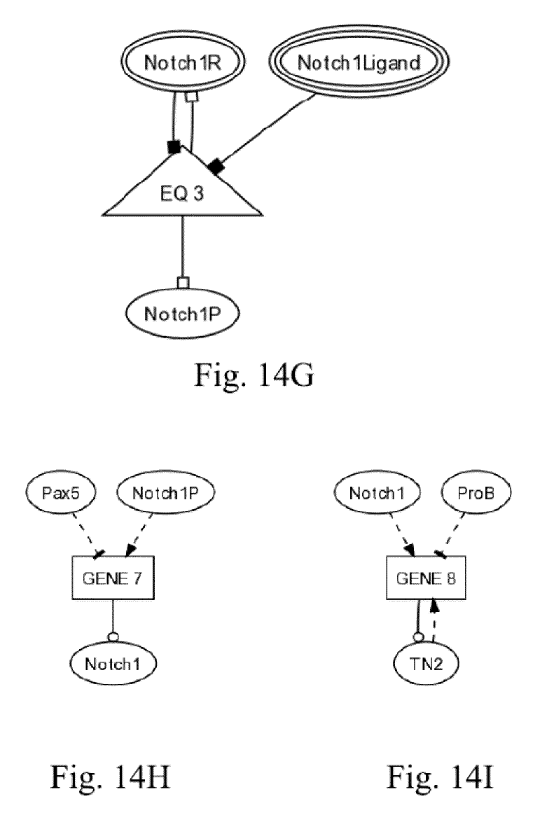

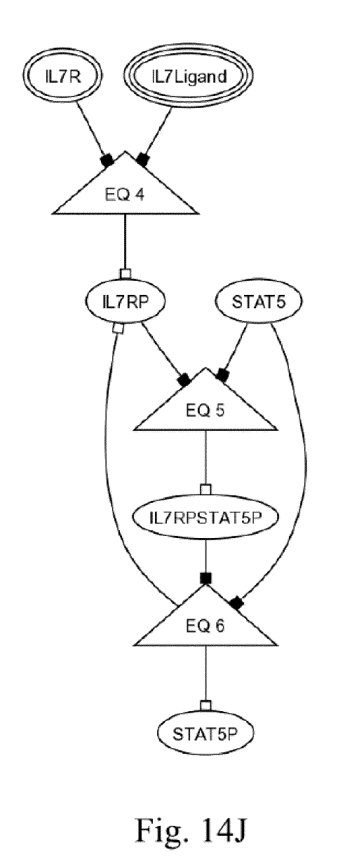

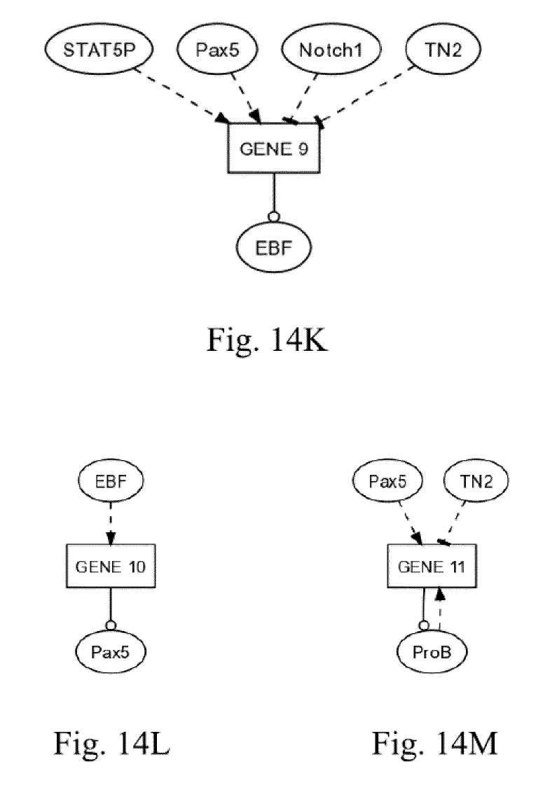

FIGS. 14A-14M are schematic flow diagrams illustrating molecules and actions, virtual genes and gene products, and chemical-interaction rules for modeling lineage-restricted transgenic lymphocyte differentiation pathways in accordance with the simulation of biological events described in Example 2 of section C2 and in accordance with an embodiment of the disclosure.

The initially-defined cells in this model are ELPs. For purposes of modeling, each cell is also defined as a “transgenic lymphocyte.” Therefore, initial starting concentrations of TLymphocyte marker molecules and ELP marker molecules are added to <InitialChemistry> under <Cell>.

### Configuration Example:

<InitialChemistry>

TLymphocyte 1000
ELP 100

</InitialChemistry>

In this example, cells need to maintain and/or retain TLymphocyte molecules throughout the simulation session. In one embodiment, TLymphocyte molecule retention can be accomplished by creating a gene unit-based feedback loop, as illustrated in FIG. 14A. A gene unit assembly can be defined in <Genome> under <CsIndividual>.

### Configuration Example:

<Genome>
[

[ TLymphocyte 11.11112 ] [ TLymphocyte ]

]
</Genome>

In the present example, transgenic lymphocytes constitutively express STAT5 and STAT5P. STAT5 expression (e.g., production, presence, etc.) can be restricted to the non-ELP cell state (FIG. 14B). Two gene unit assemblies can be added under <Genome>. The effect value of 0.65 on the STAT5P transgene unit can balance the tGRN such that over-expression (e.g., high level molecule production) of the EBF molecule does not occur prematurely during simulation.

### Configuration Example:

[ TLymphoctye 5, ELP −6 ] [ STAT5 ]
[ TLymphocyte 0.65 ] [ STAT5P ]

Transgenic lymphocyte cells produce Notch1R and IL7R molecules to support their respective signaling pathways. However, if the transgenic lymphocyte is also classified as an ELP cell, then these receptor molecules are inhibited from production. To prevent receptor generation during the ELP state, a gene unit assembly can be defined under <Genome> (FIG. 14C).

### Configuration Example:

[TLymphocyte 1, ELP −1] [Notch1R, 1L7R]

Since gene transcription produces molecules internal to the cell, the Notch1R and IL7R molecules can be moved to the surface of the cell to support the Notch1 and IL-7 signaling pathways (FIG. 14D). This is done by creating the following equations under <ChemistryEquations> under <Cell>.

### Configuration Example:

<ChemistryEquations>

Notch1R = ( Notch1R );
IL7R = ( IL7R );

</ChemistryEquations>

ELP cells can divide so that progeny can begin specific lineage pathway commitment. A gene unit under <Genome> is defined to produce Division molecules and Growth molecules (FIG. 14E). A promotion effect of 0.15 allows for slower build-up of these molecules within the cell. In this embodiment, the promotion effect of 0.15 ensures that division does not occur at every step of the simulation.

### Configuration Example:

[ELP 0.15] [Division, Growth]

In the present example, when an ELP divides into two cells, one of the cells remains an ELP and the other is subject to a differentiation mechanism. The modeling platform supports a method for allowing this division protocol to occur without having to define a complete differentiation pathway via gene units and equations. This division protocol is achieved by defining certain molecules as “indivisible”. For example, only one cell from each cell division event will get indivisible molecules. In the present model, the “ELP” molecule serves as a marker and regulator for the ELP cell type. Therefore the ELP molecule can be defined as indivisible, and in further embodiments, can be decay resistant. ELP is defined under <MoleculeCatalog> to be indivisible and non-decaying.

### Configuration Example:

<MoleculeCatalog>

ELP [ 300, 10 ] 0.0 I;

</MoleculeCatalog>

To simulate natural ELP and mature lymphocyte cell growth, the configuration file is configured to maintain the cells with physical properties. As shown in FIG. 14F, a gene unit is added to <Genome> under <CsIndividual> to produce these molecules.

### Configuration Example:

[ELP 1.11112] [Rigidity, Plasticity, Elasticity]

To initiate the Notch1 signaling pathway, a chemistry equation is defined under <ChemistryEquations> (FIG. 14G). A signal ligand molecule, Notch1Ligand, can be created to interact with the Notch1 receptor through the chemical-interaction rule to create a simulated phosphorylated form of a Notch1 signal, Notch1P. A feed back loop can also be configured to reinforce this pathway (e.g., production of more Notch1R).

### Configuration Example:

{Notch1Ligand}+(0.1 Notch1R)=(Notch1R)+Notch1P

The presence of Notch1P can be configured to activate the Notch1 gene unit. The configuration file can also be configured to simulate the inhibitory effect of Pax5 on the Notch1P signal response (FIG. 14H). For example, if a threshold level of Pax5 molecules is present within a virtual lymphocyte, it may be assumed that the IL-7 signaling pathway has been initiated prior to the Notch1 signaling pathway. This gene is defined under <Genome>.

### Configuration Example:

[Notch1P 1.111112, Pax5 −2][Notch1]

In the present example, a cell can up-regulate the Notch1 gene unit (e.g., increase molecule levels) to initiate the commitment to the T cell lineage pathway, thereby transitioning the transgenic lymphocyte to the TN2 state. This relationship can be configured using a TN2 gene unit that is promoted by the presence of Notch1. This gene unit can also be configured with a feedback loop (e.g., a self-promoting gene unit) to keep the cell in the TN2 state once established. Since a cell is limited to committing to one lymphocyte lineage in this example, ProB molecules are configured to inhibit the TN2 gene unit (FIG. 14I). The gene unit is defined under <Genome>.

### Configuration Example:

[Notch1 1, TN2 1, ProB −2][TN2]

The IL-7 signaling pathway can be initiated by the presence of both IL-7 receptor and the IL-7 ligand molecules in the extracellular environment. Through a chemistry equation, defined under <ChemistryEquations> (FIG. 14J, EQ4), IL7RP (i.e., phosphorylated form of IL-7 receptor) is created. Through EQ5, the IL-7RP recruits and phosphorylates a first STAT5 molecule to yield a dimer molecule IL-7RPSTAT5P. A IL-7RPSTATP molecule, in the presence of a second STAT5 molecule, can be consumed and yield a STAT5P molecule and an IL-7RP molecule (which can be used to further trigger EQ5). In this example, the second STAT5 molecule is not consumed in EQ6. This simulated signaling pathway can be defined under <ChemistryEquations>.

### Configuration Example:

{ IL7Ligand } + ( IL7R ) = IL7RP;
IL7RP + STAT5 = IL7RPSTAT5P;
IL7RPSTAT5P + STAT5 = IL7RP + STAT5P;

As STAT5P is generated by the IL-7 signaling pathway chemical-interaction rules described above, up-regulation of the EBF gene unit occurs (e.g., EBF molecules are generated). The EBF gene unit can be defined under <Genome> and configured to be promoted by STAT5P. Pax5 molecules, a gene unit product generated by the presence of EBF molecules, can also be configured to promote the EBF gene unit, thereby establishing a feedback loop for self (e.g., Pax5) promotion (FIG. 14K). Production of Pax5 molecules promotes the B-cell lineage pathway. Therefore, the configuration file can include chemical-interaction rule(s) for showing Notch1 inhibition (and TN2 cell state inhibition) of the EBF gene unit to simulate blocking of the B cell lineage pathway.

### Configuration Example:

[STAT5P 1, Pax5 3, Notch1 −2, TN2−5] [EBF]

EBF molecules are configured to promote Pax5 activation/production via the Pax5 gene unit control region (FIG. 14L). This gene unit can be defined under <Genome>.

### Configuration Example:

[EBF 1] [Pax5]

In this example, successful promotion of the Pax5 gene unit can designate commitment to the B cell lineage pathway. Accordingly, the Pax5 molecule can be configured to promote activation the ProB gene unit. The ProB gene unit can be configured to self-promote (e.g., in a feedback loop) to keep the cell in the ProB state once established. The presence of TN2 molecules can be configured to inhibit the ProB gene unit (FIG. 14M). The ProB gene unit can be defined under <Genome>.

### Configuration Example:

[Pax5 1, ProB 1, TN2 −2] [ProB]

In accordance with an embodiment of the disclosure, gene unit effect values, molecule decay rates, and other model parameters can be adjusted to balance out a cell metabolic network to achieve desired results (e.g., in vitro and/or in vivo verified results, etc.). In this model, IL7RP is configured with a higher decay rate than the default decay rate value of 10%. For example, the decay rate of IL7RP is set to 20% and is configured under <MoleculeCatalog>.

### Configuration Example:

IL7RP [1600, 10] 0.2;

C2.2.4 Initializing Simulation

In this example, the cell-centric simulator is configured to initiate a simulation session with the above-described thymic environment, and run as described above with respect to Example 1.

To begin a simulation session, one or more cells can be initiated into the virtual area previously defined (e.g., virtual Petri dish, thymic environment, etc.). This operation can be defined in the <InitialCellLocations> under <Simulation>.

### Configuration Example:

<InitialCellLocations>

[ 0.0, 0.0, 0.0 ];
[ 5.0, 0.0, 0.0 ];
[ −5.0, 0.0, 0.0 ];
[ 0.0, 0.0, 5.0 ];
[ 0.0, 0.0, −5.0 ];

</InitialCellLocations>

C2.2.5. Configuration File Results

An exemplary configuration is shown below:

<CsIndividual>

<RandomSeed>8467923</RandomSeed>
<Simulation>

<FixedSpheres>[0, 1000, 0] 999</FixedSpheres>
<InitialCellLocation>

[ 0.0, 0.0, 0.0 ];
[ 5.0, 0.0, 0.0 ];
[ −5.0, 0.0, 0.0 ];
[ 0.0, 0.0, 5.0 ];
[ 0.0, 0.0, −5.0 ];

</InitialCellLocation>
<Physics>

<Container>

<Dish>[ 0.0, −1.0, 0.0 ] 10.0</Dish>

</Container>
<Gravity>1.5</Gravity>
<MaxVelocityChange>0.1</MaxVelocityChange>
<TimePerStep>0.1</TimePerStep>
<DampingMultiplier>3.0</DampingMultiplier>
<NudgeMagnitude>3.0</NudgeMagnitude>
<RepulsionMultiplier>1.0</RepulsionMultiplier>

</Physics>
<Signal><No/></Signal>
<Cell>
<Promoter>

<Smoother>

<PromotionMidpoint>5</PromotionMidpoint>
<Slope>3</Slope>
<ActiveConcentration>1</ActiveConcentration>

</Smoother>

</Promoter>
<Chemistry><Default/></Chemistry>
<MaximumSize>2</MaximumSize>
<InitialSize>1</InitialSize>
<MinimumSize>1</MinimumSize>
<InitialChemistry>

TLymphocyte 1000
ELP 100

</InitialChemistry>
<ChemistryEquations>

<!-- IL7 Signaling -->
IL7R = (IL7R); <!-- move IL7R to surface to act as a receptor -->
{IL7Ligand} + (IL7R) = IL7RP; <!-- binding of IL7 to the IL7 receptor
phosphorylates it -->
IL7RP + STAT5 = IL7RPSTAT5P;
IL7RPSTAT5P + STAT5 = IL7RP + STAT5P;
<!-- Notch Signaling -->
Notch1R = (Notch1R); <!-- move notch1R to surface to act as a receptor—
>
{Notch1Ligand} + (0.1 Notch1R) = Notch1P;

</ChemistryEquations>

</Cell>

</Simulation>
<MoleculeCatalog>

Lymphocyte [ 200, 10 ];
ELP [ 300, 10 ] 0.0 I;
EBF [ 500, 10 ];
Notch1R [ 600, 10 ];
Notch1P [ 700, 10 ];
Notch1 [ 800, 10 ];
IL7R [ 900, 10 ];
STAT5P [ 1000, 10 ];
STAT5 [ 1100, 10 ];
Pax5 [ 1300, 10 ];
ProB [ 1400, 10 ];
TN2 [ 1500, 10 ];
IL7RP [ 1600, 10 ] 0.2;
IL7RPSTAT5P [ 1800, 10 ];

</MoleculeCatalog>
<Genome>
[

[ TLymphocyte 11.11112 ][ TLymphocyte ],
[ TLymphocyte 5, ELP −6 ][ STAT5 ],
[ TLymphocyte 0.65 ][ STAT5P ],
[ TLymphocyte 1, ELP −1 ][ Notch1R, IL7R ],
[ STAT5P 1, Pax5 3, Notch1 −2, TN2 −5 ][ EBF ],
[ EBF 1][ Pax5 ],
[ Notch1P 1.111112, Pax5 −2 ][ Notch1 ],
[ Notch1 1, TN2 1, ProB −2 ][ TN2 ],
[ Pax5 1, ProB 1, TN2 −2 ][ ProB ],
[ ELP 0.15 ][ Division, Growth ],
[ ELP 1.11112 ][ Rigidity, Elasticity, Plasticity ]

]
</Genome>
<Shade>
<UseModifier/><UseRadius/>
[

S IL7Ligand @ 1000 1000 1000 100 0 1 1
,S Notch1Ligand @ −12 0 −12 3 0.9 5 1.2
,S Notch1Ligand @ −12 0 −9 3 0.9 5 1.2
,S Notch1Ligand @ −12 0 −6 3 0.9 5 1.2
,S Notch1Ligand @ −12 0 −3 3 0.9 5 1.2
,S Notch1Ligand @ −12 0 0 3 0.9 5 1.2
,S Notch1Ligand @ −12 0 3 3 0.9 5 1.2
,S Notch1Ligand @ −12 0 6 3 0.9 5 1.2
,S Notch1Ligand @ −12 0 9 3 0.9 5 1.2
,S Notch1Ligand @ −12 0 12 3 0.9 5 1.2
,S Notch1Ligand @ −9 0 −12 3 0.9 5 1.2
,S Notch1Ligand @ −9 0 −9 3 0.9 5 1.2
,S Notch1Ligand @ −9 0 −6 3 0.9 5 1.2
,S Notch1Ligand @ −9 0 −3 3 0.9 5 1.2
,S Notch1Ligand @ −9 0 0 3 0.9 5 1.2
,S Notch1Ligand @ −9 0 3 3 0.9 5 1.2
,S Notch1Ligand @ −9 0 6 3 0.9 5 1.2
,S Notch1Ligand @ −9 0 9 3 0.9 5 1.2
,S Notch1Ligand @ −9 0 12 3 0.9 5 1.2
,S Notch1Ligand @ −6 0 −12 3 0.9 5 1.2
,S Notch1Ligand @ −6 0 −9 3 0.9 5 1.2
,S Notch1Ligand @ −6 0 −6 3 0.9 5 1.2
,S Notch1Ligand @ −6 0 −3 3 0.9 5 1.2
,S Notch1Ligand @ −6 0 0 3 0.9 5 1.2
,S Notch1Ligand @ −6 0 3 3 0.9 5 1.2
,S Notch1Ligand @ −6 0 6 3 0.9 5 1.2
,S Notch1Ligand @ −6 0 9 3 0.9 5 1.2
,S Notch1Ligand @ −6 0 12 3 0.9 5 1.2
,S Notch1Ligand @ −3 0 −12 3 0.9 5 1.2
,S Notch1Ligand @ −3 0 −9 3 0.9 5 1.2
,S Notch1Ligand @ −3 0 −6 3 0.9 5 1.2
,S Notch1Ligand @ −3 0 −3 3 0.9 5 1.2
,S Notch1Ligand @ −3 0 0 3 0.9 5 1.2
,S Notch1Ligand @ −3 0 3 3 0.9 5 1.2
,S Notch1Ligand @ −3 0 6 3 0.9 5 1.2
,S Notch1Ligand @ −3 0 9 3 0.9 5 1.2
,S Notch1Ligand @ −3 0 12 3 0.9 5 1.2
,S Notch1Ligand @ 0 0 −12 3 0.9 5 1.2
,S Notch1Ligand @ 0 0 −9 3 0.9 5 1.2
,S Notch1Ligand @ 0 0 −6 3 0.9 5 1.2
,S Notch1Ligand @ 0 0 −3 3 0.9 5 1.2
,S Notch1Ligand @ 0 0 0 3 0.9 5 1.2
,S Notch1Ligand @ 0 0 3 3 0.9 5 1.2
,S Notch1Ligand @ 0 0 6 3 0.9 5 1.2
,S Notch1Ligand @ 0 0 9 3 0.9 5 1.2
,S Notch1Ligand @ 0 0 12 3 0.9 5 1.2
,S Notch1Ligand @ 3 0 −12 3 0.9 5 1.2
,S Notch1Ligand @ 3 0 −9 3 0.9 5 1.2
,S Notch1Ligand @ 3 0 −6 3 0.9 5 1.2
,S Notch1Ligand @ 3 0 −3 3 0.9 5 1.2
,S Notch1Ligand @ 3 0 0 3 0.9 5 1.2
,S Notch1Ligand @ 3 0 3 3 0.9 5 1.2
,S Notch1Ligand @ 3 0 6 3 0.9 5 1.2
,S Notch1Ligand @ 3 0 9 3 0.9 5 1.2
,S Notch1Ligand @ 3 0 12 3 0.9 5 1.2
,S Notch1Ligand @ 6 0 −12 3 0.9 5 1.2
,S Notch1Ligand @ 6 0 −9 3 0.9 5 1.2
,S Notch1Ligand @ 6 0 −6 3 0.9 5 1.2
,S Notch1Ligand @ 6 0 −3 3 0.9 5 1.2
,S Notch1Ligand @ 6 0 0 3 0.9 5 1.2
,S Notch1Ligand @ 6 0 3 3 0.9 5 1.2
,S Notch1Ligand @ 6 0 6 3 0.9 5 1.2
,S Notch1Ligand @ 6 0 9 3 0.9 5 1.2
,S Notch1Ligand @ 6 0 12 3 0.9 5 1.2
,S Notch1Ligand @ 9 0 −12 3 0.9 5 1.2
,S Notch1Ligand @ 9 0 −9 3 0.9 5 1.2
,S Notch1Ligand @ 9 0 −6 3 0.9 5 1.2
,S Notch1Ligand @ 9 0 −3 3 0.9 5 1.2
,S Notch1Ligand @ 9 0 0 3 0.9 5 1.2
,S Notch1Ligand @ 9 0 3 3 0.9 5 1.2
,S Notch1Ligand @ 9 0 6 3 0.9 5 1.2
,S Notch1Ligand @ 9 0 9 3 0.9 5 1.2
,S Notch1Ligand @ 9 0 12 3 0.9 5 1.2
,S Notch1Ligand @ 12 0 −12 3 0.9 5 1.2
,S Notch1Ligand @ 12 0 −9 3 0.9 5 1.2
,S Notch1Ligand @ 12 0 −6 3 0.9 5 1.2
,S Notch1Ligand @ 12 0 −3 3 0.9 5 1.2
,S Notch1Ligand @ 12 0 0 3 0.9 5 1.2
,S Notch1Ligand @ 12 0 3 3 0.9 5 1.2
,S Notch1Ligand @ 12 0 6 3 0.9 5 1.2
,S Notch1Ligand @ 12 0 9 3 0.9 5 1.2
,S Notch1Ligand @ 12 0 12 3 0.9 5 1.2

]
</Shade>

</CsIndividual>

C2.3. Modeling Results, Predictive Value and Validation.

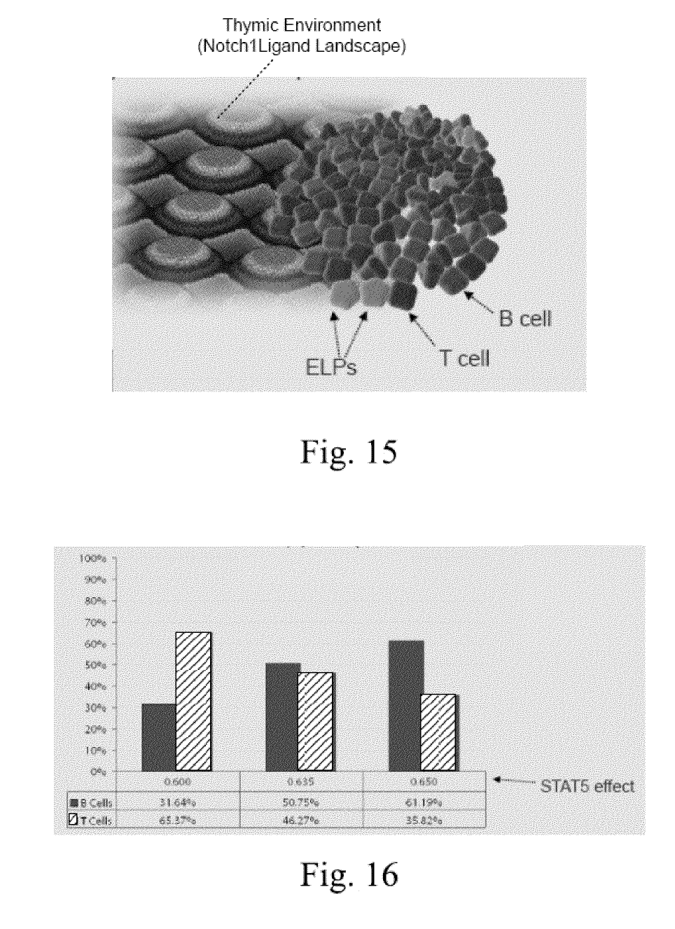

The cell-centric simulator was used to simulate transgenic lymphocyte differentiation using the above-described configuration file. FIG. 15 is a graphical image displaying developing transgenic lymphocytes in a thymic environment at a current step boundary in accordance with an embodiment of the disclosure. In one embodiment, the graphical image can be an image generated by the visualization engine and displayed on a display device associated with a computing device. As shown in FIG. 15, the population of committed B cells and T cells were developed in silico from the initial ELP progenitors placed in the heterogeneous “egg-crate” landscape of Notch ligand.

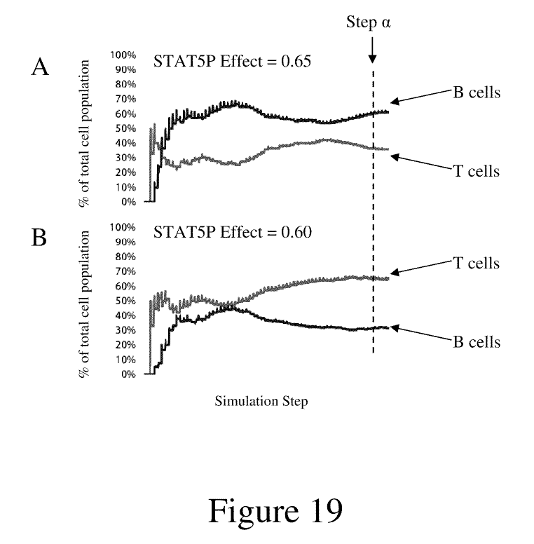

In some embodiments, the transgenic lymphocyte differentiation simulation was run at various effective concentrations (or “STAT5P effect”) of activated STAT5 (0.4≦STAT5P effect≦1.0). FIG. 19 shows two representative simulations where increasing STAT5P expression shifts from producing a greater proportion of T cells to producing a greater proportion of B cells in the virtual thymic environment. When the STAT5P effect is at 0.60, the percentage of B cells is less than the percentage of T cells (FIG. 19B), but at a STAT5P effect of 0.65, the percentage of B cells is greater than the percentage of T cells (FIG. 19A). At simulation step a (dashed line, FIGS. 19A and 19B), the percentages of B cells and T cells were plotted accordingly for STAT5P effects of 0.60, 0.635 and 0.650 (FIG. 16).

FIG. 16 is a bar graph representation of B cell versus T cell lineage-restricted development with increased levels of constitutively active STAT5 (STAT5P effect) in accordance with an embodiment of the disclosure. As shown in FIG. 16, as the level of constitutively active STAT5 is increased in the virtual cells, the more likely the cell will commit to the B cell differentiation pathway. The modeling operation using the configurable simulation information received as described above, substantiates the results demonstrated by Goetz et al. (in vivo and in vitro) in that constitutively active STAT5 expression drives the B-cell differentiation pathway in the thymic environment.

Further, the simulation results shown in FIG. 16 predict that varying the level of active STAT5 in living mice would alter the percentage of B cells that develop in the thymus. Activated STAT5 interacts with EBF in a synergistic manner to activate Pax5 production, thereby committing cells to the B cell lineage. Therefore, to validate the prediction from the results in FIG. 16 in vivo, STAT5-CA mice having only one copy of the downstream gene, EBF (ebf^{+/-}) were generated to demonstrate the impact of decreasing the effect of STAT5P in vivo.

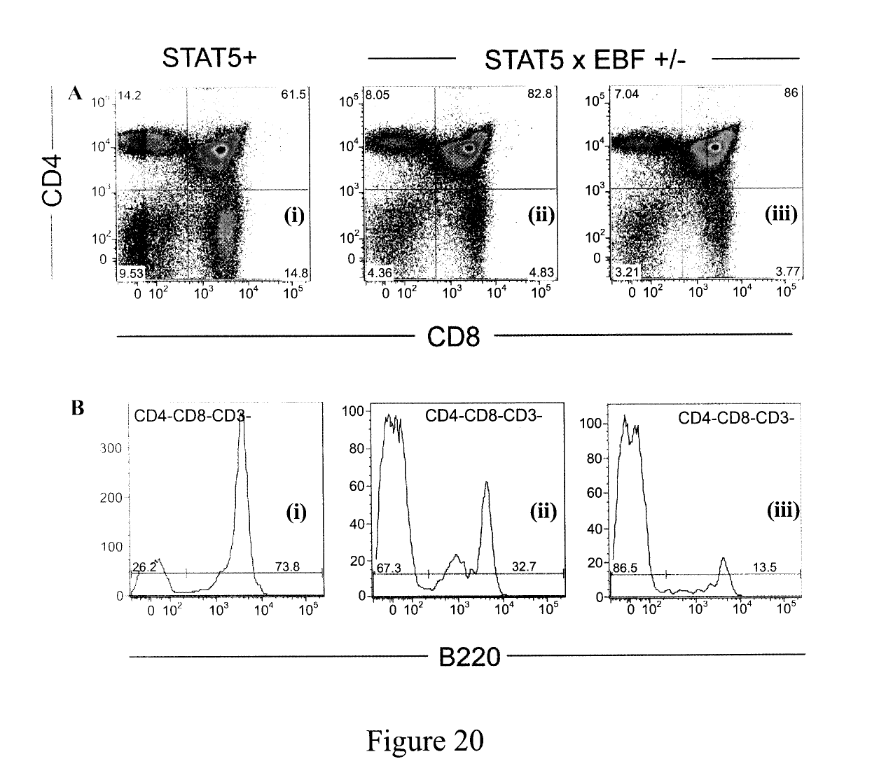

Thymic cells from STAT5-CA-ebf^{+/+} and STAT5-CA-ebf^{+/-} mice were analyzed first by flow cytometry using markers against CD4 and CD8 (FIG. 20A). The number of cells that were negative for both CD4 and CD8 was higher in STAT5-CA-ebf^{+/+} mice (FIG. 20A(i), 9.53%) than in STAT5-CA-ebf^{+/-} mice (FIGS. 20A(ii) and 20A(iii), 4.36% and 3.21%, respectively). To more closely characterize the TN population, the TN cell population was gated using markers against CD3, CD4 and CD8, then the gated population was stained for B cell (B220) expression (FIG. 20B). STAT5-CA-ebf^{+/+} mice showed that constitutively active STAT5P results in an increased percentage of B cells produced in the thymus (FIG. 20C(i)—73.8% B cells, 26.2% T cells). However, lowering EBF by 50% in vivo (STAT5-CA-ebf^{+/-}) reduces thymic B cell production by a factor of approximately 3.2 (FIGS. 20B(ii) and 20B(iii), B cell % reduced to 37.2% and 13.5%, respectively; an average of a 3.2-fold reduction in B cell lineage). Thus, lowering EBF levels in vivo attenuate and limit STAT5P-driven commitment of ELPs to B cell lineage, validating the predictive value of the transgenic in silico model.

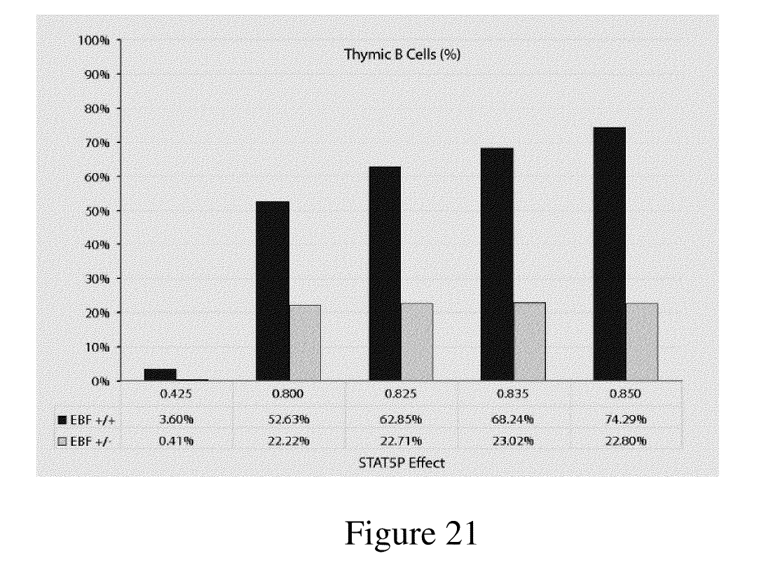

To complement the in vivo results, an in silico modeling experiment (not described above with respect to configuration files developed in Examples 1 and 2) was performed. The effects of ebf^{+/+} and ebf^{+/-} were modeled by using different promotion strengths for the EBF gene unit in accordance with an embodiment of the disclosure. The effect value on the STAT5P transgene was modeled by using a 2.00 promotion effect value for virtual ebf^{+/+} and by using a 1.00 promotion effect value for virtual ebf^{+/-}. As shown in FIG. 21, the impacts of the virtual homozygous and heterozygous EBF were examined. Virtual ebf^{+/+} produced a dose-dependent increase in thymic B cells, while virtual ebf^{+/-} reduced the percentage of B cells at all STAT5P values. Thus, varying the strength of promotion of transgenic constitutive STAT5P expression in silico predicts that stronger promotion favors production of B cells.

In summary, the results of the in silico models of ELP lineage commitment described herein extend and complement in vivo studies, and can provide a jumping-off point for wet lab researchers due to the predictive value of the models. The predictive value is not to be limited to the current ELP lineage commitment models, but may be extended to make further predictions regarding B cell and T cell lineage commitment or to any other suitable biological application as appropriate.

### C3. Example 3

### Creating a Transgenic Lymphocyte Having Cell-to-Cell Signal-Mediated Differentiation

As described above with respect to Example 2, some embodiments allow one or more additional simulation sessions to be user-specified and/or automatically generated (e.g., by the dynamic adjustment module), to 1) perturb and test the model, and/or 2) perform in silico experiments. The following example is similar to Example 2 with respect to in silico modeling of cellular differentiation of transgenic lymphocytes configured to constitutively express the STAT5 transcription factor in the thymic environment. Example 3 differs from Example 2 in that Example 3 includes a method and modeling result from performing an in silico experiment using the simulation system as described above, and wherein ELP cells use cell-to-cell signal-mediated differentiation to distinguish the ELP cell from the cell's progeny. In contrast to the “indivisible marker molecules” used to distinguish the ELP cell from its progeny demonstrated in Example 2, the cell-to-cell signal-mediated differentiation mechanism includes modeling asymmetric cell division. Asymmetric cell division can be accomplished by regulating metabolic and physical growth and division of the virtual ELP cells during simulation.

C3.1. Describing the Model

The objective of Example 3 is to develop an in silico model of ELP differentiation based on a transgenic gene regulatory network (GRN) model proposed by Goetz et al. and illustrated in FIG. 13 as described above with respect to Example 2.

C3.1.1. Defining Transgenic GRN

The transgenic gene regulatory network (tGRN) and virtual transgenic genome configured for the simulation session in accordance with Example 3 is substantially similar to the GRN and virtual genome described above with respect to Example 2 in section C2.

C3.1.2. Defining Cell States

The cell types and cell states configured for the simulation session in accordance with Example 3 is substantially similar to the cell types and cell states described above with respect to Example 2 in section C2.

C3.1.3. Defining the Environment

Thymic: As described above with respect to Examples 1 and 2 and illustrated in FIGS. 11A-11B, the thymic environment consists of IL-7 signaling ligands and Notch1 signaling ligands. The IL-7 ligands are modeled using a uniform point source (IL7Ligand) to form a homogeneous landscape. The Notch1 ligands are modeled using an array of localized point sources (Notch1Ligand) to form a heterogeneous landscape.

C3.2. Writing the Configuration File: Configure Initial Environment and Cells

As described above with respect to Examples 1 and 2 in sections C1 and C2, the configuration is designed starting from a simulation configuration template, with details interpreted in previous examples and in section B. One of ordinary skill in the art will recognize additional and/or alternative simulation configuration templates and/or configuration files.

In this example, the cell-centric simulator is configured to initiate a simulation session with the above-described thymic environment, and run as described above with respect to Examples 1 and 2.

C3.2.1. Basic Components

In this example, the configuration file was designed with the basic components as described in Example 1 in section C1.2.1.

As discussed above, to constrain an area where cells can move and grow during simulation, a virtual dish is added under <Physics>. The dish is centered at coordinates [0.0, −1.0, 0.0] and has a radius of 10.0. Conceptually, this dish can be thought of as a Petri dish. Also, adding a gravity rule under <Physics> will allow cells to maintain contact with the surface of the dish.

### Configuration Example:

<Gravity>0.5</Gravity>
<Container>

<Dish>[0.0, −1.0, 0.0] 10</Dish>

</Container>

In one embodiment, to simulate physical asymmetrical division, cells can be allowed to grow to a maximum size of 5 subspheres and have a minimum of 2 subspheres. The minimum requirement can insure that division will produce a 3 subsphere cell and a 2 subsphere cell, so long as the parent cell is 5 sub spheres in size at the time of the division action. The cells' maximum size can be regulated metabolically. In the following example, the minimum, maximum and initial cell size are set to 2, 99999, and 1 subspheres, respectively. This is configured under <Cell>.

### Configuration Example:

<MinimumSize>2</MinimumSize>
<MaximumSize>99999</MaximumSize>
<InitialSize>1</InitialSize>

In one embodiment, to simulate cell-to-cell signaling events, a signal definition can be provided under <Simulation>. In the following example, a local signaling distance of 0.5 can be established.

### Simulation Example:

<Signal>

<Local><Separation>0.5</Separation></Local>

</Signal>

C3.2.2. Configure the Thymic Environment

An IL7Ligand entry of <Shade> under <CsIndividual> is added with a strength of 100.0 and an exponent of 0.0. With an exponent of 0.0, the concentration of IL7Ligand will be 100.0 at every point in the environment; the location, modifier, and radius values are irrelevant in this specific example. Notch1Ligands are defined as an array of localized point sources. This array can be large enough to cover the virtual area defined by the “dish” that was configured as described above.

See section C2.2.2 of Example 2 for an example of a thymic environment configuration.

C3.2.3. Configure Metabolic Components

The molecules and actions, virtual genes and gene products, and chemical-interaction rules (e.g., the configurable metabolic components) for modeling lineage-restricted transgenic lymphocyte differentiation pathways in accordance with the simulation of biological events described in Example 3 of section C3 is substantially similar to the configurable metabolic components described above with respect to Example 2 in section C2.2.3 and in FIGS. 14A-D, 14G-K and 14M. The configurable metabolic components of Example 3 differ from the configurable metabolic components described with respect to Example 2 as follows:

TLymphocyte molecules: In this example, cells maintain and/or retain TLymphocyte molecules throughout the simulation session (e.g., using a gene unit-based feedback loop as illustrated in FIG. 14A) defined in <Genome> under <CsIndividual> with an example configuration:

<Genome>
[

[ TLymphocyte 10] [ TLymphocyte ]

]
</Genome>

STAT5P transgene unit: In the present example, transgenic lymphocytes constitutively express STAT5 and STAT5P and the effect value of 1.0 on the STAT5P transgene unit can balance the tGRN such that over-expression (e.g., high level molecule production) of the EBF molecule does not occur prematurely during simulation.

### Configuration Example:

[ TLymphoctye 5, ELP −6 ] [ STAT5 ]
[ TLymphocyte 1.0] [ STAT5P ]

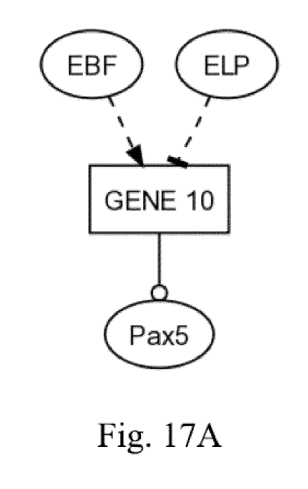

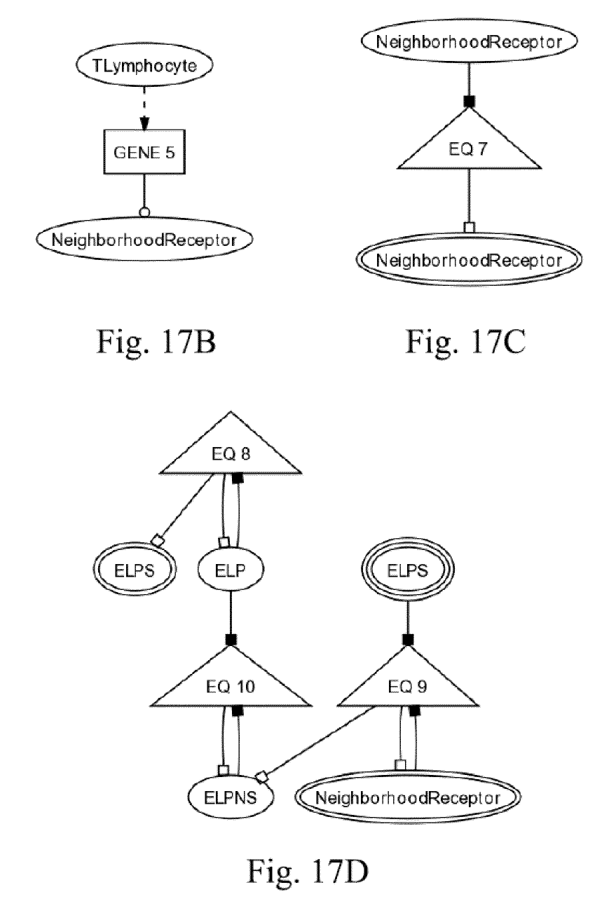

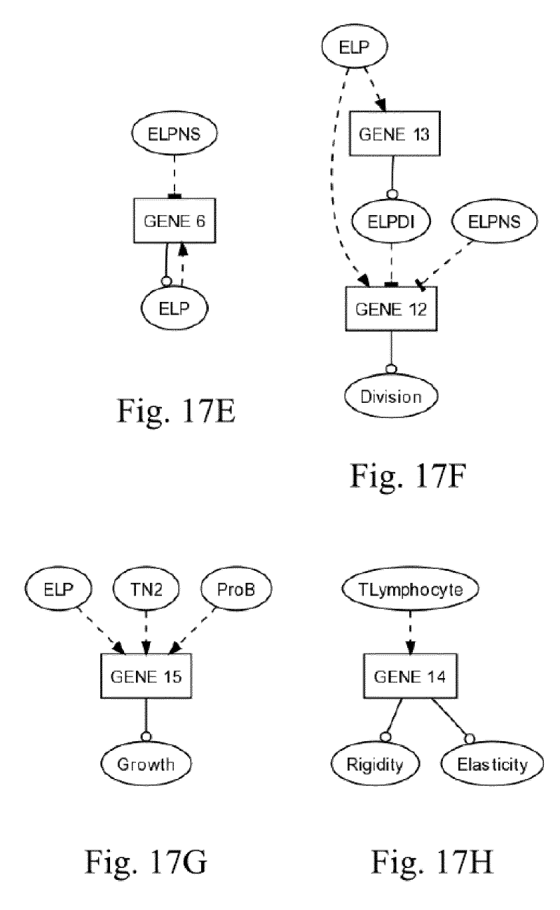

Pax5 molecule production: EBF molecules are configured to promote Pax5 activation/production via the Pax5 gene unit control region and ELP molecules (e.g., designating the ELP cell state) are configured to inhibit Pax5 molecule production via the Pax5 gene unit control region (FIG. 17A). This gene unit can be defined under <Genome>.

### Configuration Example:

[EBF 1, ELP −1000][Pax5]

Additionally, successful promotion of the Pax5 gene unit can designate commitment to the B cell lineage pathway. Accordingly, the Pax5 molecule can be configured to promote activation the ProB gene unit. The ProB gene unit can be configured to self-promote (e.g., in a feedback loop) to keep the cell in the ProB state once established. The presence of TN2 molecules can be configured to inhibit the ProB gene unit (see FIG. 14M as described above). The ProB gene unit can be defined under <Genome>.

### Configuration Example:

[Pax5 1, ProB 8.5, TN2 −10][ProB]

Cell-to-cell signal mediated differentiation: FIGS. 17B-17H are schematic flow diagrams illustrating molecules and actions, virtual genes and gene products, and chemical-interaction rules for modeling cell-to-cell signal-mediated differentiation of ELP cells into lineage-restricted transgenic lymphocytes in accordance with the simulation of biological events described in Example 3 of section C3 and in accordance with an embodiment of the disclosure.

In contrast to the indivisible marker molecule (e.g., the ELP molecule) differentiation mechanism demonstrated in Example 2 above, the present example defines a cell-to-cell mediated signaling pathway. In one embodiment, cells produce a receptor molecule on their respective cell surfaces. The receptor molecules can be detectable by neighboring cells and used to determine individual cells types. In this example, a gene unit under <Genome> is defined to produce NeighborhoodReceptor molecules in TLymphocyte cells (FIG. 17B).

### Configuration Example:

[TLymphocyte 100] [NeighborhoodReceptor]

Once the NeighborhoodReceptor molecule is produced, the molecule can be moved/transported to the virtual surface of the cell to be detectable by neighboring cells using a chemistry equation defined under <ChemistryEquations> (FIG. 17C).

### Configuration Example:

NeighborhoodReceptor=(NeighborhoodReceptor)

ELP cells can be configured to generate ELP-specific signals (e.g., ELPS molecules) detectable by neighboring cells having the NeighborhoodReceptor molecule (FIG. 17D). During simulation instances when two ELP cells are proximate such that ELPS signals can be detected by each of the proximate ELP cells, both ELP cells can be pressured to eliminate the ELP cell state (e.g., by differentiating). One example of resolving this pressure includes defining the ELP cell having the smaller cell size as the cell to eliminate the ELP cell state. The cell-to-cell signal mediated differentiation pathway can be defined under <ChemistryEquations>.

### Configuration Example:

ELP = ELP + ( 5 ELPS ); <!-- produce ELP signals so other cells know you're here -->
{ ELPS } + ( NeighborhoodReceptor ) = ELPNS + ( NeighborhoodReceptor ) <!-- ELP
neighbor response -->
ELP + ELPNS = ELPNS <!-- ELP neighbor signal pressures this cell to give up its ELP
state -->

To maintain balance between ELP cell differentiation and ELP cell state maintenance of proximate ELP cells, ELP signal molecule detection followed by a rapid molecule decay can be implemented. For example, decay rates of ELP molecules, ELP signal molecules (e.g., ELPS), and ELP neighbor signal (e.g., ELPNS) can be configured to be relatively high compared to other molecules present in the simulation model. Decay rates of ELP, ELPS and ELPNS can be defined under <MolecularCatalog>.

### Configuration Example:

ELP [ 300, 10 ] 0.5;
ELPS [ 2000, 10 ] 0.9;
ELPNS [ 2200, 10 ] 0.9;

ELP cells can be configured to maintain the ELP cell state when the cells are not in the presence of another ELP neighboring cell (FIG. 17E). A gene unit feedback loop can be defined under <Genome>.

### Configuration Example:

[ELP 100, ELPNS −300][ELP]

ELP cells can divide so that progeny can begin specific lineage pathway commitment. A gene unit under <Genome> is defined to produce Division molecules (FIG. 17F). In the present example, when an ELP divides into two cells, one of the cells remains an ELP and the other is subject to a differentiation mechanism. The modeling platform supports a method for allowing this division protocol to occur by defining a gene unit for producing an ELP division inhibitor molecule (ELPDI) (FIG. 17F). The ELPDI molecule can strongly and negatively regulate the division molecule gene unit in instances when the ELP cell is small (e.g., below a threshold size limit). At larger cell sizes (e.g., above a threshold size limit), the ELPDI concentration can be configured to diminish, and thereby reduce the inhibitory effect on the division molecule gene unit. The above described signaling pathway can also be configured to prevent division when two ELP cells are detectably proximate (e.g., when ELPNS molecules are present). In this example, ELP neighbor signal molecules (e.g., ELPNS) can negatively regulate the division molecule gene unit (FIG. 17F). In this example, two gene units are defined under <Genome>.

### Configuration Example:

[ ELP 5, ELPDI −50, ELPNS −1000 ] [ Division ]
[ ELP 0.85 ][ ELPDI ]

Another aspect of this example can include preventing ELPs from dividing at the initiation of a simulation session. Accordingly, an ELPDI molecule amount can be defined under <InitialChemistry>.

### Configuration Example:

ELPDI C 10

To simulate natural ELP and mature lymphocyte cell growth, the configuration file is configured to maintain the cells with physical properties. As shown in FIG. 17G, a gene unit can be defined under <Genome> to generate Growth molecules. ELP, TN2 and ProB cells can be assigned low effect values with respect to Growth molecules to ensure that these cell types are restricted from forming more than 5 subunits (e.g., as a cell obtains additional subunits, the growth potential declines).

### Configuration Example:

[ELP 0.25, TN2 0.2, ProB 0.2][Growth]

As shown in FIG. 17H, TLymphocyte cells can be assigned other physical properties (e.g., elasticity, rigidity, etc.). A gene unit can be defined under <Genome> to produce these molecules.

### Configuration Example:

[TLymphocyte 1] [Rigidity, Elasticity]

C3.2.4 Initializing Simulation

In this example, the cell-centric simulator is configured to initiate a simulation session with the above-described thymic environment, and run as described above with respect to Examples 1 and 2.

To begin a simulation session, one or more cells can be initiated into the virtual area previously defined (e.g., virtual Petri dish, thymic environment, etc.). This operation can be defined in the <InitialCellLocations> under <Simulation>.

### Configuration Example:

<InitialCellLocations>

[ 0.0, 0.0, 0.0 ];
[ 5.0, 0.0, 0.0 ];
[ −5.0, 0.0, 0.0 ];
[ 0.0, 0.0, 5.0 ];
[ 0.0, 0.0, −5.0 ];

</InitialCellLocations>

C3.2.5. Configuration File Results

An exemplary configuration is shown below:

<CsIndividual>

<RandomSeed>8467923</RandomSeed>
<Simulation>

<FixedSpheres>[0, 1000, 0] 999</FixedSpheres>
<InitialCellLocation>

[ 0.0, 0.0, 0.0 ];
[ 5.0, 0.0, 0.0 ];
[ −5.0, 0.0, 0.0 ];
[ 0.0, 0.0, 5.0 ];
[ 0.0, 0.0, −5.0 ];

</InitialCellLocation>
<Physics>

<Container>

<Dish>[ 0.0, −1.0, 0.0 ] 10.0</Dish>

</Container>
<Gravity>0.5</Gravity>
<MaxVelocityChange>0.1</MaxVelocityChange>
<TimePerStep>0.1</TimePerStep>
<DampingMultiplier>3.0</DampingMultiplier>
<NudgeMagnitude>3.0</NudgeMagnitude>
<RepulsionMultiplier>1.0</RepulsionMultiplier>

</Physics>
<Signal><Local><Separation>0.5</Separation></Local></Signal>
<Cell>
<Promoter>

<Smoother>

<PromotionMidpoint>5</PromotionMidpoint>
<Slope>3</Slope>
<ActiveConcentration>1</ActiveConcentration>

</Smoother>

</Promoter>
<Chemistry><Default/></Chemistry>
<MaximumSize>99999</MaximumSize>
<InitialSize>1</InitialSize>
<MinimumSize>2</MinimumSize>
<InitialChemistry>

TLymphocyte 1000
ELP 100
ELPDI C 10

</InitialChemistry>
<ChemistryEquations>

NeighborhoodReceptor = (NeighborhoodReceptor);
{ELPS} + (NeighborhoodReceptor) = ELPNS + (NeighborhoodReceptor);
ELP + ELPNS = ELPNS;
ELP = ELP + (5 ELPS);
<!-- IL7 Signaling -->
IL7R = (IL7R); <!-- move IL7R to surface to act as a receptor -->
{IL7Ligand} + (IL7R) = IL7RP; <!-- binding of IL7 to the IL7 receptor
phosphorylates it -->
IL7RP + STAT5 = IL7RPSTAT5P;
IL7RPSTAT5P + STAT5 = IL7RP + STAT5P;
<!-- Notch Signaling -->
Notch1R = (Notch1R); <!-- move notch1R to surface to act as a receptor—
>
{Notch1Ligand} + (0.1 Notch1R) = Notch1P;

</ChemistryEquations>

</Cell>

</Simulation>
<MoleculeCatalog>

IL7Ligand [ 100, 10 ];
TLymphocyte [ 200, 10 ];
ELP [ 300, 10 ] 0.5;
EBF [ 500, 10 ];
Notch1R [ 600, 10 ];
Notch1P [ 700, 10 ];
Notch1 [ 800, 10 ];
IL7R [ 900, 10 ];
STAT5P [ 1000, 10 ];
STAT5 [ 1100, 10 ];
Pax5 [ 1300, 10 ];
ProB [ 1400, 10 ];
TN2 [ 1500, 10 ];
IL7RP [ 1600, 10 ] 0.2;
IL7RPSTAT5P [ 1800, 10 ];
Notch1Ligand [ 1900, 10 ];
NeighborhoodReceptor [ 2100, 10 ];
ELPS [ 2000, 10 ] 0.9;
ELPNS [ 2200, 10 ] 0.9;
ELPDI [ 2300, 10];

</MoleculeCatalog>
<Genome>

[

[ TLymphocyte 100 ][ NeighborhoodReceptor ],
[ TLymphocyte 10 ][ TLymphocyte ],
[ TLymphocyte 5, ELP −6 ][ STAT5 ],
[ TLymphocyte 1 ][ STAT5P ], <!-- Transgene -->
[ TLymphocyte 1, ELP −1 ][ IL7R, Notch1R ],
[ STAT5P 2, Pax5 3, Notch1 −4, TN2 −5 ][ EBF ],
[ EBF 1, ELP −1000 ][ Pax5 ],
[ Notch1P 1.111112, Pax5 −2 ][ Notch1 ],
[ Notch1 1, TN2 8.5, ProB −10 ][ TN2 ],
[ Pax5 1, ProB 8.5, TN2 −10][ ProB ],
[ TLymphocyte 1 ][ Rigidity, Elasticity ],
[ ELP 100, ELPNS −300 ][ ELP ],
[ ELP 5, ELPDI −50, ELPNS −1000 ][ Division ],
[ ELP 0.25, TN2 0.2, ProB 0.2 ][ Growth ],
[ ELP 0.85 ] [ ELPDI ]

]

</Genome>
<Shade>
<UseModifier/><UseRadius/>
[

S IL7Ligand @ 1000 1000 1000 100 0 1 1
,S Notch1Ligand @ −12 0 −12 3 0.9 5 1.2
,S Notch1Ligand @ −12 0 −9 3 0.9 5 1.2
,S Notch1Ligand @ −12 0 −6 3 0.9 5 1.2
,S Notch1Ligand @ −12 0 −3 3 0.9 5 1.2
,S Notch1Ligand @ −12 0 0 3 0.9 5 1.2
,S Notch1Ligand @ −12 0 3 3 0.9 5 1.2
,S Notch1Ligand @ −12 0 6 3 0.9 5 1.2
,S Notch1Ligand @ −12 0 9 3 0.9 5 1.2
,S Notch1Ligand @ −12 0 12 3 0.9 5 1.2
,S Notch1Ligand @ −9 0 −12 3 0.9 5 1.2
,S Notch1Ligand @ −9 0 −9 3 0.9 5 1.2
,S Notch1Ligand @ −9 0 −6 3 0.9 5 1.2
,S Notch1Ligand @ −9 0 −3 3 0.9 5 1.2
,S Notch1Ligand @ −9 0 0 3 0.9 5 1.2
,S Notch1Ligand @ −9 0 3 3 0.9 5 1.2
,S Notch1Ligand @ −9 0 6 3 0.9 5 1.2
,S Notch1Ligand @ −9 0 9 3 0.9 5 1.2
,S Notch1Ligand @ −9 0 12 3 0.9 5 1.2
,S Notch1Ligand @ −6 0 −12 3 0.9 5 1.2
,S Notch1Ligand @ −6 0 −9 3 0.9 5 1.2
,S Notch1Ligand @ −6 0 −6 3 0.9 5 1.2
,S Notch1Ligand @ −6 0 −3 3 0.9 5 1.2
,S Notch1Ligand @ −6 0 0 3 0.9 5 1.2
,S Notch1Ligand @ −6 0 3 3 0.9 5 1.2
,S Notch1Ligand @ −6 0 6 3 0.9 5 1.2
,S Notch1Ligand @ −6 0 9 3 0.9 5 1.2
,S Notch1Ligand @ −6 0 12 3 0.9 5 1.2
,S Notch1Ligand @ −3 0 −12 3 0.9 5 1.2
,S Notch1Ligand @ −3 0 −9 3 0.9 5 1.2
,S Notch1Ligand @ −3 0 −6 3 0.9 5 1.2
,S Notch1Ligand @ −3 0 −3 3 0.9 5 1.2
,S Notch1Ligand @ −3 0 0 3 0.9 5 1.2
,S Notch1Ligand @ −3 0 3 3 0.9 5 1.2
,S Notch1Ligand @ −3 0 6 3 0.9 5 1.2
,S Notch1Ligand @ −3 0 9 3 0.9 5 1.2
,S Notch1Ligand @ −3 0 12 3 0.9 5 1.2
,S Notch1Ligand @ 0 0 −12 3 0.9 5 1.2
,S Notch1Ligand @ 0 0 −9 3 0.9 5 1.2
,S Notch1Ligand @ 0 0 −6 3 0.9 5 1.2
,S Notch1Ligand @ 0 0 −3 3 0.9 5 1.2
,S Notch1Ligand @ 0 0 0 3 0.9 5 1.2
,S Notch1Ligand @ 0 0 3 3 0.9 5 1.2
,S Notch1Ligand @ 0 0 6 3 0.9 5 1.2
,S Notch1Ligand @ 0 0 9 3 0.9 5 1.2
,S Notch1Ligand @ 0 0 12 3 0.9 5 1.2
,S Notch1Ligand @ 3 0 −12 3 0.9 5 1.2
,S Notch1Ligand @ 3 0 −9 3 0.9 5 1.2
,S Notch1Ligand @ 3 0 −6 3 0.9 5 1.2
,S Notch1Ligand @ 3 0 −3 3 0.9 5 1.2
,S Notch1Ligand @ 3 0 0 3 0.9 5 1.2
,S Notch1Ligand @ 3 0 3 3 0.9 5 1.2
,S Notch1Ligand @ 3 0 6 3 0.9 5 1.2
,S Notch1Ligand @ 3 0 9 3 0.9 5 1.2
,S Notch1Ligand @ 3 0 12 3 0.9 5 1.2
,S Notch1Ligand @ 6 0 −12 3 0.9 5 1.2
,S Notch1Ligand @ 6 0 −9 3 0.9 5 1.2
,S Notch1Ligand @ 6 0 −6 3 0.9 5 1.2
,S Notch1Ligand @ 6 0 −3 3 0.9 5 1.2
,S Notch1Ligand @ 6 0 0 3 0.9 5 1.2
,S Notch1Ligand @ 6 0 3 3 0.9 5 1.2
,S Notch1Ligand @ 6 0 6 3 0.9 5 1.2
,S Notch1Ligand @ 6 0 9 3 0.9 5 1.2
,S Notch1Ligand @ 6 0 12 3 0.9 5 1.2
,S Notch1Ligand @ 9 0 −12 3 0.9 5 1.2
,S Notch1Ligand @ 9 0 −9 3 0.9 5 1.2
,S Notch1Ligand @ 9 0 −6 3 0.9 5 1.2
,S Notch1Ligand @ 9 0 −3 3 0.9 5 1.2
,S Notch1Ligand @ 9 0 0 3 0.9 5 1.2
,S Notch1Ligand @ 9 0 3 3 0.9 5 1.2
,S Notch1Ligand @ 9 0 6 3 0.9 5 1.2
,S Notch1Ligand @ 9 0 9 3 0.9 5 1.2
,S Notch1Ligand @ 9 0 12 3 0.9 5 1.2
,S Notch1Ligand @ 12 0 −12 3 0.9 5 1.2
,S Notch1Ligand @ 12 0 −9 3 0.9 5 1.2
,S Notch1Ligand @ 12 0 −6 3 0.9 5 1.2
,S Notch1Ligand @ 12 0 −3 3 0.9 5 1.2
,S Notch1Ligand @ 12 0 0 3 0.9 5 1.2
,S Notch1Ligand @ 12 0 3 3 0.9 5 1.2
,S Notch1Ligand @ 12 0 6 3 0.9 5 1.2
,S Notch1Ligand @ 12 0 9 3 0.9 5 1.2
,S Notch1Ligand @ 12 0 12 3 0.9 5 1.2

]
</Shade>

</CsIndividual>

### D. ADDITIONAL EMBODIMENTS OF SIMULATION SYSTEMS AND METHODS

As another example, the cell-centric simulator may be implemented as a computational component for use in directing one or more computing devices to model one or more biological events. Referring to FIG. 3, the computational component may comprise encoded computing device instructions 322, emanating from a tangible computer readable medium, such as a memory 320 at a server 308. The encoded computing device instructions 322 are electronically accessible to at least one of the computing devices 302 and 308 for execution. The computational component may be received at the memory 402 (FIG. 4) of the computing device 302 from the server 308 coupled to the memory 402 via the network 306, for example.

The execution of the encoded computing device instructions 322 may cause the one or more computing devices 302 and 308 to receive configurable simulation information. In one embodiment, the configurable simulation information may include user-configurable simulation information received via user interface. In another embodiment, the configurable simulation information can be extracted from a selected configuration file generated during a previous simulation session and stored, for example, in the memory 320 and/or database 310.

The execution of the encoded computing device instructions 322 may further cause the one or more computing devices 302 and 308 to initialize an ontogeny engine to an initial step boundary in accordance with the configurable simulation information. The execution of the encoded computing device instructions 322 may further cause the one or more computing devices 302 and 308 to advance the ontogeny engine from a current step boundary to a next step boundary in accordance with the configurable simulation information and the current step boundary. The advancing can include performing a stepCells function. The execution of the encoded computing device instructions 322 may further cause the one or more computing devices 302 and 308 to continue the advancing until a halting condition is encountered. In other embodiments, the advancing can include performing one or more of a killCells function, a stepECM function and stepPhysics function.

Referring to FIG. 4, an operating system (not shown) runs on the processor 401 and coordinates and provides control of various components within the computing device system 302. The operating system may be a commonly available operating system such as Microsoft® Windows® XP (Microsoft and Windows are trademarks of Microsoft Corporation in the United States, other countries, or both). A programming system or program interpreter may run in conjunction with the operating system and provide calls to the operating system from these programs or applications executing on computing system 302.

Instructions for the operating system, the programming system, and applications or programs are located on storage devices, such as a hard disk drive, and may be loaded into the memory 402 for execution by the processor 401. The processes of the disclosed illustrative embodiments may be performed by the processor 401 using computer implemented instructions, which may be located in a memory such as, for example, the memory 402 or in one or more peripheral devices.

The hardware in computing system 300 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the disclosed illustrative embodiments may be applied to a multiprocessor data processing system.

In some illustrative examples, portions of the computing system 300 may be implemented in a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A processing unit may include one or more processors or CPUs. The depicted examples in FIGS. 3 and 4 and above-described examples are not meant to imply architectural limitations. For example, portions of the computing system 300 also may be implemented in a tablet computer, laptop computer, or telephone device in addition to taking the form of a PDA.

Particular embodiments of the computing system 300 can take the form of an entirely hardware embodiment, an entirely software embodiment or an embodiment containing both hardware and software elements. In a particular embodiment, the disclosed methods are implemented in software, which includes but is not limited to firmware, resident software, microcode, etc.

Further, embodiments of the present disclosure, such as the one or more embodiments in FIGS. 1A-23 can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the data processing system either directly or through intervening I/O controllers.

Network adapters may also be coupled to the data processing system to enable the data processing system to become coupled to other data processing systems or remote printers or storage devices through intervening private or public networks. Modems, cable modems, and Ethernet cards are just a few of the currently available types of network adapters.

### E. CONCLUSION

Various embodiments of the technology are described above. It will be appreciated that details set forth above are provided to describe the embodiments in a manner sufficient to enable a person skilled in the relevant art to make and use the disclosed embodiments. Several of the details and advantages, however, may not be necessary to practice some embodiments. Additionally, some well-known structures or functions may not be shown or described in detail, so as to avoid unnecessarily obscuring the relevant description of the various embodiments. Although some embodiments may be within the scope of the claims, they may not be described in detail with respect to the Figures. Furthermore, features, structures, or characteristics of various embodiments may be combined in any suitable manner.

Moreover, one skilled in the art will recognize that there are a number of other technologies that could be used to perform functions similar to those described above and so the claims should not be limited to the devices or routines described herein. While processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. The headings provided herein are for convenience only and do not interpret the scope or meaning of the claims.

The terminology used in the description is intended to be interpreted in its broadest reasonable manner, even though it is being used in conjunction with a detailed description of identified embodiments.

Any patents, applications and other references cited within the disclosure are hereby incorporated by reference in their entirety as if fully set forth herein. Aspects of the described technology can be modified, if necessary, to employ the systems, functions, and concepts of the various references described above to provide yet further embodiments.

These and other changes can be made in light of the above Detailed Description. While the above description details certain embodiments and describes the best mode contemplated, no matter how detailed, various changes can be made. Implementation details may vary considerably, while still being encompassed by the technology disclosed herein. For example, it will be appreciated how one can simulate biological events, modify the configurable simulation information, and perform additional and/or subsequent simulations, such as those detailed above, using the cell-centric simulation system. Further, it will be recognized that a user can generate user-configurable simulation information to computationally simulate lymphocyte differentiation such as development of T-cell and B-cell lymphocytes having a desired phenotype, shape, cell composition, and/or other properties.

As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the claims to the specific embodiments disclosed in the specification, unless the above Detailed Description section explicitly defines such terms. Accordingly, the actual scope of the claims encompasses not only the disclosed embodiments, but also all equivalents.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

We claim:

1. A computer-implemented method of modeling lymphocyte differentiation comprising:
receiving configurable simulation information, the configurable simulation information including:
configured physical and chemical parameters;
configured environmental information;
configured metabolic information;
initializing an ontogeny engine to an initial step boundary in accordance with the configurable simulation information, wherein the initial step boundary defines at least one virtual early lymphoid progenitor (ELP) cell in a virtual environment;
advancing the ontogeny engine from a current step boundary to a next step boundary in accordance with the configurable simulation information and the current step boundary, the advancing comprising performing a stepCells function and a stepPhysics function; and
continuing the advancing until a halting condition is encountered.

2. The method of claim 1 wherein configured physical and chemical parameters includes information for defining one or more of a virtual constraining area, a gravitational force, a maximum and a minimum cell size, a molecule decay rate and a molecule diffusion rate.

3. The method of claim 1 wherein configured environmental information includes information for defining the virtual environment having a molecule profile, the molecule profile including a molecule type, a molecule concentration and a molecule distribution.

4. The method of claim 3 wherein the virtual environment is a thymic environment, and wherein the molecule profile includes IL-7 ligand molecules distributed with a uniform point source and Notch1 ligand molecules distributed with a localized point source.

5. The method of claim 3 wherein the virtual environment is a bone marrow environment, and wherein the molecular profile includes IL-7 molecules distributed with a uniform point source.

6. The method of claim 1 wherein the virtual environment is a thymic environment, and wherein during the advancing step, the at least one virtual ELP cell divides to form two virtual daughter cells, wherein at least one of the virtual daughter cells differentiates into a virtual T-cell lymphocyte.

7. The method of claim 1 wherein the virtual environment is a bone marrow environment, and wherein during the advancing step, the at least one virtual ELP cell divides to form two virtual daughter cells, wherein at least one of the virtual daughter cells differentiates into a virtual B-cell lymphocyte.

8. The method of claim 1 wherein configured metabolic information includes information for defining a lymphocyte virtual genome and a set of chemical-interaction rules.

9. The method of claim 8 wherein the lymphocyte virtual genome includes one or more gene units for generating one or more of IL-7 receptor molecules, IL-7 ligand molecules, IL-7 signal molecules, Notch1 receptor molecules, Notch1 ligand molecules and Notch1 signal molecules.

10. The method of claim 8 wherein the lymphocyte virtual genome includes one or more gene units for generating one or more of STAT5 molecules, EBF molecules and PAX5 molecules.

11. The method of claim 8 wherein the lymphocyte virtual genome includes a gene unit for generating one or more of an elasticity molecule, a plasticity molecule and a rigidity molecule.

12. The method of claim 8 wherein the chemical-interaction rules includes one or more chemical-interaction rules for committing the virtual ELP to one of a virtual T cell and a virtual B cell, and wherein advancing the ontogeny engine from a current step boundary to a next step boundary includes invoking the chemical-interaction rules such that the method of modeling lymphocyte differentiation includes modeling differentiation of a virtual ELP to one of a virtual T cell and a virtual B cell.

13. The method of claim 8 wherein the lymphocyte virtual genome includes a virtual transgene unit for generating one more molecules for invoking a second set of chemical-interaction rules.

14. The method of claim 13 wherein:
the virtual environment is a bone marrow environment;
the virtual transgene unit includes a gene unit for constitutively generating a STAT5 molecule during lymphocyte differentiation;
the at least one virtual ELP cell divides to form two virtual daughter cells; and
wherein at least one of the virtual daughter cells differentiates into a virtual B-cell lymphocyte.

15. The method of claim 1 wherein the at least one virtual ELP cell includes an indivisible ELP molecule, and wherein the at least one virtual ELP cell divides to form a first virtual daughter cell and a second virtual daughter cells, and wherein the first virtual daughter cell is assigned the indivisible ELP molecule.

16. The method of claim 1 wherein the at least one virtual ELP cell divides to form a virtual daughter ELP cell and a virtual daughter non-ELP cell through a cell-to-cell signal-mediated differentiation mechanism, and wherein the differentiation mechanism includes modeling asymmetric cell division.

17. The method of claim 1 wherein continuing the advancing until a halting condition is encountered includes continuing the advancing until a configured halting condition is encountered.

18. The method of claim 1, further comprising generating a configuration file at the current step boundary, and storing the configuration file for subsequent retrieval.

19. The method of claim 1, further comprising:
encountering a halting condition;
receiving additional configurable simulation information, the additional simulation information including alteration information for altering the configurable simulation information; and
initializing the ontogeny engine to an initial step boundary in accordance with the configurable simulation information and the additional simulation information.

20. The method of claim 19 wherein the alteration information includes a transgene unit to incorporate in a lymphocyte virtual genome.

21. The method of claim 20 wherein the transgene unit includes a gene unit for constitutively generating a STAT5 molecule during lymphocyte differentiation.

22. The method of claim 1, further comprising generating and displaying a graphical image representing the current step boundary at a user interface.

23. The method of claim 22 wherein the graphical image is a first graphical image, and wherein the method further comprises displaying a second graphical image representing the next step boundary, the second graphical image displayed in sequential order following the display of the first graphical image.

24. The method of claim 1, wherein modeling lymphocyte differentiation can predict the outcome of an in vivo or in vitro experiment.

25. A computer program product for modeling lymphocyte differentiation comprising a computer usable medium including a computer readable program, wherein the computer readable program when executed by a computer causes a method to be performed, the method comprising:
receiving configurable simulation information, the configurable simulation information including:
configured physical and chemical parameters;
configured environmental information;
configured metabolic information;
initializing an ontogeny engine to an initial step boundary in accordance with the configurable simulation information, wherein the initial step boundary defines at least one virtual early lymphoid progenitor (ELP) cell in a virtual environment; and
advancing the ontogeny engine, until a halting condition is encountered, from a current step boundary to a next step boundary in accordance with the configurable simulation information and the current step boundary, the advancing comprising performing a stepCells function and a stepPhysics function.

26. The computer program product of claim 25 wherein performing a stepCells function includes invoking at least one of a gene unit control region rule and a chemical-interaction rule for adjusting a level of a molecule.

27. The computer program product of claim 25 wherein performing a stepPhysics function includes invoking a physical interaction rule, and wherein the physical interaction rule applies to at least one of virtual cell adhesion forces, virtual cell overlap resolution and virtual cell movement.

28. The computer program product of claim 25 wherein receiving configurable simulation information includes receiving information for modeling lymphocyte differentiation in a free-coordinate virtual environment, wherein a lymphocyte virtual cell is represented by a plurality of subspheres, and wherein the lymphocyte virtual cell occupies a non-discrete space in a three-dimensional coordinate arrangement.

29. The computer program product of claim 25 wherein configured metabolic information includes information for defining a lymphocyte virtual genome and a set of chemical-interaction rules, and wherein the lymphocyte virtual genome includes one or more gene units for generating one or more of IL-7 receptor molecules, IL-7 ligand molecules, IL-7 signal molecules, Notch1 receptor molecules, Notch1 ligand molecules and Notch1 signal molecules.

30. The computer program product of claim 25 wherein configured metabolic information includes information for defining a lymphocyte virtual genome and a set of chemical-interaction rules, and wherein the lymphocyte virtual genome includes a virtual transgene unit for generating one more molecules for invoking a second set of chemical-interaction rules.

31. The computer program product of claim 25 wherein the virtual environment is a thymic environment, and wherein during the advancing step, the at least one virtual ELP cell divides to form two virtual daughter cells, wherein at least one of the virtual daughter cells differentiates into a virtual T-cell lymphocyte.

32. The computer program product of claim 25 wherein the virtual environment is a bone marrow environment, and wherein during the advancing step, the at least one virtual ELP cell divides to form two virtual daughter cells, wherein at least one of the virtual daughter cells differentiates into a virtual B-cell lymphocyte.

33. The computer program product of claim 25, wherein modeling lymphocyte differentiation can predict the outcome of an in vivo or in vitro experiment.

34. A system for modeling lymphocyte differentiation, comprising:
a processor;
means for executing on the processor and receiving configurable simulation information, the configurable simulation information including:
configured physical and chemical parameters;
configured environmental information; and
configured metabolic information, wherein configured metabolic information includes information for defining a lymphocyte virtual genome and a set of chemical-interaction rules;
means for executing on the processor and initializing an ontogeny engine to an initial step boundary in accordance with the configurable simulation information, wherein the initial step boundary defines at least one virtual early lymphoid progenitor (ELP) cell in a virtual environment, the ELP cell having been assigned the lymphocyte virtual genome;
means for executing on the processor and advancing the ontogeny engine from a current step boundary to a next step boundary in accordance with the configurable simulation information and the current step boundary, the advancing comprising performing a stepCells function and a stepPhysics function; and
means for executing on the processor and continuing the advancing until a halting condition is encountered.

35. The system of claim 34 wherein the lymphocyte virtual genome includes one or more gene units for generating one or more of IL-7 receptor molecules, IL-7 ligand molecules, IL-7 signal molecules, Notch1 receptor molecules, Notch1 ligand molecules and Notch1 signal molecules.

36. The system of claim 34 wherein the lymphocyte virtual genome includes a virtual transgene unit for generating one more molecules for invoking a second set of chemical-interaction rules.

37. The system of claim 34 wherein:
the means for receiving configurable simulation information includes a receive module;
the means for initializing an ontogeny engine includes an initialize module;
the means for advancing the ontogeny engine includes an advance module; and
the means for continuing the advancing includes a halt detection module.

38. The system of claim 37, wherein the receive module is further configured to receive additional configurable simulation information, the additional simulation information including alteration information for altering the configurable simulation information, and wherein the initialize module is further configured to initialize the ontogeny engine to an initial step boundary in accordance with the configurable simulation information and the additional simulation information.

39. The system of claim 34, wherein modeling lymphocyte differentiation can predict the outcome of an in vivo or in vitro experiment.
